(19) United States
(12) Patent Application Publication
(10) Pub. No.: US 2008/0136933 A1
(43) Pub. Date: Jun. 12, 2008

(54) Apparatus for controlling operation of a multiple photosensor pixel image sensor

(75) Inventors: Taner Dosluoglu, (US); Guang Yang, Annandale, NJ (US)

Correspondence Address: STEPHEN B. ACKERMAN, 28 DAVIS AVENUE, POUGHKEEPSIE, NY, 12603, US

(73) Assignee: Digital Imaging Systems GmbH

(21) Appl. No.: 12/001,373

(22) Filed: Dec. 11, 2007

Related U.S. Application Data
(60) Provisional application No. 60/874,151, filed on Dec. 11, 2006.

(51) Int. Cl. H04N 9/73; H04N 5/335; H04N 5/76

(52) U.S. Cl. 348/223.1; 348/272; 348/231.99; 348/E05.091; 348/E09.051

(57) ABSTRACT

An apparatus for controlling operation of a color multiple sensor pixel image sensor includes a row control circuit in communication with rows of the array of plurality of color multiple sensor pixel image sensors. The control apparatus generates reset control signals, transfer gating signals, and row selecting signals for control the integration of photoelectrons generated from the light impinging upon the array of color multiple sensor pixel image sensors and charge transfer of the photoelectrons by the plurality of transfer switches between the photosensing devices and from the photosensing devices to the combined photosensing and charge storage device. The control apparatus provides the row selecting signals for sequentially selecting rows of the plurality of color multiple sensor pixel image sensors such that output signals from each of the color multiple sensor pixel image sensors on a selected row are transferred for detection.

This application claims priority under 35 U.S.C. §119 to U.S. Provisional Patent Application Ser. No. 60/874,151, Filing Date Dec. 11, 2006 which is incorporated herein by reference in its entirety.

### RELATED PATENT APPLICATIONS

“A Multiple Photosensor Pixel Image Sensor” (Dosluoglu—436), Ser. No. 11/301,436, Filing Date Dec. 13, 2005, assigned to the same assignee as this invention and incorporated herein by reference in its entirety.

“A Multiple Photosensor Pixel” (Dosluoglu—840), Ser. No. 11/252,840, Filing Date Oct. 18, 2005, assigned to the same assignee as this invention and incorporated herein by reference in its entirety.

### BACKGROUND OF THE INVENTION

1. Field of the Invention

The present invention relates to solid-state image sensing devices. More particularly, this invention relates to apparatus and methods for generating signals for activating and controlling operation of multiple photosensor solid state image sensing devices.

2. Description of Related Art

Integrated circuit image sensors are finding applications in a wide variety of fields, including machine vision, robotics, guidance and navigation, automotive applications, and consumer products such as digital camera and video recorders. Imaging circuits typically include a two dimensional array of photo sensors. Each photo sensor includes one picture element (pixel) of the image. Light energy emitted or reflected from an object impinges upon the array of photo sensors. The light energy is converted by the photo sensors to an electrical signal. Imaging circuitry scans the individual photo sensors to readout the electrical signals. The electrical signals of the image are processed by external circuitry for subsequent display.

Modern metal oxide semiconductor (MOS) design and processing techniques have been developed that provide for the capture of light as charge and the transporting of that charge within active pixel sensors and other structures so as to be accomplished with almost perfect efficiency and accuracy.

One class of solid-state image sensors includes an array of active pixel sensors (APS). An APS is a light sensing device with sensing circuitry inside each pixel. Each active pixel sensor includes a sensing element formed in a semiconductor substrate and capable of converting photons of light into electronic signals. As the photons of light strike the surface of a photoactive region of the solid-state image sensors, free charge carriers are generated and collected. Once collected the charge carriers, often referred to as charge packets or photoelectrons are transferred to output circuitry for processing.

An active pixel sensor also includes one or more active transistors within the pixel itself. The active transistors amplify and buffer the signals generated by the light sensing element to convert the photoelectron to an electronic signal prior to transferring the signal to a common conductor that conducts the signals to an output node.

Active pixel sensor devices are fabricated using processes that are consistent with complementary metal oxide semiconductor (CMOS) processes. Using standard CMOS processes allows many signal processing functions and operation controls to be integrated with an array of active pixel sensors on a single integrated circuit chip.

Refer now to FIG. 1a for a detailed discussion of a three transistor active pixel image sensor of the prior art. A substrate 5 heavily doped with a P-type impurity has its surface further doped with a complementary impurity to create a lightly doped P-type epitaxial layer 10. The N-type photo detector region 15 is formed within the surface of the epitaxial layer 10 of the substrate 5. A P-type material is heavily diffused relatively deeply into the surface of the epitaxial layer 10 of the substrate 5 to form the P-well diffusions 20.

The junction of the N-type photo detector region 15 with the epitaxial layer 10 is depleted of electrons and acts collection region during the photo conversion. The collected photoelectrons cause the voltage potential N-type photo detector region 15 to become more negative in proportion to the number of photons 50 that impinge upon the N-type photo detector region 15. The N-type photo detector region 15 is connected through the N⁺ contact to the gate of the NMOS transistor 30 that acts as a source follower such that the voltage at the source of the NMOS transistor 30 is proportional to the voltage potential present at the N-type photo detector region 15. The drain of the row selection NMOS transistor 35 is connected to the source of the NMOS transistor 30. The source of the row selection transistor NMOS transistor 35 is connected to a pixel output port 55 for further processing. The gate of the row selection transistor NMOS transistor 35 is connected to the row select signal 45 for activation to transfer the sensed signal from the pixel for readout. The NMOS transistor 25 has its drain connected to the power supply voltage source VDD and is source connected to the N⁺ photo detector region 15. The gate of the NMOS transistor is connected to the reset signal 40. When activated the NMOS transistor 25 ties the N-type photo detector region 15 through the N⁺ contact to the power supply voltage source VDD to reset the N-type photo detector region 15.

In operation the N-type photo detector region 15 is initialized by applying the reset signal 40 to the NMOS transistor 25 to reset the N-type photo detector region 15. Photons are allowed to impinge upon the N-type photo detector region 15 for an integration period. The row select signal 45 is activated and the voltage present at the N-type photo detector region 15 is sensed. The reset signal 40 is again applied to reset the N-type photo detector region 15 and this reset level is then sensed and the difference determined in a double sampling method of readout.

An alternative to the three transistor active pixel image sensor is a four transistor pinned active pixel image sensor. For a detailed discussion of a four transistor pinned active pixel image sensor of the prior art and shown in FIG. 1b. A substrate 105 heavily doped with a P-type impurity has its surface further doped with a complementary impurity to create a lightly doped P-type epitaxial layer 110. The N⁺ diffusion region 115 of pinned photo detector is formed within the surface of the epitaxial layer 110 of the substrate 105. A shallow P⁺ pinning diffusion 120 is formed within the N⁺ photo detector region 115 to complete the pinned photo detector. A P-type material is heavily diffused relatively deeply into the surface of the epitaxial layer 110 of the substrate 105 to form the P-well diffusions 125 and 130. The shallow P⁺ pinning diffusion 120 is in contact with the P-well 130 which connected to the ground reference voltage. The shallow P⁺ pinning diffusion 120 and the p-type epitaxial layer 110 force the N⁺ photo detector region 115 to be more totally depleted for collecting the photoelectrons resulting from the impingement of the photons 150 on the surface of the pinned photodiode region.

An N⁺ floating diffusion storage node 135 is formed within the P-well diffusion 125 to retain charge that is collected in the N⁺ photo detector region 115. A gate insulator or thin oxide 140 is placed on the surface of the p-type epitaxial layer 110 and a polycrystalline silicon layer is formed on the surface to form the transfer gate 145. The N⁺ photo detector region 115, the transfer gate 145, and the floating diffusion 135 form a transfer gate switch

The transfer gate 145 of the transfer gate switch is connected to a transfer gating signals T_GT 155. The floating diffusion storage node 135 is connected to the gate of the source follower NMOS transistor 160. The drain of the source follower NMOS transistor 160 is connected to the power supply voltage source VDD and the source of the source follower NMOS transistor 160 is connected to the drain of the row select NMOS transistor 165. The gate of the row select NMOS transistor 165 is connected to the row select signal 170. The source follower NMOS transistor 160 to buffers the electrical signal created by the photoelectron charge collected in the floating diffusion 135.

The floating diffusion storage node 135 is further connected to the source of the Reset NMOS transistor 180. The drain of the Reset NMOS transistor 180 is connected to the power supply voltage source VDD. The gate of the Reset NMOS transistor 180 is connected to the reset signal 185. The reset signal 185 activates the Reset NMOS transistor 180 to couple the power supply voltage source VDD to the floating diffusion storage node 135 and the N⁺ photo detector region 115. The N⁺ photo detector region 115 is reset at the activation of the transfer gate 145 by draining the electrons in N⁺ photo detector region 115 to N⁺ diffusion 135.

The read out of a four transistor active pixel image sensor of the prior art begins by activation of the row select signal 170 to turn on the source follower NMOS transistor 165 to gate the pixel output electrical signal PIX_OUT 175 to external circuitry for processing and display. The pixel reset signal 185 is activated to turn on the reset Reset NMOS transistor 180 to connect the N+ photo detector region 115 and the floating diffusion storage node 135 to the power supply voltage source VDD to empty the N+ photo detector region 115 and the floating diffusion storage node 135 of any photoelectrons. The pixel output electrical signal PIX_OUT 175 is sampled by the external circuitry read the reset level present at the floating diffusion storage node 135. During this period, the photons 150 that impinge upon the pinned photodiode formed of the N+ photo detector region 115 and the shallow P+ pinning diffusion 120 are converted to photoelectrons and collected within the photo detector. At the completion of an integration period for the collection of the photoelectrons, the transfer gate signal 155 is activated to turn on the transfer gate switch to transfer the collected photoelectrons to the storage node of the floating diffusion 135. The collected photoelectrons that are retained at the floating diffusion 135 are the input to the source follower NMOS transistor 160. The amplitude of pixel output electrical signal PIX_OUT 175 from the drain of the source follower NMOS transistor 160 is indicative of the intensity of the light energy hν or the number of photons 150 absorbed by the pinned photodiode. Once the pixel output electrical signal PIX_OUT 175 is read out it is compared to the read out level of the reset signal and the external circuitry will perform correlated double sampling. The source follower transistor 160 threshold voltage mismatch and the noise of the reset signal [i.e., kT/C noise] of the storage node are then cancelled by correlated double sampling operation.

Refer now to FIG. 2 for an explanation of the structure of an array of pixel image sensor of the prior art. Multiple active pixel image sensors 100 are arranged in rows and columns. The active pixel image sensors 100 are three transistor active pixel image sensors of FIG. 1a or alternately, the four transistor active pixel image sensors of FIG. 1b. The row control circuit 180 provides the reset signals 182a, . . . , 182n, the row select signals 184a, . . . , 184n, and the transfer gating signals 185a, . . . , 185n for the four transistor active pixel image sensors of FIG. 1b. The output of each of the active pixel image sensors 100 of a column is connected respectively to a column pixel bus 195a, . . . , 195n. Each of the column pixel buses 195a, . . . , 195n is connected to a column sample and hold circuit 190.

The row control circuit 180 activates all the reset signals 182a, . . . , 182n for each of the active pixel image sensors 100. All reset signals 182a, . . . , 182n are activated for global shutter operation. Alternately, for rolling shutter which is most commonly used; the reset signals 182a, . . . , 182n are activated in sequence to provide the rolling shutter exposure. The sensors are exposed to light for an exposure period. For the three transistor active pixel image sensors of FIG. 1a , the row control circuit 180 activates each of row select signals 184a, . . . , 184n sequentially. The output signal representative of the intensity of the light that impinges on the array of active pixel image sensors 100 is applied to the column pixel buses 195a, . . . , 195n and thus to the column sample and hold circuits 190. The column sample and hold circuits 190 receive and condition the output signals for further processing.

If the array of active pixel image sensors 100 are the four transistor active pixel image sensors of FIG. 1b, each of the transfer gating signals 185a, . . . , 185n are activated prior to the row select signals 184a, . . . , 184n to transfer the accumulated photoelectrons from the photodiodes to a N⁺ floating diffusion storage node 135 of each four transistor active pixel image sensor of FIG. 1b. Upon completion of the transfer of the read out signals the transfer gating signals 185a, . . . , 185n and the row select signals 184a, . . . , 184n are deactivated and the next sequential row is activated as described above.

As is known in the art, a video display is formed of an array of picture elements or pixels. A pixel is one of the smallest complete elemental dots that make up the representation of a picture on a display. Usually the dots are so 15 small and so numerous they appear to merge into a smooth image. The color and intensity of each dot is variable. In color displays the pixels are generally formed of red, green, and blue sub-pixels that are of a size and arrangement that light emitting from them is added to form the color of the whole pixel. Pixels are either rectangular or square.

U.S. Pat. No. 6,903,754 (Brown-Elliott) teaches an arrangement of color pixels for full color imaging devices with simplified addressing referred to as the Pentile Matrix. The architecture of the array consists of an array of rows and column line architecture for a display. The array consists of a plurality of row and column positions and a plurality of three-color pixel elements. A three-color pixel element can comprise a blue emitter, a pair of red emitters, and a pair of green emitters. The blue emitter is placed in the center of a square formed of the pairs of red and green emitters. The pair of red emitters is on opposing corners of the square and the pair of green emitters is adjacent to the red emitters and the other opposing corners of the square.

Image sensor elements (either CMOS or Charged Coupled Devices) generally sense light as a grey-scaled value. Alternately, the pixel sensor elements, as described, are tuned to be sensitive to a particular hue of the color. If the pixel sensor elements sense only grey scale values they require a color filter array to generate the color components that are to be displayed. The color filter arrays, such as the Bayer Pattern as shown in U.S. Pat. No. 3,971,065 (Bayer), provide the color information for an image. Refer to FIG. 3 for a description of a Bayer pattern color array. The first green hue pattern, having elements denoted by G1, assumes every other array position with the red hue pattern of a given row. The second green hue pattern (G2) assumes an every other array position and alternates with the blue hue pattern (B) in alternate rows. In the case of pixel sensor elements detecting the grey scale values, the Bayer pattern color array will be a discrete dyed coating. In the case of those pixel sensor elements capable of sensing the discrete color components, the pixel sensor elements have their sensitivities tuned to receive specific colors and the pixel sensor elements are arranged in the Bayer pattern.

“A CMOS Image Sensor with a Double-Junction Active Pixel”, Findlater, et al., IEEE Transactions on Electron Devices, January 2003, Vol.: 50, Issue: 1, pp.: 32-42, describes a CMOS image sensor that employs a vertically integrated double-junction photodiode structure. The imager allows color imaging with only two filters. The sensor uses a 6-transistor pixel array.

U.S. Pat. No. 5,028,970 (Masatoshi) provides an image sensor for sequentially reading signals from photoelectric converting elements disposed in a matrix and formed on a substrate in which both an image sensor and a photometry sensor are incorporated. The sensor includes a light-shielding layer disposed over the area of the substrate except the area of the photoelectric elements, the light-shielding layer forming a lower electrode. A PN-junction photodiode layer is disposed over the light-shielding layer, and an upper transparent electrode layer is disposed at least over the photodiode layer. The upper transparent electrode layer is divided into a plurality of pattern areas. If desired, at least one of the pattern areas of the upper transparent electrode layer may be further divided into a plurality of very small areas and color filters formed over the very small areas.

U.S. Pat. No. 6,111,300 (Cao, et al.) teaches a multiple color detection elevated pin photodiode active pixel sensor formed on a substrate. A diode is electrically connected to a first doped region of the substrate. The diode conducts charge when the diode receives photons having a first range of wavelengths. A second doped region conducts charge when receiving photons having a second range of wavelengths. The photons having the second range of wavelengths pass through the diode substantially undetected by the diode. A doped well within the substrate conducts charge when receiving photons having a third range of wavelengths. The photons having the third range of wavelengths pass through the diode substantially undetected by the diode.

U.S. Pat. No. 6,486,911 (Denyer, et al.) describes an optoelectronic sensor with shuffled readout. The optoelectronic sensor is a multi-spectral image array sensor that senses radiation of different wavelengths e.g. different colors. The array has at least one row of cells containing a plurality of series (R, G) of pixels which series are interspersed with each other. Each series consists essentially of pixels for sensing radiation of substantially the same wavelength e.g. the same color. At least two horizontal shift registers are provided, each register being coupled to pixels of a respective one of the plurality of series (R, G) of pixels so as to enable the outputs from the pixels of each series to be read out consecutively at an array output. The pixels are preferably arranged in a Bayer matrix of Red, Green and Blue pixels and two interleaved shift registers are provided for reading out the pixel outputs for each color consecutively, in each row.

U.S. Pat. No. 6,693,670 (Stark) provides a multi-photodetector unit cell, which includes a plurality of light-detecting unit cells and a single charge-integration and readout circuitry. Typically, each of the cells produces charge representative of the detected light. The integration and readout circuit may be shared by the plurality of unit cells, and used to read-out the charge in real-time. The cluster may also include a switch associated with each unit cell, such that each switch connects its associated unit cell to the circuit. Each unit cell includes a photodetector, a photodiode or a photogate. The circuit includes a shared storage device, a shared reset circuit, or a readout circuit. Typically, the shared storage device may be for accumulating the charge in the focal plane.

U. S. Patent Application 2004/0201073 (Dosluoglu, et al.) provides detecting red and green light in a single pixel. The pixel includes a deep N well formed in a P type epitaxial substrate. A number of P wells, which are used as the sensor nodes, are formed in the deep N well. The use of these P wells as the sensor nodes improves the modulation transfer function. The depth of the deep N well is about equal to the depth of hole electron pairs generated by red light in silicon. The depth of the P wells is about equal to the depth of hole electron pairs generated by green light in silicon. A red/green signal is determined at each P well by determining the potentials between each of the P wells and the deep N well after a charge integration cycle with the P wells and the deep N well isolated. A green signal is determined at each P well by determining the potentials between each of the P wells and the deep N well after a charge integration cycle with the P wells isolated and the deep N well held at a fixed positive voltage. A red signal at each P well is determined by subtracting the green signal at that P well from the red/green signal at that P well.

U.S. Pat. No. 6,878,918 (Dosluoglu) teaches a circuit and method that suppresses reset noise in active pixel sensor arrays. A circuit having a number of N-wells formed in a P-silicon epitaxial layer or a number of P-wells formed in an N-silicon epitaxial layer is provided. A pixel is formed in each of the wells so that each of the wells is surrounded by silicon of the opposite polarity and an array of pixels is formed. Means are provided for selectively combining or binning adjacent N- or P-wells. During the reset period of the imaging cycle selected groups of adjacent pixels are binned and the charge injected by the resetting of a pixel is averaged among the neighboring pixels, thereby reducing the effect of this charge injection on any one of the pixels and thus reducing the noise generated. The reset is accomplished using a PMOS transistor formed in each N-well or an NMOS transistor formed in each P-well. The selective binning is accomplished using NMOS or PMOS transistors formed in the region between adjacent wells. Conductive traces between adjacent wells can also be used to accomplish the selective binning.

U.S. Pat. No. 5,359,213 (Lee, et al.) describes a charge transfer device capable of transferring signal charge at a high signal to noise ratio (S/N ratio) and preventing an occurrence of dark current. They include a double-layered charge transfer path structure provided by forming a surface channel region on a buried channel region formed in a semiconductor substrate, the surface channel region having a conductivity opposite to that of the buried channel region. The surface channel region of the doubled-layered structure is used for accumulating dark current generated from boundary surfaces between the substrate and a gate insulating film, whereas the buried channel region is used for transferring optical signal charge.

U.S. Pat. No. 5,739,562 (Ackland, et al.) provides an active pixel image sensor that includes an array of pixels arranged in two groups, for instance columns and rows. A first common conductor is coupled to the pixels in the first group for conducting control signals. A second common conductor is coupled to the pixels in the second group for selectively transmitting signals to processing electronics. Each of the pixels includes multiple sensing elements that are each configured for capturing a portion of energy from an object to be imaged. At least one of the sensing elements is of a type distinct from another of the sensing elements, for example, a photogate and a photodiode. An amplifying arrangement is provided for receiving signals from selected sensing elements and for selectively providing output signals to the second common conductor.

U.S. Pat. No. 6,934,050 (Merrill, et al.) provides a method for storing a full Red, Green, Blue (RGB) data set of a three-color image data captured with an imager array formed on a semiconductor substrate. The imager has multiple vertical-color-filter detector groups. Each of the vertical color detector groups is composed of three detector layers each configured to collect photo-generated carriers of a first polarity, separated by intervening reference layers configured to collect and conduct away photo-generated carriers of opposite polarity, the three detector layers being disposed substantially in vertical alignment with respect to one another and having different spectral sensitivities. The three-color image data is then stored as digital data in a digital storage device without performing interpolation on the three-color image data.

### SUMMARY OF THE INVENTION

An object of this invention is to provide an apparatus for controlling operation of a color multiple sensor pixel image sensor that senses differentiated color components of light impinging upon the multiple photosensor pixel image sensor.

To accomplish at least this object, a control apparatus is fabricated on a surface of a substrate with an array of color multiple sensor pixel image sensor to control operation of the array of color multiple sensor pixel image sensors that sense differentiated color components of light impinging upon the pixel image sensor. Each of the color multiple sensor pixel image sensors has a plurality of first level photosensing devices, a plurality of second level photosensing devices, a combined photosensing and charge storage device, and at least one reset triggering switch. Each of a plurality of first level transfer switches is connected between each first level photosensing device and the combined photosensing and charge storage device. Each of a plurality of second level transfer switches is connected between each of the second level photosensing devices and one of the first level photosensing devices. The plurality of first level and second level photosensing devices is formed within the surface of the substrate such that each first level and second level photosensing device is structured for conversion of photons of one of the differentiated color components to photoelectrons. The combined photosensing and charge storage device is formed within the surface of the surface and structured for conversion of photons of a principal color of the differentiated color components to photoelectrons and connected to sequentially receive photoelectrons from each of the plurality of photosensing devices. Each first level and second level triggering switch is connected such that photoelectrons are selectively and sequentially transferred from each of the plurality of first level and second level photosensing devices to the combined photosensing and charge storage device.

The reset triggering switch is in communication with the combined photosensing and charge storage device and through the triggering switches connected to the plurality of first level and second level photosensing devices. The reset triggering switch places the plurality of first level photosensing devices, the second level photosensing devices, and the combined photosensing and charge storage device to a reset voltage level after integration and sensing of the photoelectrons.

Each of the multiple photosensor pixel image sensors further includes at least one readout circuit connected to receive and convert photoelectrons retained by the combined photosensing and charge storage device for conversion to an electronic signal indicative of a magnitude of the color component of the light received by one selected photosensing device of the plurality of photosensing devices. The readout circuit includes a source follower connected to the storage node to receive and buffer a voltage indicative of a number of photoelectrons retained by the combined photosensing and charge storage device. A pixel select switch is selectively connected to the source follower to transfer the buffered voltage indicative of the number of photoelectrons by the combined photosensing and charge storage device to external circuitry for further processing.

The control apparatus includes a row control circuit in communication with rows of the array of plurality of color multiple sensor pixel image sensors. The control apparatus generates reset control signals, transfer gating signals, and row selecting signals for the array of plurality of color multiple sensor pixel image sensors. The timing of the transfer gating signals control the integration of photoelectrons generated from the light impinging upon the array of color multiple sensor pixel image sensors and charge transfer of the photoelectrons by the plurality of first and second level transfer switches between the second level photosensing devices to the first level photosensing device and from the first level photosensing devices to the combined photosensing and charge storage device. The control apparatus provides the row selecting signals for sequentially selecting rows of the plurality of color multiple sensor pixel image sensors such that output signals from each of the color multiple sensor pixel image sensors on a selected row are transferred for detection. The reset control signals control resetting of the rows of the array of plurality of color multiple sensor pixel image sensors. Further, reset control signals activate the reset triggering switch for resetting the individual first level and second level photosensing devices and the combined photosensing and charge storage device of each of the plurality of color multiple sensor pixel image sensors on a selected row.

The control apparatus further includes a column sample and hold circuit in communication with each column of the plurality of color multiple sensor pixel image sensors to sample and hold the conversion electrical signals from selected rows of the plurality of color multiple sensor pixel image sensors and from the sampled and held conversion electrical signals generating an output signal representative of a number of photon impinging upon each color multiple sensor pixel image sensor of the row of selected color multiple sensor pixel image sensors.

During a row reset period, the row control circuit transmits reset control signals to activate each reset triggering switch. Each of the first level triggering switches, and each of the second level triggering switches of each color multiple sensor pixel image sensor of a selected row of the array of the plurality of color multiple sensor pixel image sensors are activated to set each of the color multiple photosensor pixel image sensor of selected row of the array of color multiple sensor pixel image sensors to a reset level. During a light integration period, each of the color multiple sensor pixel image sensors of selected row of the array of color multiple sensor pixel image sensors are exposed to light impinging upon the array of color multiple sensor pixel image sensors. At completion of the light integration period, the row control circuit transmits row selecting signals to activate each pixel select switch of each of the color multiple sensor pixel image sensors of the selected row of the array of color multiple sensor pixel image sensors.

During a combined photosensing and charge storage device readout period, the column sample and hold circuit samples and holds the conversion electrical signal representing a number of photoelectrons converted during the exposure from each combined photosensing and charge storage device of each color multiple sensor pixel image sensor of the selected row. The column sample and hold circuit samples and holds the conversion electrical signal representing a reference voltage level of each of the color multiple sensor pixel image sensors of the selected row. The column sample and hold circuit then generates a color intensity signal representative of the intensity of light converted by each of the combined photosensing and charge storage device of the color multiple photosensor pixel image sensors of the selected row.

At a beginning of a first level photosensing device readout period, the row control circuit selects at least one of the first level photosensing devices for readout. Simultaneously, at the beginning of the first level photosensing device readout period, the row control circuit transmits the reset control signals to activate each reset triggering switch to reset each combined photosensing and charge storage device of the color multiple photosensor pixel image sensors of the selected row of color multiple sensor pixel image sensors to the reset level. During the first level photosensing device readout period, the column sample and hold circuit samples and holds the conversion electrical signal representing a reset level of each of the color multiple sensor pixel image sensors of the selected row. The row control circuit transmits at least one of the first level triggering signals to activate each first level triggering switch to transfer charge from the selected first level photosensing device to the combined photosensing and charge storage device of the color multiple photosensor pixel image sensors of the selected row. The column sample and hold circuit samples and holds the conversion electrical signal representing a number of photoelectrons converted during the exposure from each selected first level photosensing device connected to the combined photosensing and charge storage device of each color multiple sensor pixel image sensor of the selected row; During the first level photosensing device readout period the row control circuit sequentially selects one of the first level photosensing devices for readout until all first level photosensing devices are readout.

At a beginning of a second level photosensing device readout period, the row control circuit selects at least one of the second level photosensing devices for readout. Simultaneously, at the beginning of the second level photosensing device readout period, the row control circuit transmits the reset control signals to activate each reset triggering switch to reset each combined photosensing and charge storage device of the color multiple photosensor pixel image sensors of the selected row of color multiple sensor pixel image sensors to the reset level. During the second level photosensing device readout period, the column sample and hold circuit samples and hold the conversion electrical signal representing a reset level of each of the color multiple sensor pixel image sensors of the selected row. The row control circuit transmits at least one of the first level transfer gating signals to activate each first level triggering switch to transfer charge from the second level photosensing devices to the combined photosensing and charge storage device of the color multiple photosensor pixel image sensors of the selected row. The column sample and hold circuit samples and holds the conversion electrical signal representing a number of photoelectrons converted during the exposure from each selected second level photosensing device connected to the combined photosensing and charge storage device of each color multiple sensor pixel image sensor of the selected row. During the second level photosensing device readout period the row control circuit sequentially selects one of the first level photosensing devices for readout until all first level photosensing devices are readout.

During the first level photosensing device readout period, the row control circuit transmits one of the second level triggering signals to activate each second level triggering switch to transfer charge from the selected second level photosensing device to an associated first level photosensing device that has previously sampled, held and readout for temporary holding of the charge for sampling, holding, and reading out. Alternately, during the second level photosensing device readout period, the row control circuit transmits one of the second transfer gating signals to activate each second level triggering switch simultaneously with the first level triggering switch to transfer charge from the second level photosensing device through the selected first level photosensing device to the combined photosensing and charge storage device.

The row control circuit repeatedly transmits row selecting signals to activate each pixel select switch of each of the color multiple sensor pixel image sensors of another selected row of the array of color multiple sensor pixel image sensors and the row control circuit and the column sample and hold circuit perform the above operations of charge transfer, sample, hold and readout procedures until all rows of the array of the color multiple sensor pixel image sensors are transferred.

If each column of the array of color multiple sensor pixel image sensors has a single sample and hold circuit connected to a single analog-to-digital readout circuit, at the completion of the combined photosensing and charge storage device readout period, the row control circuit sequentially activates a column select signal to serially transfer each color intensity signal developed from each combined photosensing and charge storage device of each column of the selected row. Then, at the completion of the first level photosensing device readout period, the row control circuit sequentially activates a column select signal to serially transfer each color intensity signal developed from each readout circuit of first level photosensing device of the selected row. And then, at the completion of second level photosensing device period, the row control circuit sequentially activates a column select signal to serially transfer each color intensity signal developed from each readout circuit of the second level photosensing devices of the selected row.

Alternately, each column of the array of color multiple sensor pixel image sensors may have a one sample and hold circuit for each type of the combined photosensing and charge storage device, the first level photosensing devices, and the second level photosensing devices. Each of the sample and hold circuits for each type of the combined photosensing and charge storage device, the first level photosensing devices, and the second level photosensing devices is connected to a separate analog-to-digital readout circuit. At the completion of second level photosensing device period, this allows the row control circuit to sequentially activate a column select signal to serially transfer each color intensity signal developed from each readout circuit of the combined photosensing and charge storage device, the first level photosensing device, and the second level photosensing devices of the selected row in parallel for each column.

The first level triggering signals may be connected to more than one of the first level triggering switches and/or the second level triggering switches. The row control circuit transmits the one first level triggering signal to activate each the first level triggering switches and/or second level triggering switches to bin charge present on those first level photosensing devices and/or second level photosensing devices connected to the first level triggering switches and/or second level triggering switches. This then transfer the charge to the combined photosensing and charge storage device of the color multiple photosensor pixel image sensors for readout.

### BRIEF DESCRIPTION OF THE DRAWINGS

FIG. 1a is cross sectional views of a three-transistor photodiode CMOS active pixel image sensor of the prior art.

FIG. 1b is cross sectional views of a four-transistor pinned photodiode CMOS active pixel image sensor of the prior art.

FIG. 2 is a block diagram of an array of photodiode CMOS active pixel sensors of the prior art showing operational control circuitry.

FIG. 3 is a diagram illustrating a Bayer patterned color image sensor array of the prior art.

FIGS. 4a-4g are schematics of seven configurations of a first embodiment of a multiple photosensor pixel image sensor topology for which the operation control circuitry of this invention manipulates control signals.

FIG. 5a is a block diagram of a second embodiment of the multiple photosensor pixel image sensor topology for which the operation control circuitry of this invention manipulates control signals.

FIGS. 5b is a schematic diagram of the second embodiment of the multiple photosensor pixel image sensor topology for which the operation control circuitry of this invention manipulates control signals.

FIGS. 6a is a block diagram of a third embodiment of the multiple photosensor pixel image sensor topology for which the operation control circuitry of this invention manipulates control signals.

FIGS. 6b is a schematic diagram of the third embodiment of the multiple photosensor pixel image sensor topology for which the operation control circuitry of this invention manipulates control signals.

FIG. 7 is a block diagram of an image capture system employing an array of multiple photosensor pixel image sensors with associated operational control circuitry of this invention.

FIG. 8 is a block diagram of an array of multiple photosensor pixel image sensors with details of the associated operational control circuitry of this invention.

FIG. 9 is a schematic diagram of a multiple photosensor pixel image sensor illustrating associated operational control circuitry for activation and readout of this invention.

FIGS. 10a and 10b are schematic diagrams of the column sample, hold and readout circuitry details of the associated operational control circuitry of this invention

FIG. 11a is a cross sectional diagram of the first level photosensor device and the combined photosensing and charge storage device or the multiple photosensor pixel image sensor for which the operational control circuitry of this invention provides necessary control function.

FIG. 11b is a diagram of the voltage levels for the photosensors of FIG. 11a.

FIG. 11c is a cross sectional diagram of the second level photosensor device, first level photosensor device, and the combined photosensing and charge storage device or the multiple photosensor pixel image sensor for which the operational control circuitry of this invention provides necessary control function.

FIG. 11d is a diagram of the voltage levels for the photosensors of FIG. 11c.

FIG. 12 is a timing diagram of the operation control signals of this invention for a row of an array of multiple photosensor pixel image sensors with associated operational control circuitry of this invention showing the timing for the generation of photoelectrons developed from photons impinging upon the array of multiple photosensor pixel image sensors.

FIG. 13a is a timing diagram illustrating the operation of the control signals of this invention for a row multiple photosensor pixel image sensors of the array of multiple photosensor pixel image sensors with a single sample and hold circuit per column of the array of multiple photosensor pixel image sensors.

FIGS. 13b and 13c are a timing diagrams illustrating the operation of the control signals of this invention for a row multiple photosensor pixel image sensors of the array of Bayer patterned multiple photosensor pixel image sensors with a single sample and hold circuit per column of the array of multiple photosensor pixel image sensors.

FIG. 14 is a timing diagram illustrating the operation of the control signals of this invention for a row of multiple photosensor pixel image sensors of the array of multiple photosensor pixel image sensors with a sample and hold circuit for each type of photosensor for each column of the array of multiple photosensor pixel image sensors.

FIG. 15 is a timing diagram illustrating the operation of the control signals of this invention for a row of multiple photosensor pixel image sensors of the array of multiple photosensor pixel image sensors with a single sample and hold circuit per column of the array of multiple photosensor pixel image sensors having binning of the combined photosensing and charge storage device and a first level photosensors of the multiple photosensor pixel image sensor.

FIG. 16 is a timing diagram illustrating the operation of the control signals of this invention for a row of multiple photosensor pixel image sensors of the array of multiple photosensor pixel image sensors with a sample and hold circuit for each type of photosensor for each column of the array of multiple photosensor pixel image sensors having binning of the combined photosensing and charge storage device and a first level photosensors of the multiple photosensor pixel image sensor.

FIG. 17 is a timing diagram illustrating the operation of the control signals of this invention for a row of multiple photosensor pixel image sensors of the array of multiple photosensor pixel image sensors with a single sample and hold circuit per column of the array of multiple photosensor pixel image sensors having binning of the first level photosensors and the second level photosensor of the multiple photosensor pixel image sensor.

FIG. 18 is a timing diagram illustrating the operation of the control signals of this invention for a row of multiple photosensor pixel image sensors of the array of multiple photosensor pixel image sensors with a sample and hold circuit for each type of photosensor for each column of the array of multiple photosensor pixel image sensors having binning of all the combined photosensing and charge storage device, the first level photosensors, and the second level photosensor of the multiple photosensor pixel image sensor.

FIG. 19 is a flow chart of the method of this invention for controlling the operation of an array of multiple photosensor pixel image sensors.

FIGS. 20a-20c are flow charts of a method of this invention for readout of the multiple photosensors of one multiple photosensor pixel image sensor with a single sample and hold circuit per column of the array of multiple photosensor pixel image sensors.

FIGS. 21a-21b are flow charts of a method of this invention for readout of the multiple photosensors of one multiple photosensor pixel image sensor with a sample and hold circuit for each type of photosensor for each column of the array of multiple photosensor pixel image sensors.

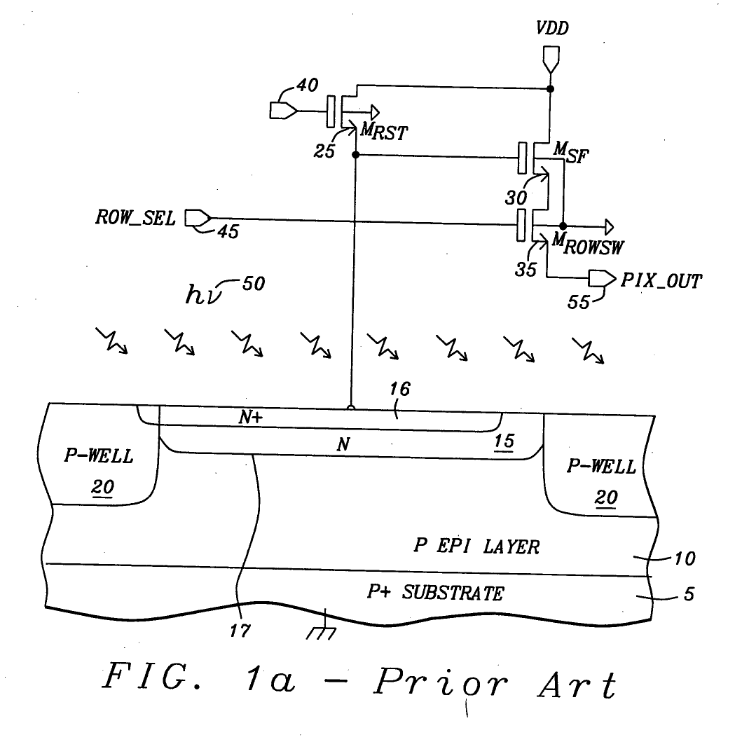

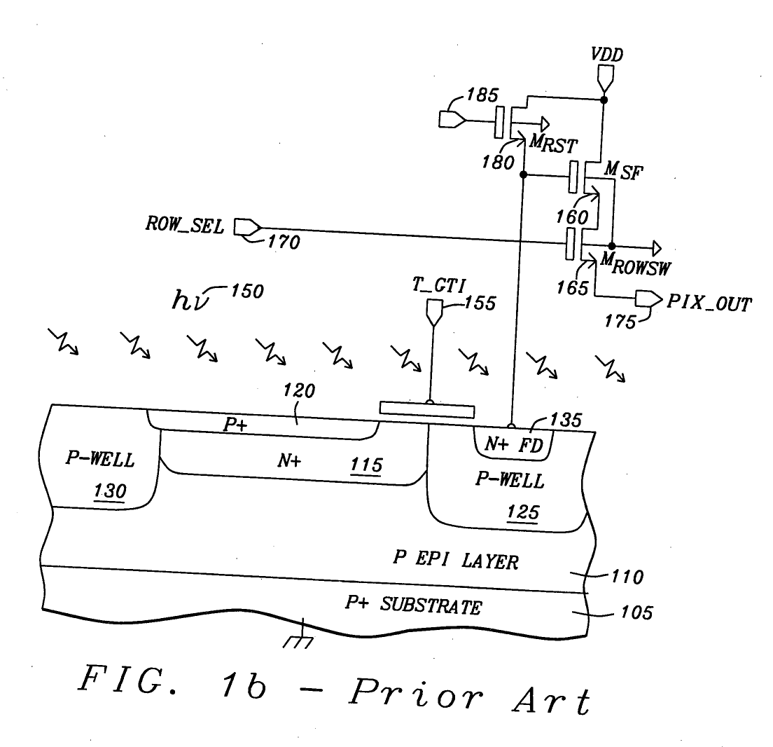

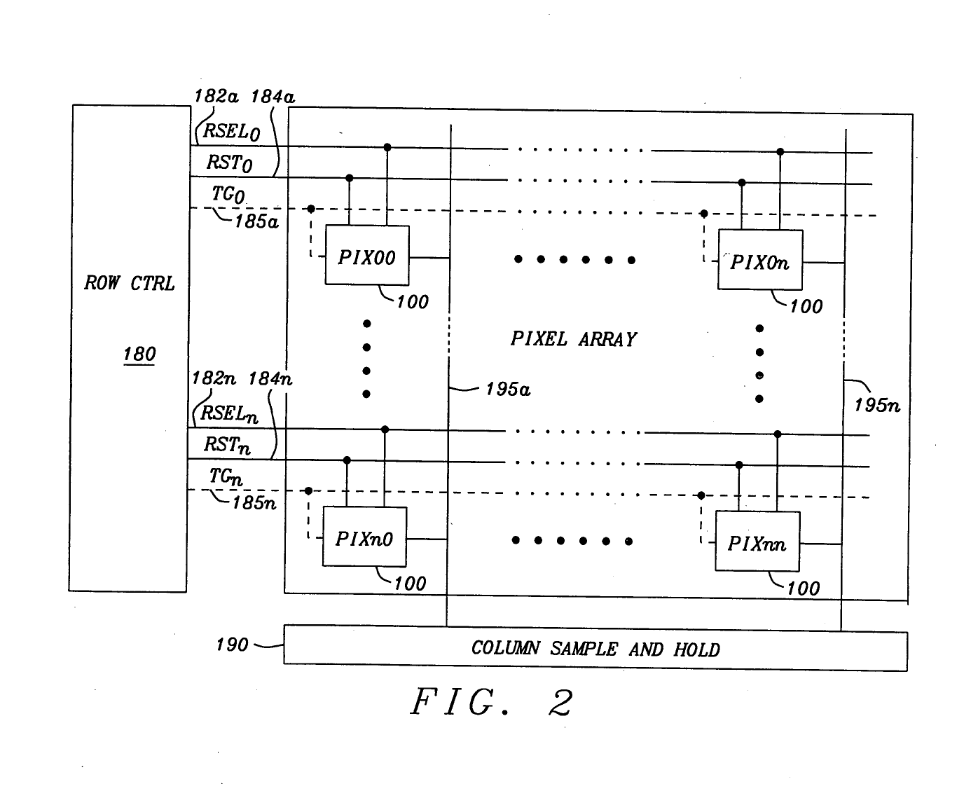

### DETAILED DESCRIPTION OF THE INVENTION

The multiple photosensor pixel image sensor for which the operation control circuitry of this invention manipulates control signals preferably has four photosensing devices formed in a 2×2 matrix. One of the four photosensing devices is constructed to act as a combined photosensing and charge storage device and the remaining three devices are standard pinned photodiodes connected to the combined photosensing and charge storage device. In the preferred embodiment, the combined photosensing and charge storage device has its light sensitivity tuned to be sensitive to one principle color component or hue of light emitted or reflected from an object. In the case of a Red, Green, and Blue image sensor, the combined photosensing and charge storage device is tuned to receive a Red hue. Two of the remaining pinned photodiodes are tuned for detecting the same differentiated color component of the light and the third pinned photodiode is tuned for detecting the third of the differentiated color components of the light. In the preferred embodiment the two photodiodes receive the green hue and the third photodiode receives the blue hue.

The two pinned photodiodes that receive the green hue and the pinned photodiode that receives the blue hue are each connected directly or indirectly through an NMOS transfer gate to the combined photosensing and charge storage device that receives the red hue. The combined photosensing and charge storage device is readout with a double sampling process. The combined photosensing and charge storage device is reset and the first photodiode that receives the green hue is readout with correlated double sampling. The combined photosensing and charge storage device is reset and each of the three pinned photodiodes that receives the green hue and blue hue are readout with correlated double sampling.

The combined photosensing and charge storage device is connected directly to the gate of a source follower NMOS transistor to buffer the voltage level of the combined photosensing and charge storage device that is proportional to the amplitude of the differentiated color components of the light received by the pixel image sensor. A row switching NMOS transistor is connected to the source of the source follower NMOS transistor to gate the output voltage of the source follower transistor to the readout circuitry present at each row of an array of the pixel image sensors.

The multiple photosensor pixel image sensors are arranged in rows and columns to form an array. Each row of the multiple photosensor pixel image sensors are connected to a row control circuit of the operation control circuitry of this invention. The row control circuit provides a row reset signal to reset each multiple photosensor pixel image sensor of a selected row of the array to a reset level that is approximately the voltage level of the power supply voltage source. The array of multiple photosensor pixel image sensors is exposed to the light for the conversion of the photons to photoelectrons. The number of photoelectrons being proportional to the number of photons impinging upon the photo sensors of the multiple photosensor pixel image sensor.

The row control circuit activates a row select signal to read out each of the photosensors of each of the multiple photosensor pixel image sensors on a row. The conversion signal of the combined photosensing and charge storage device is applied to a column sample and hold circuit of the operation control circuitry to be sampled and held. The row control circuitry then resets each combined photosensing and charge storage device of the multiple photosensor pixel image sensors of the selected row and the column sample and hold circuit then samples and holds the reset level. The conversion signal and the reset level are combined to generate and output voltage that represents the amplitude of the light impinging upon the combined photosensing and charge storage device.

The row control circuit then resets the combined photosensing and charge storage device and the column and sample and hold circuit samples and holds the reset level of the combined photosensing and charge storage device. The row control circuit then transmits a first level transfer gating signal to activate the first level transfer gate of a first of the three photodiodes to transfer the collected photoelectrons to the combined photosensing and charge storage device of each of the multiple photosensor pixel image sensors of the selected row. The column sample and hold circuit then samples and holds the conversion signal of the first photodiode. The reset level and the conversion signal are combined to generate and output voltage that represents the amplitude of the light impinging upon the first photodiode.

The row control circuit then resets the combined photosensing and charge storage device and the column and sample and hold circuit samples and holds the reset level of the combined photosensing and charge storage device. The row control circuit then transmits a first transfer gating signal to activate the first level transfer gate of a second of the three photodiodes to transfer the collected photoelectrons to the combined photosensing and charge storage device of each of the multiple photosensor pixel image sensors of the selected row. The column sample and hold circuit then samples and holds the conversion signal of the first photodiode. The reset level and the conversion signal are combined to generate and output voltage that represents the amplitude of the light impinging upon the second photodiode.

The row control circuit then resets the combined photosensing and charge storage device and the column and sample and hold circuit samples and holds the reset level of the combined photosensing and charge storage device. At this same time, the row control circuit also transmits a second level transfer signal to activate a second level transfer gate between the third photodiode and the first photodiode to transfer the photoelectrons from the third photodiode and the first photodiode. The row control circuit then activates a first level transfer gating signal to activate the first level transfer gate of a first of the three photodiodes to transfer the collected photoelectrons of the third photodiode present on the first photodiode to the combined photosensing and charge storage device of each of the multiple photosensor pixel image sensors of the selected row. The column sample and hold circuit then samples and holds the conversion signal of the third photodiode. The reset level and the conversion signal are combined to generate and output voltage that represents the amplitude of the light impinging upon the third photodiode.

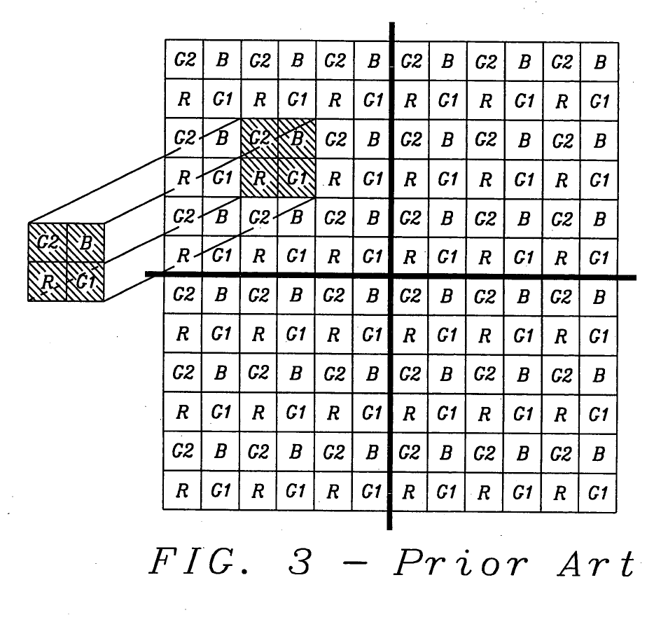

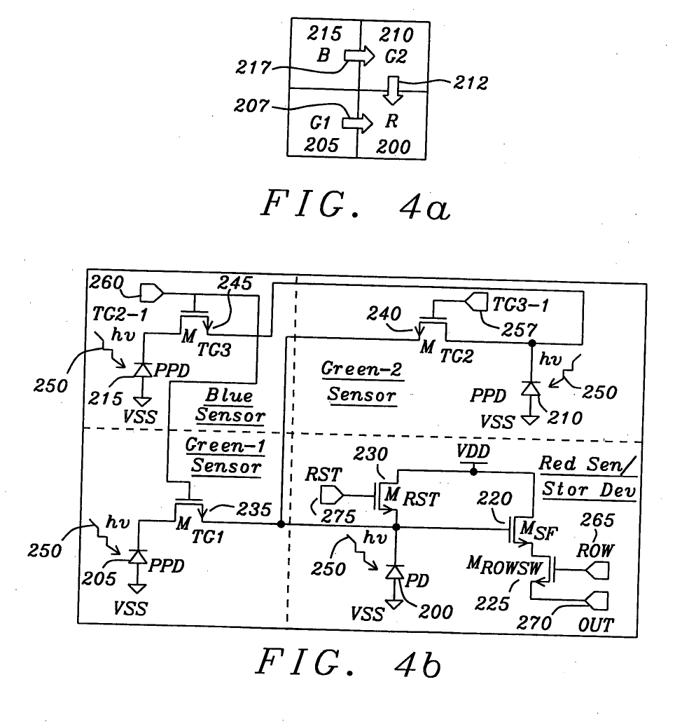

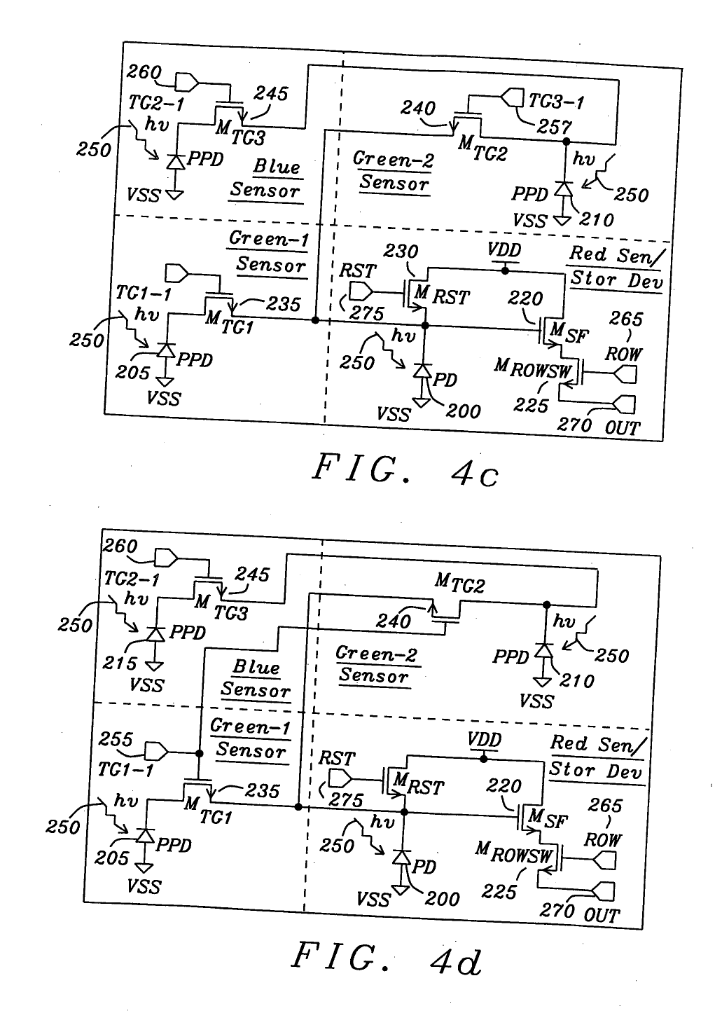

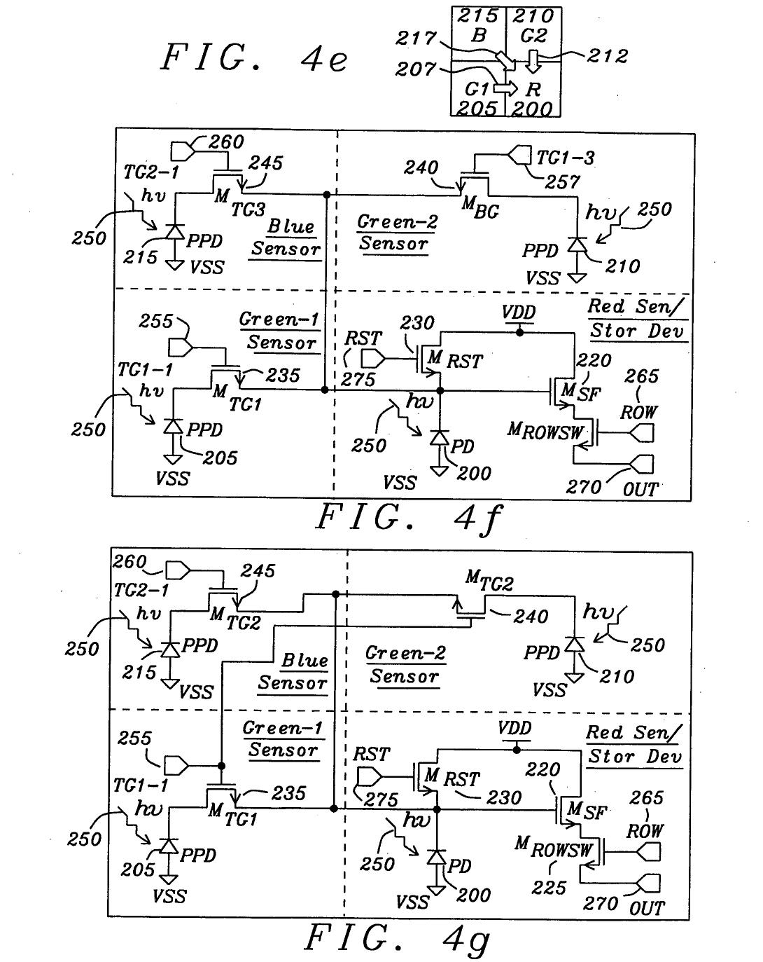

Dosluoglu—436 provides a detailed description of the multiple photosensor pixel image sensor for which the operation control circuitry of this invention manipulates control signals. Refer to FIG. 4a and 4e for a summary description of the topology of the multiple photosensor pixel image sensor for which the operation control circuitry of this invention manipulates control signals. The pixel image sensor, as shown, has four photodiodes configured in a Bayer pattern color array of FIG. 3. The red photodiode 200 functions as a combined photosensing and charge storage device in that it senses the red differentiated color components of light impinging upon the photodiodes of the pixel image sensor. After the integration and sensing of the red differentiated color components of light, the red photodiode 200 is used as the charge storage node for the remaining photosensors 205, 210, and 215 of the pixel image sensor. In FIG. 4a, the charge 207 and 212 flows from the first green photodiode 210 and the second green photodiode 210 flow directly to the combined photosensing and charge storage device 200. The charge 217 from the blue photodiode 215 flows first to the second green photodiode 210 and thence to the combined photosensing and charge storage device 200. The circuits shown in FIGS. 4b-4d illustrate the configurations of the multiple photosensor pixel image sensor where the charge 207 and 212 flows from the first green photodiode 210 and the second green photodiode 210 flow directly to the combined photosensing and charge storage device 200 and the charge 217 from the blue photodiode 215 flows first to the second green photodiode 210 and then to the combined photosensing and charge storage device 200. In FIG. 4e, the charge 207, 212 and 217 flows from the first green photodiode 210, the second green photodiode 210, and the blue photodiode 215 flow directly to the combined photosensing and charge storage device 200. The circuits shown in FIGS. 4f and 4g illustrate the configurations of the multiple photosensor pixel image sensor where the charge 207, 212 and 217 flows from the first green photodiode 210, the second green photodiode 210, and the blue photodiode 215 flow directly to the combined photosensing and charge storage device 200.

Referring now to FIG. 4b for a review of the structure of the preferred embodiment of the multiple photosensor pixel image sensor of Dosluoglu—436. The first green photodiode 205 is connected through the NMOS transfer gate 235 to the red photodiode 200 and the second green photodiode 210 is connected through the NMOS transfer gate 240 to the red photodiode 200. The blue photodiode 215 is connected through the NMOS third transfer gate 245 to the first green photodiode 210. The cathode of the red photodiode 200 acts as the photoelectron storage node for the pixel image sensor and is connected to the gate of the source follower NMOS transistor 220. The drain of the source follower NMOS transistor 220 is connected to the power supply voltage source VDD and the source is connected to the drain of the row select NMOS gating transistor 225. The gate of the row select NMOS gating transistor 220 is connected to the row select signal 265 and the source is connected to the output terminal 270 for connection to the readout circuit of a row of an array of the pixel image sensors. The row select signal 265 activates the row select NMOS gating transistor 225 to transfer the voltage at the source of the source follower NMOS transistor 220 to the readout circuitry attached to the row. The voltage at the source of the source follower NMOS transistor 220 is proportional to the number of photons 250 that impinge upon the photodiodes of the pixel image sensor.

The first level transfer gate signal TG1-3 257 is connected to the gate of the NMOS transfer gate 240 and the second level transfer gate signal TG2-1 260 is connected to the gate of the NMOS transfer gate 235 and the gate of the third transfer gate 245. The first level transfer gate signal TG1-3 255 and the second level transfer gate signal TG2-1 257 provide the control signals for the activation of the NMOS transfer gates 235, 240, and 245 for the transfer of the photoelectrons collected in the conversion of the photons to the red photodiode 200.

The source of the NMOS reset transistor 230 is connected to the cathode of the red photodiode 200 and the sources of the NMOS transfer gates 235 and 240. The drain of the NMOS reset transistor 230 is connected to the power supply voltage source VDD and its gate is connected to the reset signal 275. The pixel image sensor is initiated and each of the photodiodes 200, 205, 210, and 215 are reset by setting the reset signal 275 to turn on the NMOS reset transistor 230. The row select signal is set to activate the row select NMOS gating transistor 225 to transfer the voltage present at the source of the source follower NMOS transistor 220 that is proportional to the number of photoelectrons present at the cathode of the red photodiode 200 to the read out circuitry for further processing. The first level and second level transfer gate signals TG1-3 257 and TG2-1 260 are set to activate the NMOS transfer gates 235, 240, and 245. Each of the photodiodes 200, 205, 210, and 215 are then reset.

The NMOS transfer gates 235, 240, and 245 and the NMOS reset transistor 230 are deactivated and the photodiodes 200, 205, 210, and 215 are exposed to the photons of the light 250. The photons are converted within the photodiodes 200, 205, 210, and 215 to generate the photoelectrons. The photodiodes 200, 205, 210, and 215 maybe constructed for receiving similar wavelengths of the light 250 and the colors are filtered using dyed coatings over the photodiodes 200, 205, 210, and 215. Alternately, the photodiodes 200, 205, 210, and 215 have their structure tailored to receive a particular differentiated color component of the light 250. In the preferred embodiment, the combined photosensing and charge storage photodiode 200 is tailored to receive the red hue. The photodiodes 205 and 210 are tailored to receive the green hue and the photodiode 215 is tailored to receive the blue hue.

At the completion of the integration of the photoelectrons at each of the photodiodes 200, 205, 210, and 215, the voltage developed by the red photoelectrons at the cathode of the red photodiode 200 is presented at the gate of the source follower NMOS transistor 220. The reset signal is then set to activate the NMOS reset transistor 230 to reset the red photodiode 200 and the reset level is then read by the read out circuitry to provide a double sampling reading of the red photodiode 200.

The reset signal 275 is again set to activate the NMOS reset transistor 230 to reset the red photodiode 200 and the reset level is then read by the read out circuitry to provide a reference sampling of the red photodiode 200 for a correlated double sampling of the second green photodiode 210. The first transfer gate signal 255 is set such that the NMOS transfer gate 240 is activated and the charge accumulated during the integration period on the second green photodiode 210 is transferred to the red photodiode 200 acting as the charge storage device of the second green photodiode 210. The charge now present on the red photodiode 200 is applied to the gate of the source follower NMOS transistor 220. The row select signal 265 is set to a level to activate the row select NMOS gating transistor 225 to transfer the voltage present at the source of the source follower NMOS transistor 220 that is proportional to the number of photoelectrons present at the cathode of the red photodiode 200 that were transferred from the second green photodiode 210 to the read out circuitry for further processing.

The first level transfer gate signal TG1-3 257 is set such that the NMOS transfer gate 240 is deactivated and the reset signal 275 is again set to activate the NMOS reset transistor 230 to reset the red photodiode 200 and the reset level is then read by the read out circuitry to provide a reference sampling of the red photodiode 200 for a correlated double sampling of the first green photodiode 205. The second level transfer gate signal TG2-1 260 is set to activate the NMOS transfer gate 235 and the charge accumulated during the integration period on the first green photodiode 205 is transferred to the red photodiode 200 acting as the charge storage device of the first green photodiode 205. The charge now present on the red photodiode 200 is applied to the gate of the source follower NMOS transistor 220. The row select signal 265 is set to a level to activate the row select NMOS gating transistor 225 to transfer the voltage present at the source of the source follower NMOS transistor 220 that is proportional to the number of photoelectrons present at the cathode of the red photodiode 200 that were transferred from the first green photodiode 205 to the read out circuitry for further processing. The second transfer gate signal 260 is set to activate the NMOS third transfer gate 245 to transfer the charge from the cathode of the blue photodiode 215 to the second green photodiode 210. The second green photodiode 210 acting as a binning device for the blue photodiode 215.

The second transfer gate signal 260 is then set to activate the NMOS transfer gate 235 and the NMOS third transfer gate 245. The reset signal 275 is again set to activate the NMOS reset transistor 230 to reset the red photodiode 200 and the reset level is then read by the read out circuitry to provide a reference sampling of the red photodiode 200 for a correlated double sampling of the first green photodiode 205 retaining the photoelectron charges from the The second transfer gate signal 260 is set to activate the NMOS transfer gate 235 and the charge accumulated during the integration period on the first green photodiode 205 is transferred to the red photodiode 200 acting as the charge storage device of the blue photodiode 215 with the first green photodiode 205 acting as the binning device. The charge now present on the red photodiode 200 is applied to the gate of the source follower NMOS transistor 220. The row select signal 265 is set to a level to activate the row select NMOS gating transistor 225 to transfer the voltage present at the source of the source follower NMOS transistor 220 that is proportional to the number of photoelectrons present at the cathode of the red photodiode 200 that were transferred from the blue photodiode 215 to the read out circuitry for further processing. The process is continuously repeated starting with the resetting of the photodiodes 200, 205, 210, and 215 as described above.

It is obvious to one skilled in the art that the NMOS transfer gates 235, 240, and 245 may have separate transfer gate signals TG1-1 255, TG1-3 257, and TG2-1 260 as shown in FIG. 4c. In this case the first level transfer gate signal TG1-3 257 is activated to turn on the NMOS transfer gate 240 after the red combined photosensing and charge storage device 200 has been read out. This provides the reading out the second green photodiode 210. The transfer gate signal TG1-3 257 is deactivated to turn off the NMOS transfer gate 240 and the second level transfer gate signal TG2-1 260 is activated to turn on the NMOS transfer gate 235 for reading out the first green photodiode 205. Finally, both first level transfer gate signals TG1-1 255 and TG1-3 257 are activated to turn on the NMOS transfer gates 240, and 245 simultaneously allowing the charge from the blue photodiode 215 to be transferred through the second green photodiode 210 to the red combined photosensing and charge storage device 200.

In FIG. 4d, the first level transfer gate signal TG1-1 255 is connected to the gates of the NMOS transfer gates 235 and 240 to act to bin the charges of the two green photodiodes 205 and 210. The second level transfer gate signal TG2-1 260 is connected to the gate of the NMOS transfer gate 245. After the red combined photosensing and charge storage device 200 has been read out, the first level transfer gate signal TG1-1 255 is activated to turn on the NMOS transfer gates 235 and 240 to transfer the charge of the first and the second green photodiodes 205 and 210 to the red combined photosensing and charge storage device 200 for read out. Both the first and the second green photodiodes 205 and 210 are reset and the first level transfer gate signal TG1-1 255 is deactivated. The second level transfer gate signal TG2-1 260 is activated and the charge from the blue photodiode 215 is transferred to the second green photodiodes 210. The first level transfer gate signal TG1-1 255 is activated simultaneously or sequentially with the second level transfer gate signal TG2-1 260 and the charge transferred to the red combined photosensing and charge storage device 200 for read out.

FIG. 4f illustrates one example where the charge of the multiple photosensors 205, 210, and 215 are transferred directly to the red combined photosensing and charge storage device 200, as explained in FIG. 4e. In FIG. 4f, the transfer gate signals TG1-1 255, TG1-3 257, and TG2-1 260 are connected 5 respectively to the gates of the NMOS transfer gates 235, 240, and 245. Each of the transfer gate signals TG1-1 255, TG1-3 257, and TG2-1 260 is sequentially activated to transfer the charge from the first green photodiodes 205, the second green photodiodes 210, and the blue photodiode 215 to the red combined photosensing and charge storage device 200 for read out. In FIG. 4g, the first transfer gate signal TG1-1 255 is connected to the gates of the NMOS transfer gates 235 and 240. The second level transfer gate signal TG2-1 260 is connected to the gate of the NMOS transfer gate 245. The first level transfer gate signal TG1-1 255 permits the binning of the charges of the first and the second green photodiodes 205 and 210. The transfer gate signals TG1-1 255 and TG2-1 260 are sequentially activated to turn on the NMOS transfer gates 235, 240, and 245 appropriately to transfer the charges to the red combined photosensing and charge storage device 200 for readout.

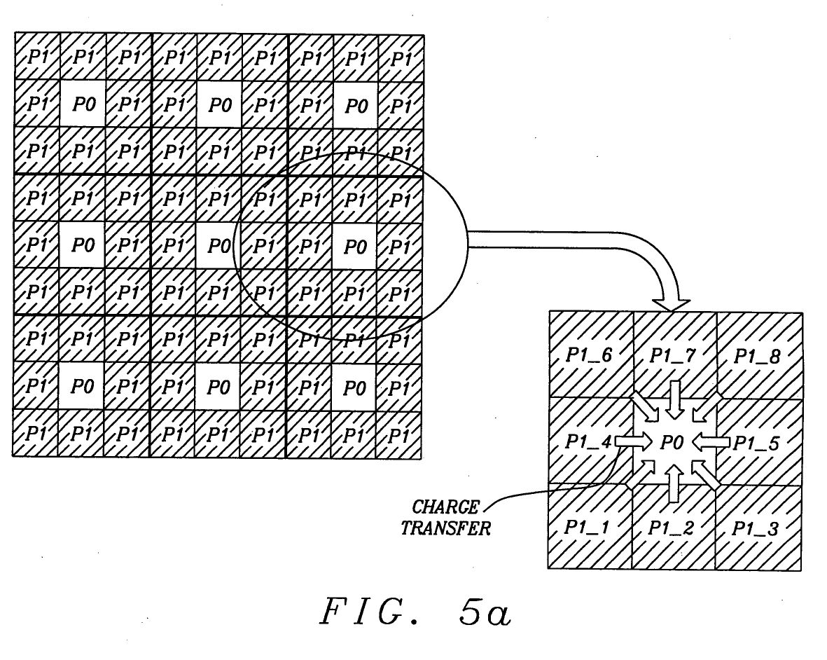

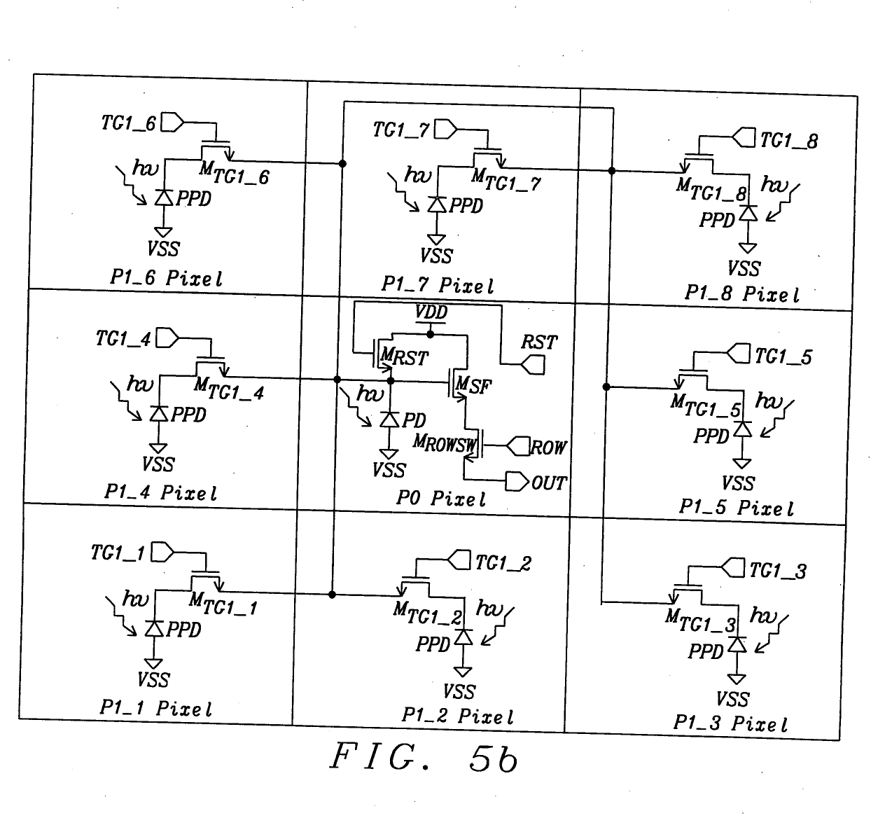

The embodiment as shown in Dosluoglu—436 and summarized above illustrates a combined photosensing and charge storage device having multiple photosensors or pinned photodiodes connected to transfer any charge to the a combined photosensing and charge storage device for read out. The charge from more remote photosensors may be transferred through another photosensing device as shown in the 2×2 pixel image sensor explained in Dosluoglu—436 and summarized above. It is obvious to one skilled in the art that larger grouping of the photosensors maybe connected to transfer the integrated charge to the combined photosensing and charge storage device. FIGS. 5a and 5b illustrate a second embodiment of the multiple photosensor pixel image sensor topology for which the operation control circuitry of this invention manipulates control signals. The combined photosensing and charge storage device (P0) and the photosensors P1_{—}n (n=1, 2, . . . , 8) are arranged in a 3×3 matrix with the combined photosensing and charge storage device (P0) placed in the center location of the matrix and the photosensors P1_{—}n are arranged in the surrounding positions of the matrix. The combined photosensing and charge storage device (P0) is a red photodiode device coupled with a readout circuit as described in FIG. 4a above. Photosensors (P1) are the first green, second green and the blue photosensor or pinned photodiode (PPD) pixels with transfer gate also as described in FIG. 4a. Charge in the photosensor or pinned photodiode (PPD) of photosensors P1_{—}n transfers to photodiode in the combined photosensing and charge storage device (P0) through transfer gate M_{TG1}_{_{—}}ₙ (n=1, 2, . . . , 8). The combined photosensing and charge storage device (P0) and Photosensors P1_{—}n either can be readout individually or can be binned during readout (by any combination) by controlling the timing of the transfer signals TG1_{—}n to activate the transfer gates M_{TG1}_{_{—}}ₙ. Based on the applications, the conductors transporting the transfer signals TG1_{—}n can be tight together on certain combination to enlarge the pixel open space (running less wires) and to increase the pixel fill factor, if the binning pattern is pre-defined.

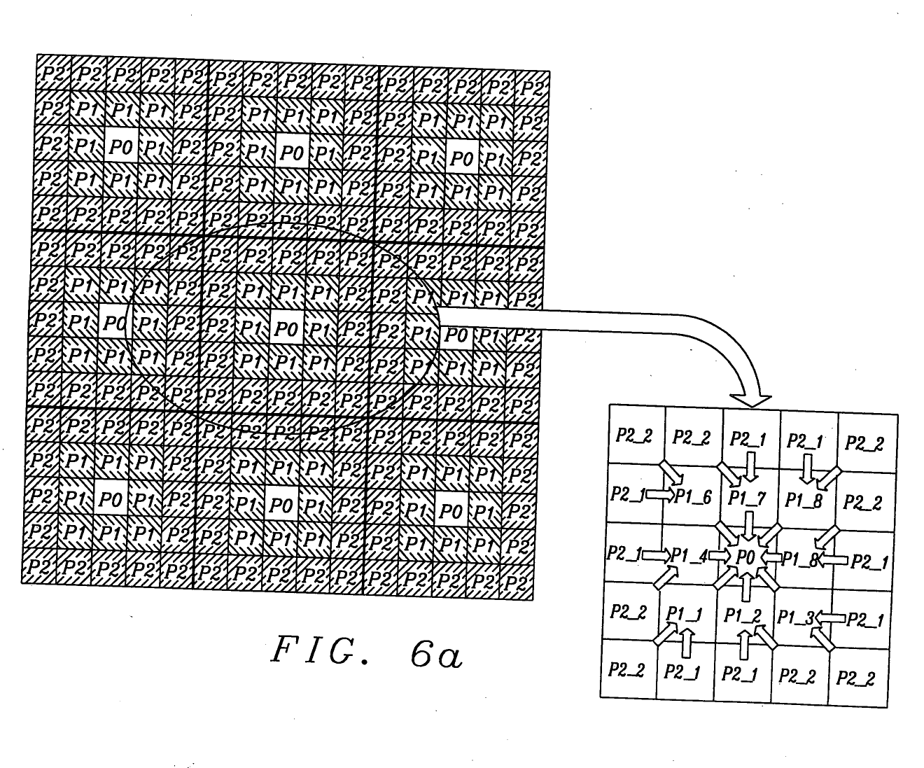

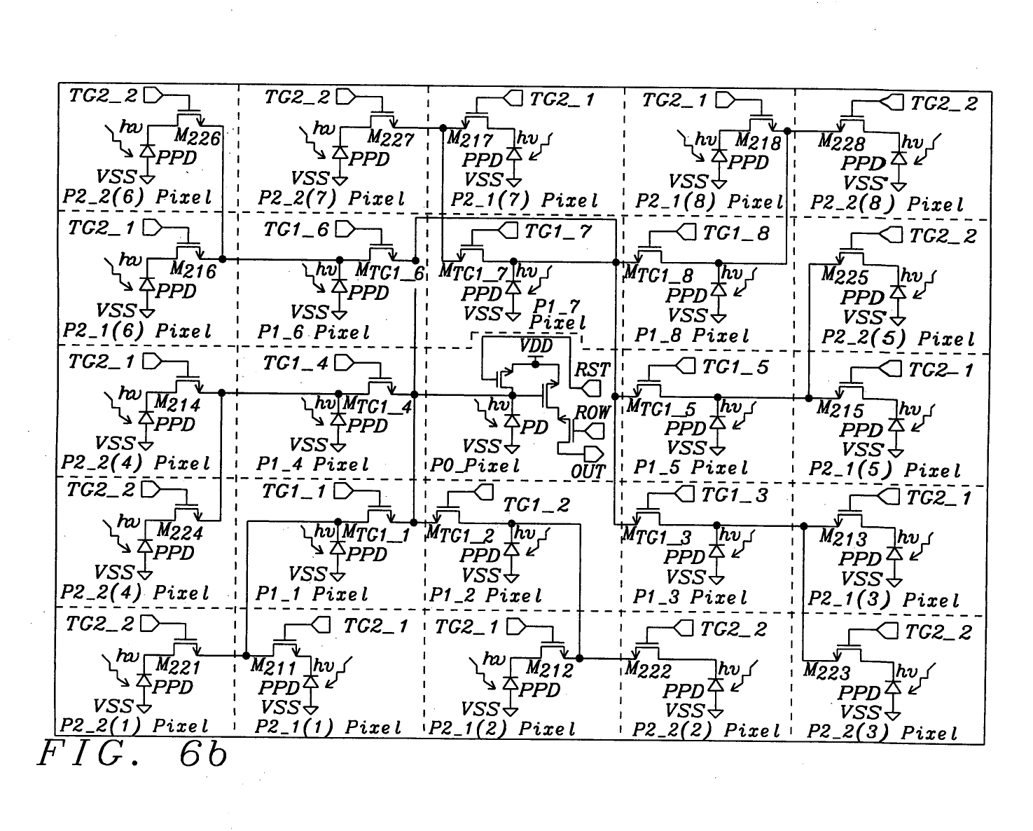

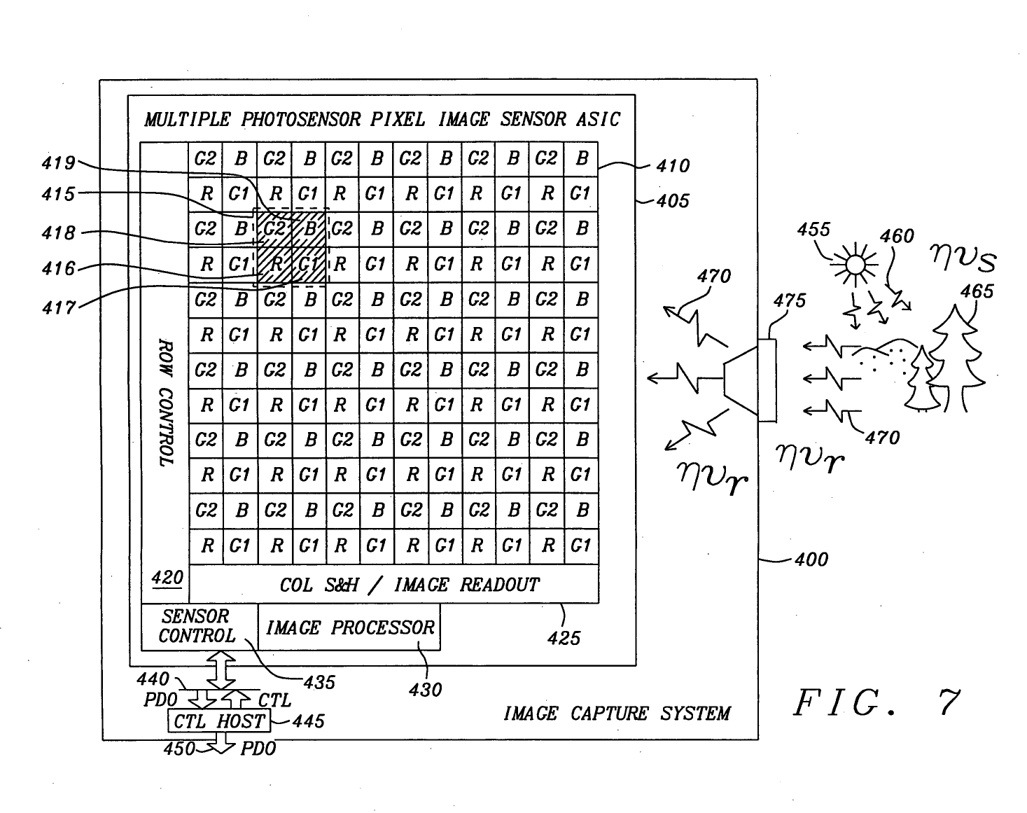

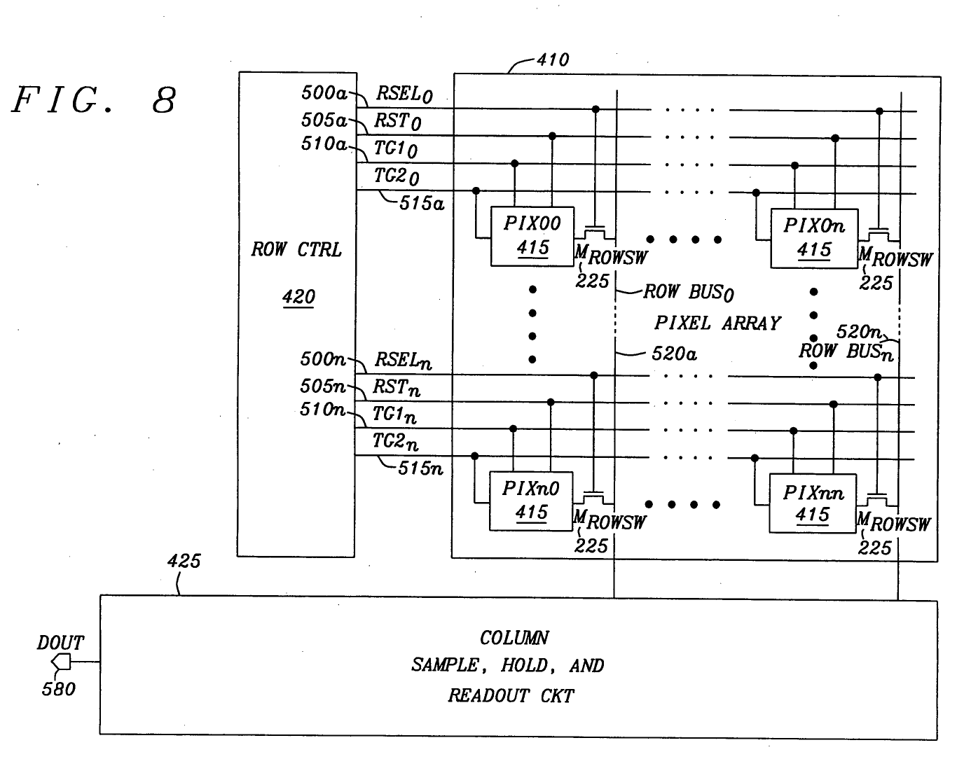

FIGS. 6a and 6b illustrate a third embodiment of the multiple photosensor pixel image sensor topology for which the operation control circuitry of this invention manipulates control signals. The combined photosensing and charge storage device (P0) and the photosensors P1_{—}n (n=1, 2, . . . , 8) are arranged in a 5×5 matrix with the combined photosensing and charge storage device (P0) placed in the center location of the matrix and the photosensors P1_{—}n are arranged in the positions surrounding the combined photosensing and charge storage device (P0). This approach illustrates the multiple photosensor pixel image sensor topology with much less pixel readout circuits in the pixel array (1 out of 25, or 4%) than a standard arrangement with each pixel image sensor having one sensor and one read out circuit.

FIG. 6b shows the schematic of the approach of 5×5 pixel image sensor array sharing one combined photosensing and charge storage device (P0) having one readout circuit. The combined photosensing and charge storage device (P0) is the red photodiode combination sensor and storage device with the readout circuit. Photosensors P1_{—}n are the photosensors or pinned photodiodes (PPD) with the transfer gates M₁_{_{—}}ₙ (n=1, 2, . . . , 8). Charge in the photosensors or pinned photodiodes (PPD) P1_{—}n (n=1, 2, . . . , 8) transfer to the combined photosensing and charge storage device (P0) pixel through transfer gates M_{TG1}_{_{—}}ₙ (n=1, 2, . . . , 8). Photosensors P2_{—}m (n=1, 2, . . . , 16) are also the photosensors or pinned photodiodes (PPD) with transfer gate, M_{2xy} (x=1, 2, y=1, 2, . . . , 8), connecting to the photosensor or pinned photodiodes P1_{—}n. The combined photosensing and charge storage device (P0), the photosensors P1_{—}n, and the photosensors P2_{—}n either can be readout individually or can be binned during readout (by any combination) by controlling the transfer signals of TG1_{—}n and TG2_{—}m. It should be noted that there are only two transfer signals TG2_{—}m in this approach. Readout of the photosensors P2_{—}n has two phases: transfer the charge from the photosensors P2_{—}n to the photosensors P1_{—}n (eight photosensors P2_{—}n per transfer in parallel), then transfer the charge from the photosensors P1_{—}n to combined photosensing and charge storage device (P0) for readout.

Refer now to FIG. 7 for a discussion of an image capture system incorporating an array of the multiple photosensor pixel image sensors and the operation control circuitry of this invention that manipulates control signals for controlling functioning of the array of multiple photosensor pixel image sensors. The image capture system 400 has a multiple photosensor pixel image sensor application specific integrated circuit (ASIC) 405 that includes an array 410 of multiple photosensor pixel image sensors 415 as described above in FIG. 4b arranged in rows and columns. Each of the multiple photosensor pixel image sensors has a combined photosensing and charge storage device 416 that is sensitive to red light and three photodiodes 417, 418, and 419. The two photodiodes 417 and 418 are sensitive to green light and the photodiode 419 is sensitive to blue light. The two photodiodes 417 and 418 are connected through transfer switches to the combined photosensing and charge storage device 416 and the photodiode 419 is connected to the photodiode 417 through a transfer gate as described above. The row control circuit 420 of the operational control circuitry of this invention provides the control signals for resetting and reading out of the rows of the array 410 of multiple photosensor pixel image sensor 415. The Column Sample and Hold and Readout circuit 425 of the operational control circuitry of this invention receives the conversion signals from the rows of the array 410 of multiple photosensor pixel image sensor 415 and generates the output signals that are amplified and converted to pixel data. The Column Sample and Hold and Readout circuit 425 transfers the pixel data to the image processor for further processing. The sensor control 435 communicates control signals and timing for the generation of the necessary control signals for resetting and reading out of the rows of the array 410 of multiple photosensor pixel image sensor 415 and the timings for the sampling, holding and reading out of the conversion signals from the array 410 of the multiple photosensor pixel image sensors 415. The Input/Output bus 440 transfers the necessary control signals from the host controller 445 to the sensor controller and the processed pixel data to the host controller 440 for even further encoding and processing. The host controller 445 then transmits the pixel data out 450 to external systems for display or reproduction.

A light source (the sun) 455 provides light 460 that is reflected from the objects 465. The reflected light 470 is focused by a lens 475 to impinge on the array 410 of multiple photosensor pixel image sensors 415.

Refer now to FIG. 8 for a discussion of the structure of the array 410 of multiple photosensor pixel image sensors and the row control circuit and the column sample and hold and readout circuit 425 that form the operation control circuitry of this invention. The multiple photosensor pixel image sensors 415 are placed in columns and rows to form the array 410. Each of the multiple photosensor pixel image sensors 415 are structured as explained in FIG. 4b above. The gate of the row select NMOS gating transistor 225 of each multiple photosensor pixel image sensor on each row of the array 410 is connected to the row select control signal 500a, . . . , 500n generated by the row control circuit 420. The source of each row select NMOS gating transistor 225 of each multiple photosensor pixel image sensor on each column of the array 410 is connected to a column sample and hold circuit 525a, . . . , 525n.

The gate of the NMOS reset transistor 230 of each multiple photosensor pixel image sensor 415 on each row of the array 410 is connected to the row reset signal 505a, . . . , 505n generated by the row control circuit 420 for selectively resetting the combined photosensing and charge storage device 200. The gate of each NMOS transfer gate 240 of each multiple photosensor pixel image sensor 415 on each row of the array 410 is connected to the first row transfer gate signal 510a, . . . , 510n generated by the row control circuit 420 for transferring the photoelectrons from the second green photodiode 210 to the combined photosensing and charge storage device 200. The gate of the NMOS transfer gate 235 and the gate of the NMOS third transfer gate 245 are connected to the second row transfer gate signal 515a, . . . , 515n generated by the row control circuit 420 for transferring the photoelectrons from the first green photodiode 205 to the combined photosensing and charge storage device 200 and simultaneously transferring the photoelectrons of the blue photodiode 215 to the second green photodiode 210. It should be noted that the second row transfer gate signal 515a, . . . , 515n may in fact be two separate signals: the first being the second row transfer signal for activating the first transfer gate 235 and the second a second level transfer signal for activating the second level transfer gate 245. The combination is shown for simplicity of operation but in more complex structures of the multiple photosensor pixel image sensor having separate transfer signals and binning transfer signals may be necessary.

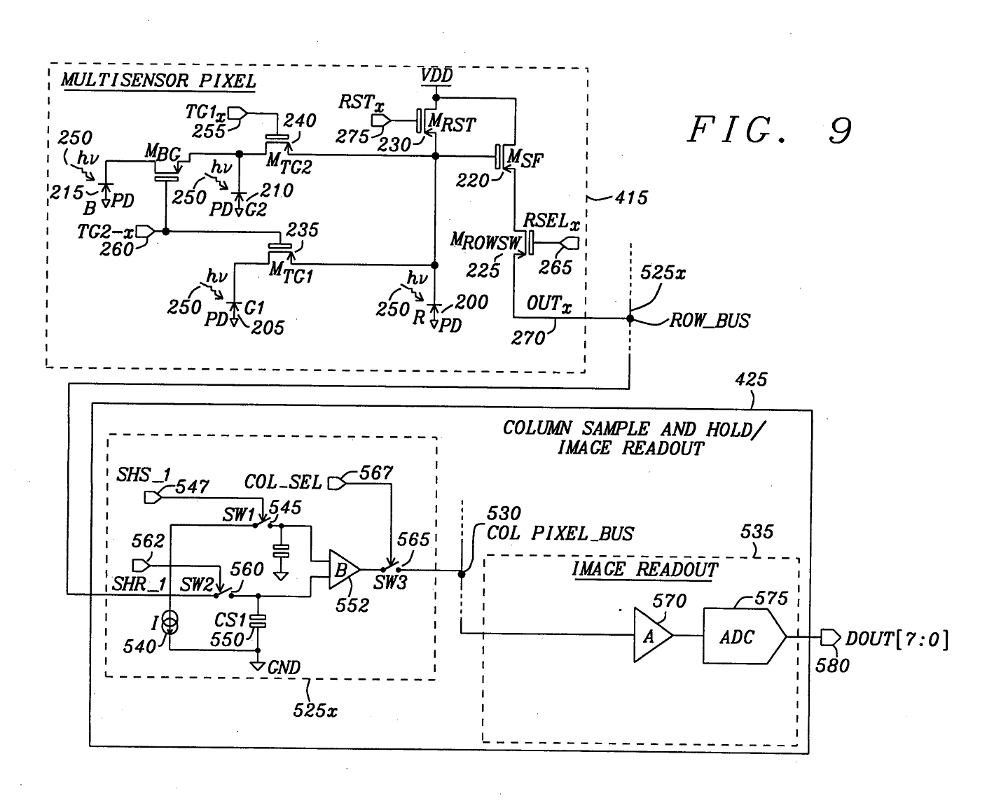

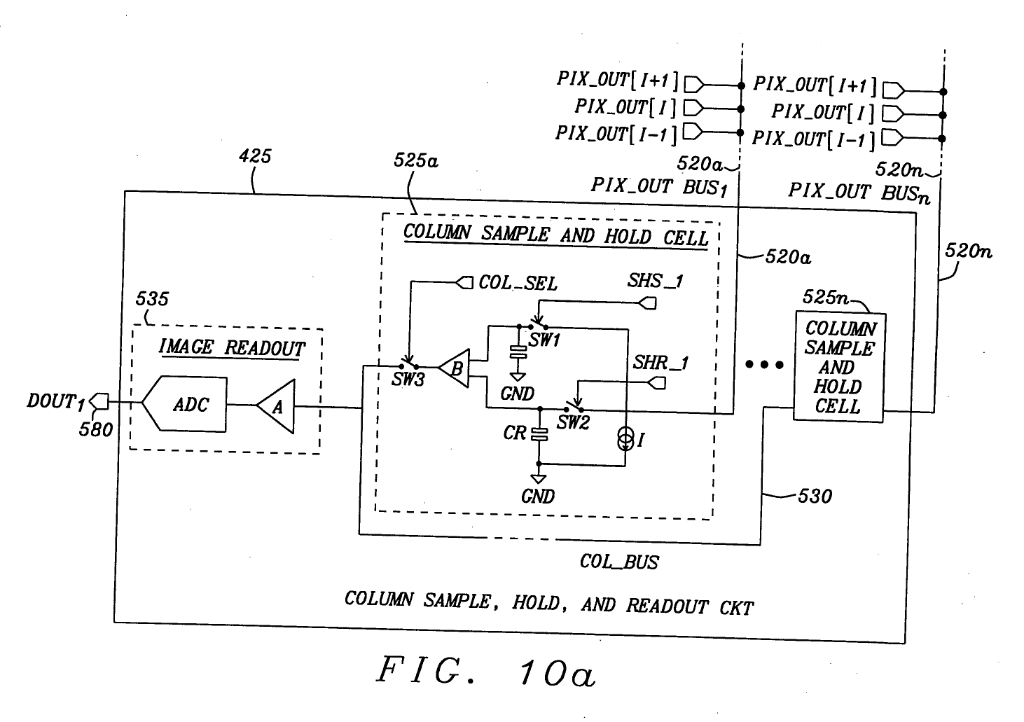

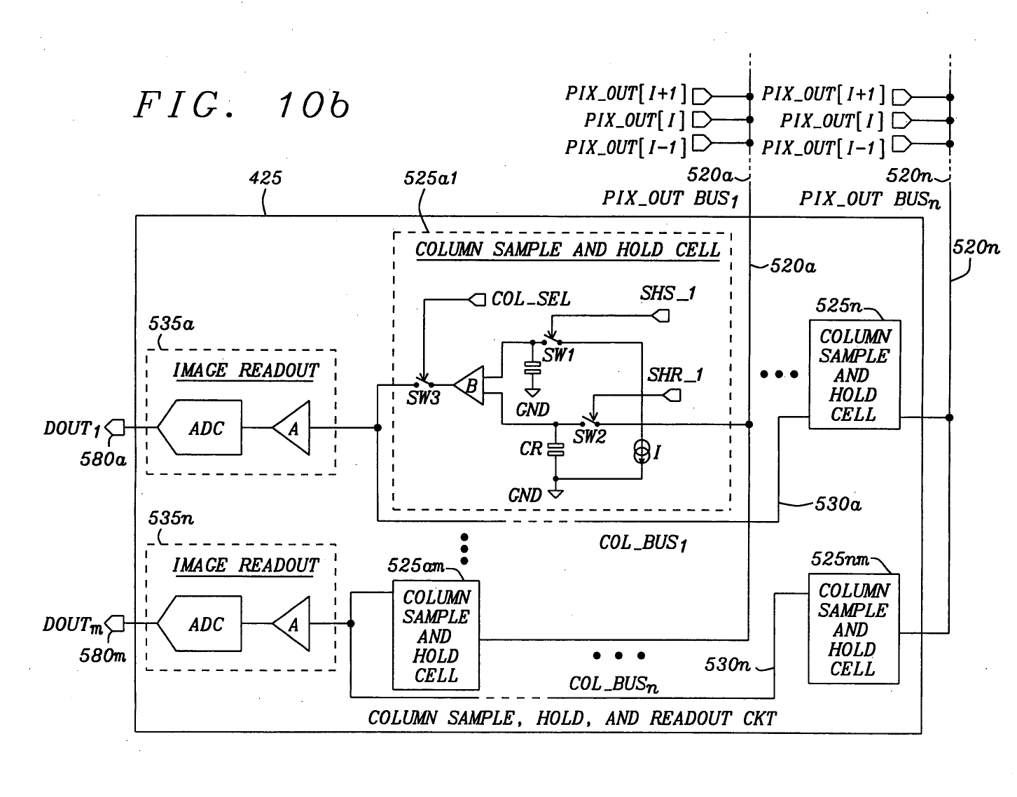

The structure of a single multiple photosensor pixel image sensor on a selected row of the array 410 showing the column readout of the selected pixel 415 is shown in FIG. 9. The red photodiode 200 functions as a combined photosensing and charge storage device in that it senses the red differentiated color components of light 250 impinging upon the photodiodes of the pixel image sensor. After the integration and sensing of the red differentiated color components of light 250, the red photodiode 200 is used as the charge storage node for the remaining photosensors 205, 210, and 215 of the pixel image sensor. The first green photodiode 205 is connected through the NMOS transfer gate 235 to the red photodiode 200 and the second green photodiode 210 is connected through the NMOS transfer gate 240 to the red photodiode 200. The blue photodiode 215 is connected through the NMOS third transfer gate 245 to the first green photodiode 210. The cathode of the red photodiode 200 acts as the photoelectron storage node for the pixel image sensor and is connected to the gate of the source follower NMOS transistor 220. The drain of the source follower NMOS transistor 220 is connected to the power supply voltage source VDD and the source is connected to the drain of the row select NMOS gating transistor 225. The gate of the row select NMOS gating transistor 220 is connected to the row select signal 265 and the source is connected to the output terminal 270 for connection through the Row Bus 520x to the column sample and hold/image Readout circuit 425.

The row select signal 265 activates the row select NMOS gating transistor 225 to transfer the voltage at the source of the source follower NMOS transistor 220 to the readout circuitry attached to the row. The voltage at the source of the source follower NMOS transistor 220 is proportional to the number of photons 250 that impinge upon the photodiodes of the pixel image sensor.

The first level transfer gate signal TG1-3 257 is connected to the gate of the NMOS transfer gate 240 and the second level transfer gate signal TG2-1 260 is connected to the gate of the NMOS transfer gate 235 and the gate of the third transfer gate 245. The first level transfer gate signal TG1-3 257 and the second level transfer gate signal TG2-1 260 provide the control signals for the activation of the NMOS transfer gates 235, 240, and 245 for the transfer of the photoelectrons collected in the conversion of the photons to the red photodiode 200.

The source of the NMOS reset transistor 230 is connected to the cathode of the red photodiode 200 and the sources of the NMOS transfer gates 235 and 240. The drain of the NMOS reset transistor 230 is connected to the power supply voltage source VDD and its gate is connected to the reset signal 275. The pixel image sensor is initiated and each of the photodiodes 200, 205, 210, and 215 are reset by setting the reset signal 275 to turn on the NMOS reset transistor 230. The transfer gate signals 255 and 260 are set to activate the NMOS transfer gates 235, 240, and 245. Each of the photodiodes 200, 205, 210, and 215 are then reset.

The NMOS transfer gates 235, 240, and 245 and the NMOS reset transistor 230 are deactivated and the photodiodes 200, 205, 210, and 215 are exposed to the photons of the light 250. The photons are converted within the photodiodes 200, 205, 210, and 215 to generate the photoelectrons.

The column sample and hold circuit 525x combines the column pixel row operation (pixel reset, row select) and the column operation (the photo generation, photo sensing). The Sample and Hold Sense signal SHS_1 547 and the Sample and Hold Reset signal SHR_1 262 are activated and deactivated by the column sample and hold/Image Readout circuit 425 to respectively activate the switches SW1 545 and SW2 560 to capture the pixel output electrical signal OUTx 270 from the Row Bus 520x. The pixel output electrical signal OUTx 270 being indicative of the level of the intensity of the light energy 250 present on each of the photosensors 200, 205, 210, and 215 of the multiple photosensor pixel image sensor 415 and the voltage level when the combined photosensing and charge storage device 200. This combination causes the output voltage of the differential buffer amplifier 552 to be equal to the differential voltage of pixel reset level and photo conversion electrical signal level, i.e., Vout=Vrst−Vsig. During the pixel readout, switch SW3 565 controlled by column select signal COL_SEL 567 transfers the differential voltage through the column bus COL_BUS 530 to the video amplifier 570 that applies a gain factor and offset correction factor to the output signal. The output of video amplifier 570 is the analog output that is digitized by an analog-to-digital converter 575. The output of the analog-to-digital converter 575 is the digital data word 580 that is transferred to the image processor 430 of FIG. 5.

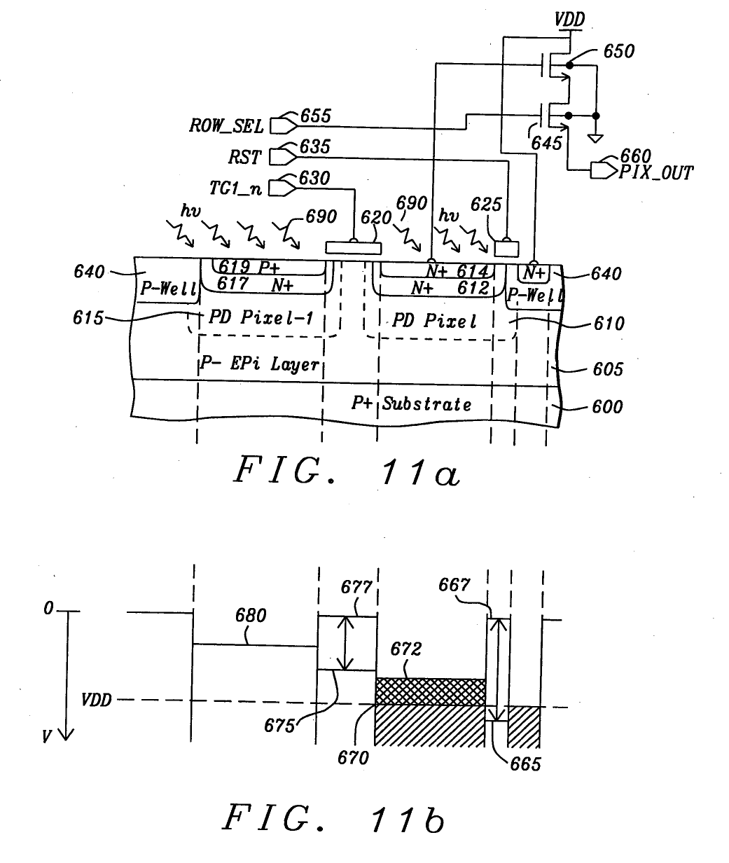

Referring to FIG. 10a, the structure of the column sample, hold, and readout circuit 425 is shown where each Row Bus 520a, . . . , 520n of each column of the array 410 of multiple photosensor pixel image sensors 415 is connected to a column sample and hold circuit 525a, . . . , 525n. The column sample and hold circuits 525a, . . . , 525n are connected through the column bus 530 to the Image Readout circuit 535 for amplification and conversion to the digital data word 580. FIG. 10b illustrates the structure of the column sample, hold, and readout circuit 425 where each Row Bus 520a, . . . , 520n of each column of the array 410 of multiple photosensor pixel image sensors 415 is connected to multiple column sample and hold circuits 525a1, . . . , 525an, . . . , 525am, . . . , 525nm. Each of the multiple column sample and hold circuits 525a1, . . . , 525an, . . . , 525am, . . . , 525nm is associated with an individual photosensor sensor of the multiple photosensor pixel image sensors 415 and is connected to one of the Image Readout circuits 535a, . . . , 535m. The output of each of the Image Readout circuits 535a, . . . , 535m is a digital data word 580a, . . . , 580m. Each digital data word 580a, . . . , 580m is transferred to the image processor 430 of FIG. 7.

As shown above, Dosluoglu—436 has two device configurations. The first device configuration is a pinned photodiode such as the first and second green and the blue photodiodes 205, 210 and 215 of FIGS. 4f-4g and photodiodes P1 of FIGS. 5a-5b and FIGS. 6a-6b are connected to the red combined photosensing and charge storage device 200 of FIGS. 4f-4g and the photodiodes P0 of FIGS. 5a-5b and FIGS. 6a-6b. The photoelectron transfer of the first configuration is a single level of transfer from the multiple photosensors 205, 210 and 215 of FIGS. 4f-4g and photodiodes P1 of FIGS. 5a and 6a to the combined photosensing and charge storage device 200 of FIGS. 4b-4d and P0 of FIGS. 5a and 6a. The transfer is controlled by a first level transfer gate signal TG1-1 255 and TG1-3 257 of FIGS. 4f-4g and TG1_{—}n of FIGS. 5b and 6b.

The second configuration is a for a multiple photosensor pixel image sensor where the pinned photodiode such as the first and second green photosensors 205 and 210 of FIGS. 4b-4d and the photodiodes P1 of FIGS. 5a-5b and FIGS. 6a-6b are connected directly to the red combined photosensing and charge storage device 200 of FIGS. 4b-4d and the photodiodes P0 of FIGS. 5a-5b and FIGS. 6a-6b. The second configuration further has a second level of pinned photodiodes such as the blue photosensors 215 of FIGS. 4b-4d and the photodiodes P2 of FIGS. 5a-5b and FIGS. 6a-6b connected through the first or second green photosensors 205 or 210 of FIGS. 4b-4d and the photodiodes P1 of FIGS. 5a-5b and FIGS. 6a-6b to the red combined photosensing and charge storage device 200 of FIGS. 4b-4d and the photodiodes P0 of FIGS. 5a-5b and FIGS. 6a-6b. The photoelectron transfer of the second configuration is a combination of a single level of transfer and a two level transfer. The single level of transfer is from the multiple photosensors 205, 210 and 215 of FIGS. 4f-4g and photodiodes P1 of FIGS. 5a and 6a to the combined photosensing and charge storage device 200 of FIGS. 4b-4d and P0 of FIGS. 5a and 6a. The transfer is controlled by a first level transfer gate signal TG1-1 255 and TG1-3 257 of FIGS. 4f-4g and TG1_{—}n of FIGS. 5b and 6b. The two level of transfer is from a second level photosensor such as the blue photodiode 215 of FIGS. 4b-4d and photodiodes P2 of FIGS. 5a and 6a to one of the first level photodiodes 210 of FIGS. 4b-4d and photodiodes P1 of FIGS. 5a and 6a. The control signal for controlling the transfer of the photoelectrons from the second level photosensors to the first level photosensors is the second level transfer gate control signals TG2-1 of FIGS. 4b-4d and TG2_{—}n of FIGS. 5b and 6b.

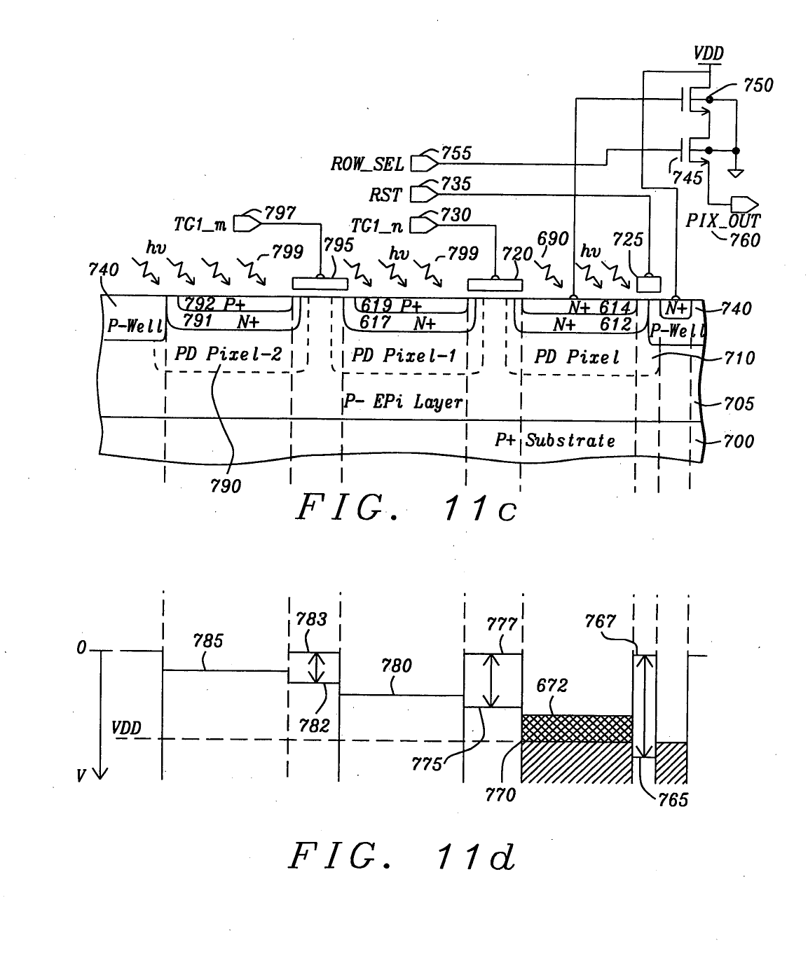

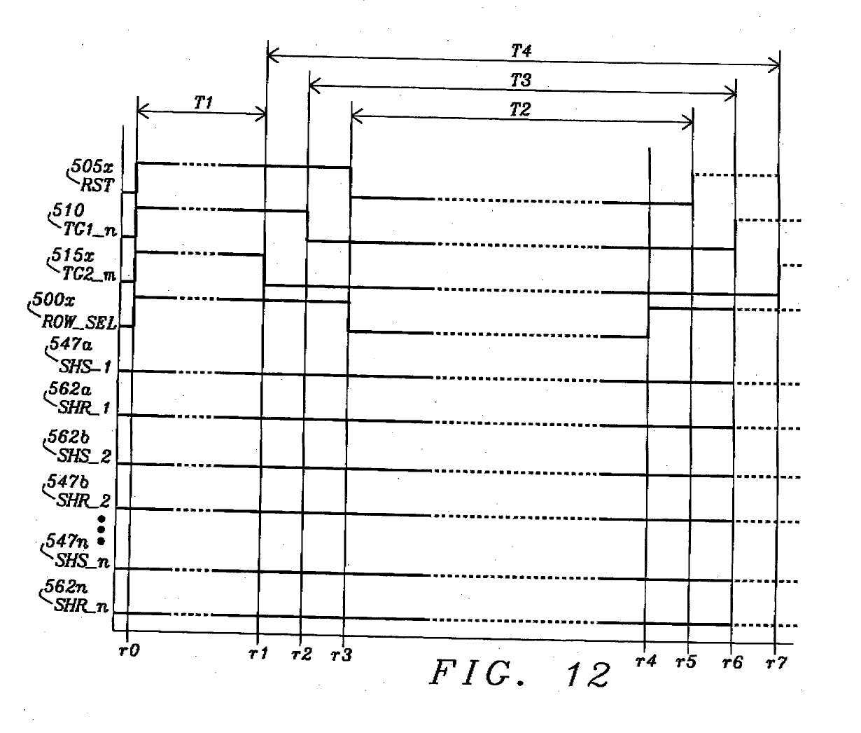

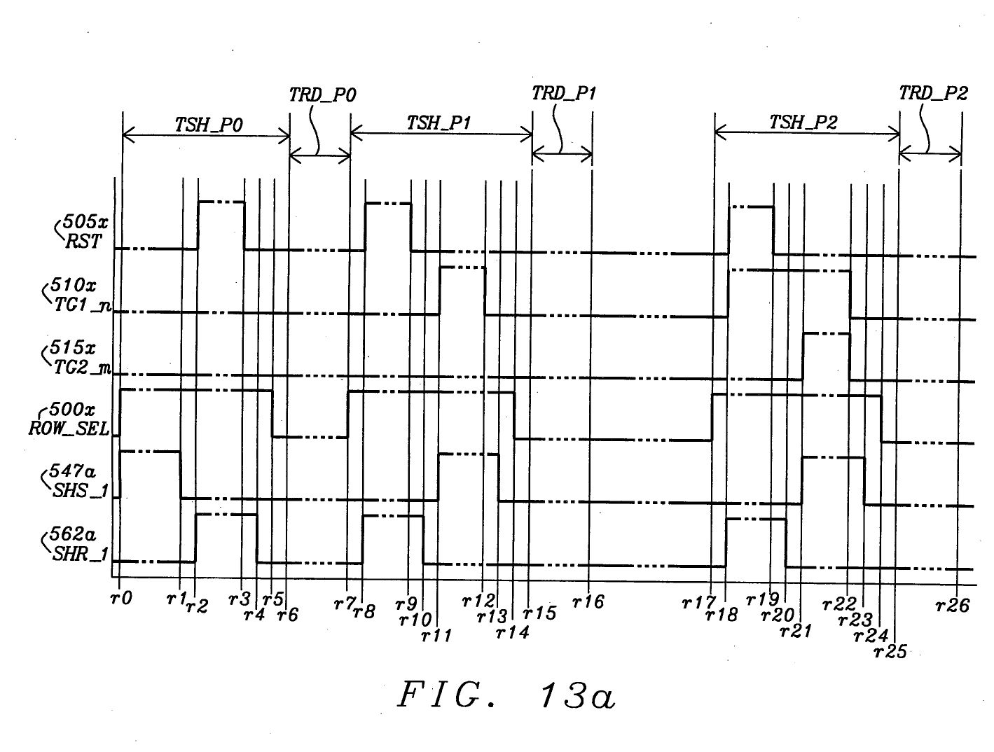

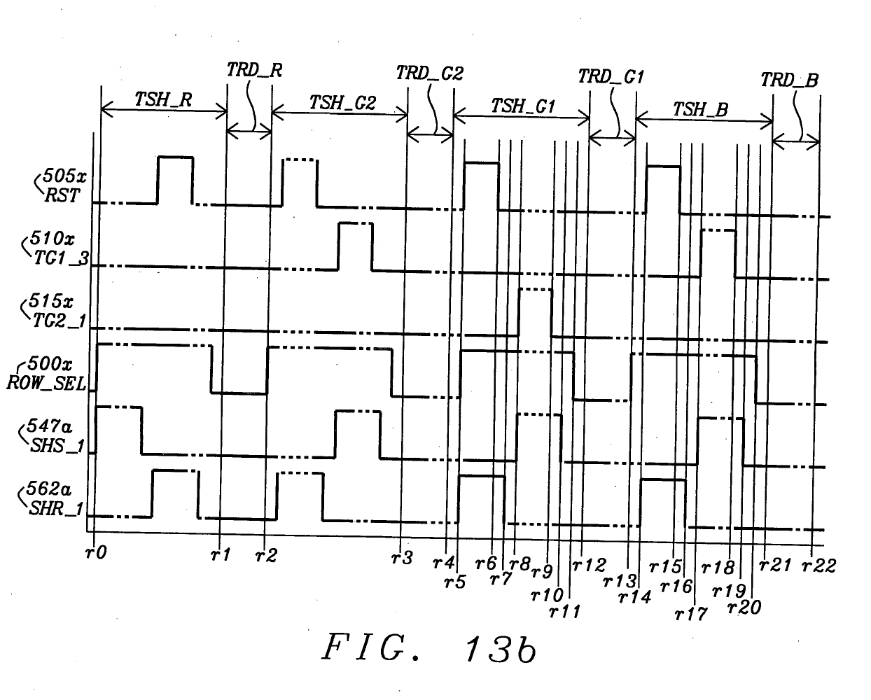

The first configuration and the second configuration above have different requirements for the fabrication process. FIGS. 11a and 11b illustrate the cross sectional structure of the configuration and the biasing voltage that is required to be developed by the row control circuit 420 of FIG. 7 for the first configuration.

A substrate 600 is heavily doped with a P-type impurity has its surface further doped with a complementary impurity to create a lightly doped P-type epitaxial layer 605. A P-type material is diffused into the surface of the substrate 600 to form the contact diffusions not shown for the P-type epitaxial layer 605.

The P-type impurity is diffused into the surface of the substrate 600 to form the P-type wells 640 that define the boundaries for the combined photosensing and charge storage device 610 and the first level photosensing devices 615. The N-type impurity is diffused into the surface of the substrate in the area between the P-type wells 640 to form the N-implant 612 that is the junction of the combined photosensing and charge storage device 610. This diffusion must be sufficiently deep to insure the conversion of the red photons to photoelectrons and the collection of these photoelectrons. The N-type impurity is also diffused into the surface of the substrate in the area between the P-type wells 640 to form the N-implant 617 that is the cathode of the pinned first level photosensing device 615.

The N-type impurity is then diffused into the N-implant 612 of the combined photosensing and charge storage device 610 to form the N+ shallow diffusion 614 that acts as the contact diffusion for the pixel image sensor. The P-type impurity is then diffused into the N-implant 617 to form the pinning diffusion 619 for the pinned first level photosensing device 615.

A thin oxide is formed on the epitaxial layer 605 in the areas of the NMOS transfer gates between the combined photosensing and charge storage device 610 and the first level photosensing device 615. The gate 620 of the NMOS transfer gate between the combined photosensing and charge storage device 610 and the first level photosensing device 615 is formed on the surface of the thin oxide. The gate 620 of NMOS transfer gate is connected to the first level transfer gate signal TG1_{—}n 630. Similarly, the gate 625 of the reset NMOS transistor is formed between the combined photosensing and charge storage device 610 and the P-type well 640. The gate 625 is connected to the reset signal terminal 635, which when activated provides the reset voltage level for the combined photosensing and charge storage device 610 and the first level photosensing device 615. The P-type wells 640 are connected to the power supply voltage source VDD for biasing the P-type wells 640, the P-type epitaxial layer 605 and the P-type substrate.

The shallow N+ implant 614 of the combined photosensing and charge storage device 610 acts as the photoelectron storage node for the pixel image sensor and is connected to the gate of the source follower NMOS transistor 650. The drain of the source follower NMOS transistor 650 is connected to the power supply voltage source VDD and the source is connected to the drain of the row select NMOS gating transistor 645. The gate of the row select NMOS gating transistor 645 is connected to the row select signal 655 and the source is connected to the output terminal 660 for connection to the readout circuit of a row of an array of the pixel image sensors. The row select signal 655 activates the row select NMOS gating transistor 645 to transfer the voltage at the source of the source follower NMOS transistor 650 to the readout circuitry attached to the row.

FIG. 11b shows a graph of the voltage levels present within the combined photosensing and charge storage device 610 and the first level photosensing device 615 and the required voltage levels necessary to activate and deactivate the NMOS transfer gate and the NMOS reset gate. When deactivated the NMOS transfer gate 620 and the NMOS reset gate 625 are set respectively to the ground reference voltage level 667 and 677. In order to provide a hard reset voltage level 670 that is the power supply voltage source VDD for the combined photosensing and charge storage device 610, the high biasing voltage at the reset signal 635 must be about 1.0V higher than the power supply voltage source VDD. The hard reset voltage level 670 will provide better image performance for the combined photosensing and charge storage device 610. Likewise, the first level photosensing device 615 must be reset to a voltage level that will totally deplete the N-implant 617.

The reset signal 635 and the first level transfer gate signal 630 are set to deactivate the gates of the NMOS transfer gate 620 and the NMOS reset gate 625 are set respectively to the ground reference voltage level 667 and 677. The photons 690 impinge upon the combined photosensing and charge storage device 610 and the first level photosensing device 615 and cause the voltage levels of within the N-implant 612 to reach the voltage level 672 and the N-implant 617 to the voltage level 680. The voltage level 672 is buffered by the source follower NMOS transistor 650 for transfer to the pixel output 660. After the combined photosensing and charge storage device 610 is reset, the transfer gate signal TG1_{—}n 630 is set to turn on the transfer gate to transfer the charge from the first level photosensing device 615 to the combined photosensing and charge storage device 610. The N-implant of the pinned second level photosensing device 615 is adjusted to make the channel potential 680 of first level photosensing device 615 lower than VDD. The bias voltage of the transfer gate signal TG1_{—}n 630 is controlled to make channel potential 675 of first level transfer gate lower than the voltage level of the power supply voltage source VDD and higher than the voltage level 680 of the first level photosensing device 615. The proper potential 675 adjustment gives the condition of the potential 680 of the first level photosensing device 615 is less than the voltage level of the first level transfer gate signal 630, which is less that the voltage level of the power supply voltage source VDD. This condition ensures the fully charge transfer from the first level photosensing device 615 to the combined photosensing and charge storage device 610 without the image lag.

Refer now to FIGS. 11c and 11d for a discussion of the cross sectional structure of the configuration and the biasing voltage that is required to be developed by the row control circuit 420 of FIG. 7 for the second configuration.

A substrate 700 is heavily doped with a P-type impurity has its surface further doped with a complementary impurity to create a lightly doped P-type epitaxial layer 705. A P-type material is diffused into the surface of the substrate 700 to form the contact diffusions not shown for the P-type epitaxial layer 705.

The P-type impurity is diffused into the surface of the substrate 700 to form the P-type wells 740 that define the boundaries for the combined photosensing and charge storage device 710, the first level photosensing devices 715, and the second level photosensing devices 790. The N-type impurity is diffused into the surface of the substrate in the area between the P-type wells 740 to form the N-implant 712 that is the junction of the combined photosensing and charge storage device 710. This diffusion must be sufficiently deep to insure the conversion of the red photons to photoelectrons and the collection of these photoelectrons. The N-type impurity is also diffused into the surface of the substrate in the area between the P-type wells 740 to form the N-implant 717 that is the cathode of the pinned first level photosensing device 715 and to form the N-implant 791 that is the cathode of the pinned second level photosensing device 790.

The N-type impurity is then diffused into the N-implant 712 of the combined photosensing and charge storage device 710 to form the N+ shallow diffusion 714 that acts as the contact diffusion for the pixel image sensor. The P-type impurity is then diffused into the N-implant 717 to form the pinning diffusion 719 for the pinned first level photosensing device 715. The P-type impurity is further diffused into the N-implant 791 to form the pinning diffusion 792 for the pinned second level photosensing device 790.

A thin oxide is formed on the epitaxial layer 705 in the areas of the NMOS transfer gates between the combined photosensing and charge storage device 710, the first level photosensing device 715 and the second level photosensing devices 790. The gate 720 of the NMOS transfer gate between the combined photosensing and charge storage device 710 and the first level photosensing device 715 is formed on the surface of the thin oxide. The gate 795 of the NMOS transfer gate between and the first level photosensing device 715 and the second level photosensing devices 790 is formed on the surface of the thin oxide. The gate 720 of NMOS transfer gate is connected to the first level transfer gate signal TG1_{—}n 730 and the gate 795 of NMOS transfer gate is connected to the second level transfer gate signal TG2_{—}m 797. Similarly, the gate 725 of the reset NMOS transistor is formed between the combined photosensing and charge storage device 710 and the P-type well 740. The gate 725 is connected to the reset signal terminal 735, which when activated provides the reset voltage level for the combined photosensing and charge storage device 710 and the first level photosensing device 715. The P-type wells 740 are connected to the power supply voltage source VDD for biasing the P-type wells 740, the P-type epitaxial layer 705 and the P-type substrate.

The shallow N+ implant 714 of the combined photosensing and charge storage device 710 acts as the photoelectron storage node for the pixel image sensor and is connected to the gate of the source follower NMOS transistor 750. The drain of the source follower NMOS transistor 750 is connected to the power supply voltage source VDD and the source is connected to the drain of the row select NMOS gating transistor 745. The gate of the row select NMOS gating transistor 745 is connected to the row select signal 755 and the source is connected to the output terminal 760 for connection to the readout circuit of a row of an array of the pixel image sensors. The row select signal 755 activates the row select NMOS gating transistor 745 to transfer the voltage at the source of the source follower NMOS transistor 750 to the readout circuitry attached to the row.

FIG. 11d shows a graph of the voltage levels present within the combined photosensing and charge storage device 710, the first level photosensing devices 715, and the second level photosensing devices 790 and the required voltage levels necessary to activate and deactivate the NMOS transfer gates and the NMOS reset gate. When deactivated the NMOS transfer gates 720 and 795 and the NMOS reset gate 725 are set respectively to the ground reference voltage level 767, 783, and 777. In order to provide a hard reset voltage level 770 that is the power supply voltage source VDD for the combined photosensing and charge storage device 710, the high biasing voltage at the reset signal 735 must be about 1.0V higher than the power supply voltage source VDD. The hard reset voltage level 770 will provide better image performance for the combined photosensing and charge storage device 710. Likewise, the first level photosensing device 715 and the second level photosensing devices 790 must be reset to a voltage level that will totally deplete the N-implants 717 and 791.

The reset signal 735, the first level transfer gate signal 730 and second level transfer gate signal 797 are set to deactivate the gates of the NMOS transfer gates 720 and 795 and the NMOS reset gate 725 are set respectively to the ground reference voltage level 777, 795, and 767. The photons 799 impinge upon the combined photosensing and charge storage device 710, the first level photosensing devices 715, and the second level photosensing devices 790 and cause the voltage levels of within the N-implant 712 to reach the voltage level 772, the N-implant 717 to the voltage level 780, and the N-implant 791 to the voltage level 785. The voltage level 772 is buffered by the source follower NMOS transistor 750 for transfer to the pixel output 760. After the combined photosensing and charge storage device 710 is reset, the transfer gate signal TG1_{—}n 730 is set to turn on the transfer gate to transfer the charge from the first level photosensing device 715 to the combined photosensing and charge storage device 710. The N-implant of the pinned second level photosensing device 715 is adjusted to make the channel potential 780 of first level photosensing device 715 lower than VDD. The N-implant 791 that is the cathode of the pinned second level photosensing device 790 is adjusted to make the channel potential of second level photosensing device 790 lower than the first level photosensing device 715. The bias voltage of the transfer gate signal TG1_{—}n 730 is controlled to make channel potential 775 of first level transfer gate lower than the voltage level of the power supply voltage source VDD and higher than the voltage level 780 of the first level photosensing device 715. The proper potential 775 adjustment gives the condition of the potential 780 of the first level photosensing device 715 is less than the voltage level of the first level transfer gate signal 730, which is less that the voltage level of the power supply voltage source VDD. The HIGH bias of the second level transfer gate signal TG2_{—}m 797 is controlled to make channel potential 782 of second level transfer gating signal TG2_{—}m 797 lower than the potential 780 of the first level photosensing device 715, but higher than the potential 785 of the second level photosensing device 790. The proper potential adjustment of the voltage levels of the first and second transfer gate signals 730 and 797 will be set such that the first and second transfer gate signals 730 and 797 must have level that comply with the function:

VPPD2 (785)<VTG2_{—}H (782)<VPPD1 (775)<VTG1_{—}H (772)<VDD.

### This condition ensures the fully charge transfer from the second level photosensing devices 790 to the first level transfer gate signal 730 to the combined photosensing and charge storage device 710 without the image lag.

Referring to FIGS. 7, 8, 9, 10a, 10b, 12, and 13a for an explanation of the operation of the control circuitry of this invention that manipulates control signals for controlling functioning of the array of multiple photosensor pixel image sensors. The multiple photosensor pixel image sensor has, as described above, three types of photosensors: the combined photosensing and charge storage devices (designated P0 for this discussion), the first level photosensing devices (designated P1 for this discussion), and the second level photosensing devices (designated P2 for this discussion). In FIG. 7, the red photosensing device 416 is the combined photosensing and charge storage device 710, the first and second green photosensing devices 417 and 418 are the first level photosensing devices P1, and the blue photosensing device 419 is the second level photosensing device P2.

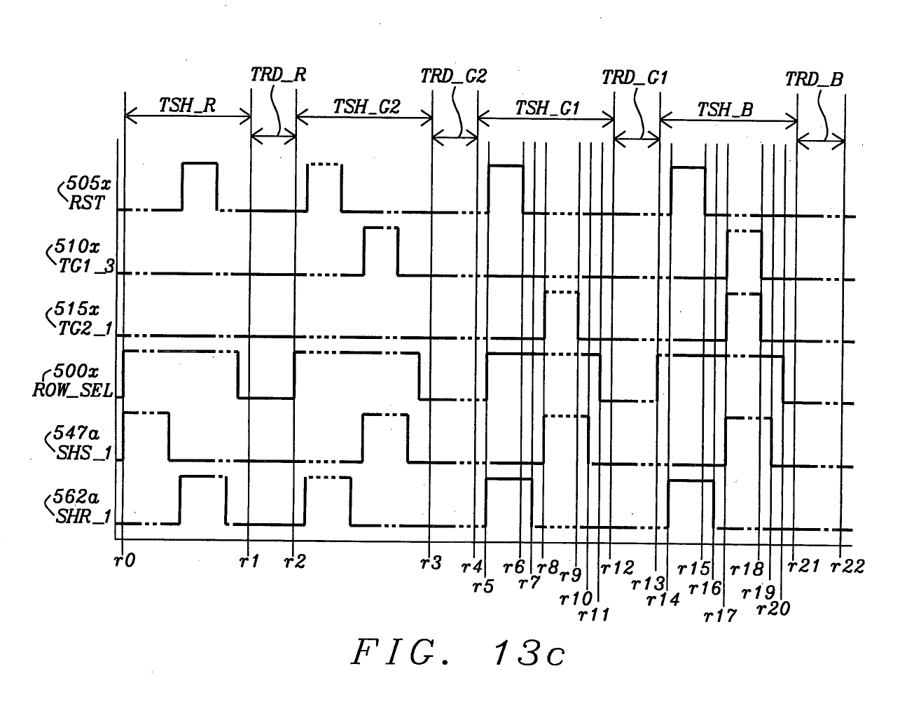

In the pixel integration timings as shown in FIG. 12, the row control circuit 420 activates the row reset signal 505x and the row select 500x for a selected row of the array 410 of multiple photosensor pixel image sensors 415 during the period T1 between time τ0 and time τ1 to place the combined photosensing and charge storage device P0 and the first level photosensing devices P1, and the second level photosensing devices P2 at the reset voltage level for a row reset. At the time τ1, the second level transfer gate signal TG2_{—}m 515x is deactivated to start the integration of the photoelectrons of the second level photosensing device P2. It should be noted that in a structure as is shown FIG. 9 the second level transfer gate signal TG2_{—}m 515x is also disabled to begin integration of the photoelectrons of certain first level photosensing devices P1. At the time τ2, the first level transfer gate signal TG1_{—}n 510x is deactivated to start the integration photoelectrons of the first level photosensing device P1. At the time τ3, the Reset signal 505x is deactivated to start the integration of the photoelectrons of the combined photosensing and charge storage device P0. At the time τ3 the row select 500x is deactivated during the integration periods T2, T3, and T4.

At the time τ4, the row select signal 500x is activated to begin the readout process for the combined photosensing and charge storage device P0. At the time τ5, the Reset signal 505x is activated to provide the reset reference level for the readout of the combined photosensing and charge storage device P0, which is explained more completely hereinafter. The times τ6, and τ7 represent the beginning of the readout process for the first level photosensing device P1 and the second level photosensing device P2 also described hereinafter.

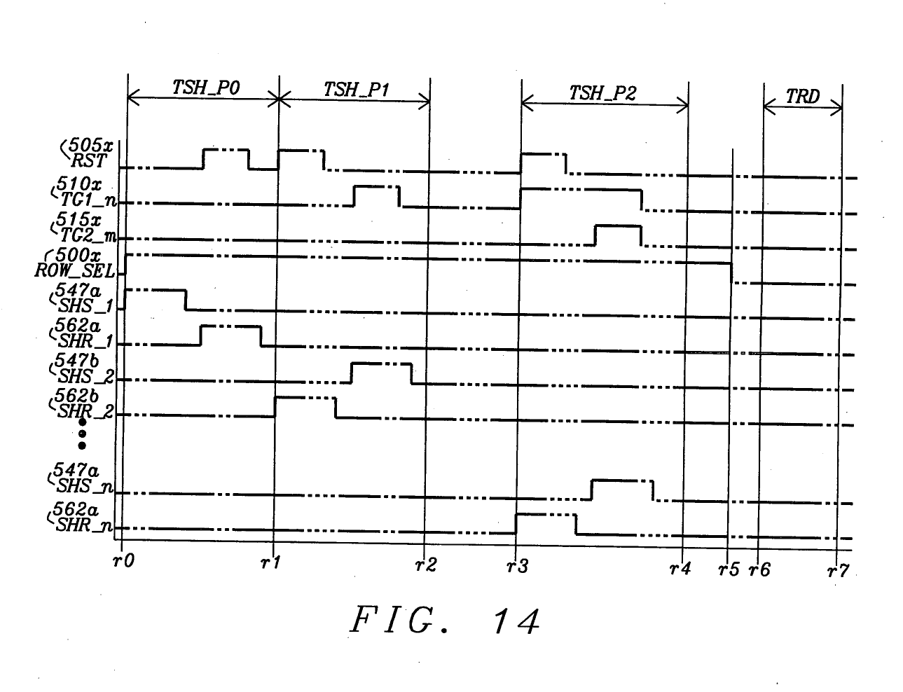

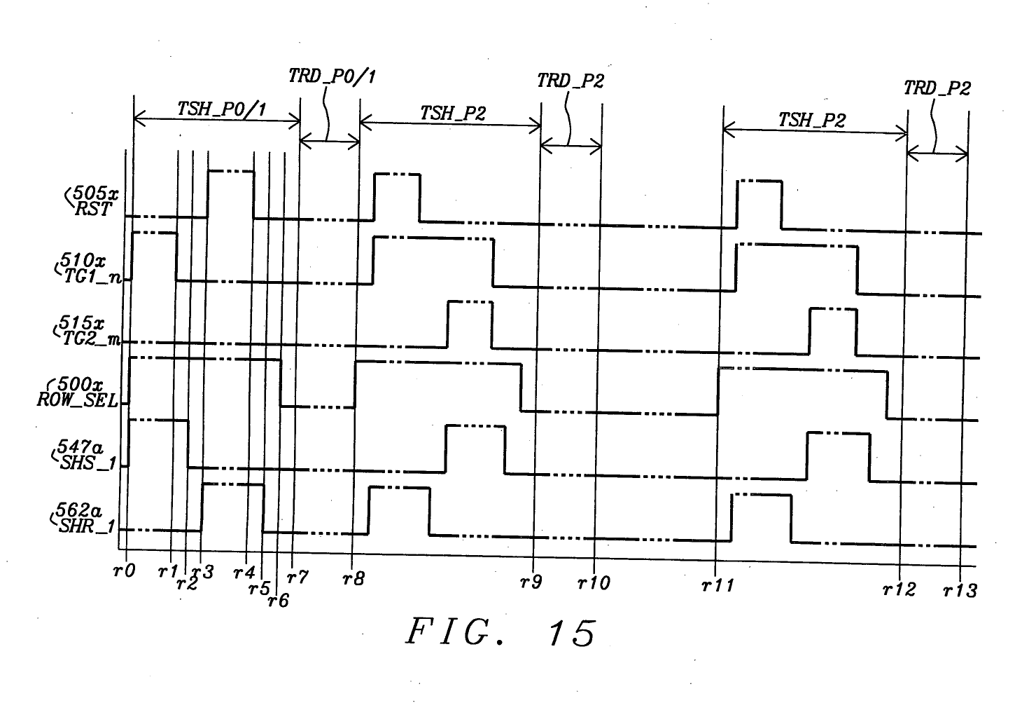

Referring now to FIG. 13a for an explanation of sample, hold and readout process employing the single column sample and hold circuit of FIG. 10a, where each column has a single sample and hold circuit 525a, . . . , 525n. At the time τ0, (equivalent to the time τ5 of FIG. 12), the Row Select signal 500x is activated to place the output voltage of the source follower of each of the combined photosensing and charge storage device P0 at the Row Bus 520a, . . . , 520n of FIG. 10a of each row. The Sample and Hold Sense signal 547a is also activated at the time τ0 to capture the voltage level of the output of the source follower of the combined photosensing and charge storage device P0 representing the number of photoelectrons integrated as described in FIG. 12. At the time τ1, the Sample and Hold Sense signal SHS_1 547a is deactivated and at the time τ2 (equivalent to the time τ6 of FIG. 12) the Reset signal 505x is activated to reset the combined photosensing and charge storage device P0. The Sample and Hold Reset signal 562a is activated to capture the Reset voltage level at the output of the source follower of the combined photosensing and charge storage device P0. The Reset signal 505x is deactivated at the time τ3 and the Sample and Hold Reset signal 562a is deactivated at the time τ4. The Row Select signal 500x is deactivated at the time τ5. The time from the time τ0 to the time τ6 is considered the Sample and Hold period TSH_P0 for the combined photosensing and charge storage device P0. From the time τ6 to the time τ7 is the time period TRD_P0 that the voltage level of each pixel of each column of the array is read out through the Image Readout circuit 535 of FIG. 10a to the data output 580 of FIG. 10a.

At the time τ7, the Row Select signal 500x is activated to start the Sampling and Holding period TSH_P1 for the first level photosensing device P1. At the time τ8, the Reset signal 505x is activated and the Sample and Hold Reset signal SHR_1562a is activated to capture the Reset voltage level at the output of the source follower of the combined photosensing and charge storage device P0. At the time τ9, the Reset signal 505x is deactivated and at the time τ10, the Sample and Hold Reset signal SHR_1 562a is deactivated. At the time τ11 (equivalent to the time τ7 of FIG. 12), the first level transfer gating signal TG1_{—}n 510x is activated to transfer the charge from the first level photosensing device P1 to the combined photosensing and charge storage device P0. The Sample and Hold Sense signal SHS_1 547a is also activated at the time τ11 to capture the voltage level of the output of the source follower of the combined photosensing and charge storage device P0 representing the number of photoelectrons integrated during the period T3 as described in FIG. 12. At the time τ12, the first level transfer gating signal TG1_{—}n 510x is deactivated; at the time τ13, the Sample and Hold Sense signal SHS_1 547a is deactivated; and at the time τ14 the Row Select signal 500x is deactivated to complete the readout of the charge of the first level photosensing device P1 in the time period TSH_P1.

During the time period TRD_P1 between the time τ15 and time τ16, the voltage level of each first level photosensing device P1 of each column of the array is read out through the Image Readout circuit 535 of FIG. 10a to the data output 580 of FIG. 10a. If there are multiple first level photosensing devices P1, the signal levels as shown for the time period TSH_P1 and the time period TRD_P1 for each of these devices are repeated to complete the readout of each of the first level photosensing device P1. The repetition occurs from the time τ16 to the time τ17.

At the time τ17, the Row Select signal 500x is activated to start the Sampling and Holding period TSH_P2 for the second level photosensing device P2. At the time τ18, the Reset signal 505x is activated, the first level transfer gating signal TG1_{—}n 510x is activated, and the Sample and Hold Reset signal SHR_1562a is activated to capture the Reset voltage level at the output of the source follower of the combined photosensing and charge storage device P0. At the time τ19, the Reset signal 505x is deactivated and at the time τ20, the Sample and Hold Reset signal SHR_1 562a is deactivated. At the time τ21 (equivalent to the time τ8 of FIG. 12), the second level transfer gating signal TG2_{—}m 515x is activated to transfer the charge from second level photosensing device P2, through the first level photosensing device P1 to the combined photosensing and charge storage device P0. The Sample and Hold Sense signal SHS_1 547a is also activated at the time τ21 to capture the voltage level of the output of the source follower of the combined photosensing and charge storage device P0 representing the number of photoelectrons integrated during the period T4 as described in FIG. 12. At the time τ22, the first level transfer gating signal TG1_{—}n 510x and the second level transfer gating signal TG2_{—}m 515x are deactivated. At the time τ23, the Sample and Hold Sense signal SHS_1 547a is deactivated. At the time τ24 the Row Select signal 500x is deactivated to complete the readout of the charge of the second level photosensing device P2 in the time period TSH_P2.

During the time period TRD_P2 between the time τ25 and time τ26, the voltage level of each second level photosensing device P2 of each column of the array is read out through the Image Readout circuit 535 of FIG. 10a to the data output 580 of FIG. 10a. If there are multiple second level photosensing devices P2, the signal levels as shown for the time period TSH_P2 and the time period TRD_P2 for each of these devices are repeated to complete the readout of each of the second level photosensing device P2. The repetition occurs after the time τ26.

It should be noted that the first level transfer gating signal TG1_{—}n 510x and/or the second level transfer gating signal TG2_{—}m 515x maybe connected to multiple first level photosensing devices P1 and second level photosensing devices P2 to provide binning of the charges from multiple photosensors. The first level transfer gating signal TG1_{—}n 510x and/or the second level transfer gating signal TG2_{—}m 515x are activated appropriately to transfer the charge from the multiple first level photosensing devices P1 and second level photosensing devices P2 to the combined photosensing and charge storage device P0 for the read out.

In FIG. 13a, the transfer from a second level photosensing device P2 to the combined photosensing and charge storage device P0 occurs through a first level photosensing devices P1. It is in keeping with the intent of this invention that the first level transfer gating signal TG1_{—}n 510x and/or the second level transfer gating signal TG2_{—}m 515x may be connected to other levels of the photosensors to activate transfer of charge from a second level photosensing device P2 to a first level photosensing devices P1 where it is held while the charge of another of the first level photosensing devices P1 are being sampled and held. The charge from the second level photosensing device P2 is then subsequently transferred from the first level photosensing devices P1 to the combined photosensing and charge storage device P0. An example of this is shown in the multiple photosensor pixel image sensor 415 of FIG. 9 and is exemplary of a structure suitable for a Bayer Pattern sensor. Refer now to FIGS. 7, 8, 9 and 13b, for an explanation of the operation of the control circuitry of this invention that manipulates control signals for controlling functioning of the array of Bayer Pattern multiple photosensor pixel image sensors. In FIG. 13b, the Sampling and Holding period TSH_R between the time τ0 and the time τ1 is the time for the capturing the voltage level representing the number of photoelectrons integrated at the Red combined photosensing and charge storage device P0 200. This timing is identical to that described above for the Sampling and Holding period TSH_P0 FIG. 13a. The period of time from the time τ1 to the time τ2 is the Readout time TRD_R for the readout of each of the Red combined photosensing and charge storage devices P0 200 of the selected row. The Sampling and Holding period TSH_G2 between the time τ2 and the time τ3 is the time for the capturing the voltage level representing the number of photoelectrons integrated at the Green-2 photosensing device P1 210. This timing is identical to the Sampling and Holding period TSH_P1 that described above for FIG. 13a. The time τ3 and the time τ4 is the Readout time TRD_G2 for the readout of each of the Red combined photosensing and charge storage devices P0 200 containing the charge from the Green-2 photosensing device P1 210 of the selected row.

At the time τ5, the Row Select signal 500x is activated to start the Sampling and Holding period TSH_G1 for the Green-1 photosensing device P1 205. Also, at the time τ5, the Reset signal 505x and the Sample and Hold Reset signal SHR_1 562a are activated to capture the Reset voltage level at the output of the source follower of the combined photosensing and charge storage device P0. At the time τ6, the Reset signal 505x is deactivated and at the time τ7, the Sample and Hold Reset signal SHR_1 562a is deactivated. As shown in FIG. 9, the second level transfer gating signal TG2_1 260 (represented as 515x in FIG. 13c) is connected to the gates Green-1 first level transfer gate M_{TG1} 235 and the Blue second level transfer gate M_{TG2} 245. At the time τ8, the second level transfer gating signal TG2_1 515x is activated to transfer the charge from the Green-1 level photosensing device P1 205 to the combined photosensing and charge storage device P0 200. The Sample and Hold Sense signal SHS_1 547a is also activated at the time τ8 to capture the voltage level of the output of the source follower of the combined photosensing and charge storage device P0 representing the number of photoelectrons integrated during the period T3 by the Green-1 first level photosensing device P1 205 as described in FIG. 12. The Blue second level transfer gate M_{TG2} 245 is also activated to transfer the charge of the Blue second level photosensing device P2 215 to the Green-2 first level photosensing device P1 210. At the time τ9, the second level transfer gating signal TG2_1 515x is deactivated; at the time τ10, the Sample and Hold Sense signal SHS_1 547a is deactivated; and at the time τ11 the Row Select signal 500x is deactivated to complete the sampling and holding of the charge of the Green-1 first level photosensing device P1 205 in the time period TSH_G1.

During the time period TRD_G1 between the time τ12 and time τ13, the voltage level of each Green-1 first level photosensing devices P1 205 of each column of the array is read out through the Image Readout circuit 535 of FIG. 10a to the data output 580 of FIG. 10a.

At the time τ13, the Row Select signal 500x is activated to start the Sampling and Holding period TSH_B for the Blue photosensing device P2 215. Also, at the time τ14, the Reset signal 505x and the Sample and Hold Reset signal SHR_1 562a are activated to capture the Reset voltage level at the output of the source follower of the combined photosensing and charge storage device P0. At the time τ15, the Reset signal 505x is deactivated and at the time τ16, the Sample and Hold Reset signal SHR_1 562a is deactivated. At the time τ17, the first level transfer gating signal TG1_3 510x is activated to transfer the charge from the Green-2 level photosensing device P1 210 to the combined photosensing and charge storage device P0 200. The Sample and Hold Sense signal SHS_1 547a is also activated at the time τ17 to capture the voltage level of the output of the source follower of the combined photosensing and charge storage device P0 representing the number of photoelectrons integrated during the period T3 by the Blue second level photosensing device P2 215 as described in FIG. 12. At the time τ18, the first level transfer gating signal TG1_3 510x is deactivated; at the time τ19, the Sample and Hold Sense signal SHS_1 547a is deactivated; and at the time τ20 the Row Select signal 500x is deactivated to complete the sample and holding of the charge of the Blue second level photosensing device P2 215 in the time period TSH_B.

During the time period TRD_B between the time τ21 and time τ22, the voltage level of each Blue second level photosensing devices P2 215 of each column of the array is read out through the Image Readout circuit 535 of FIG. 10a to the data output 580 of FIG. 10a.

The potential difference between the GREEN-2 first level photosensing device P1 210 and the Blue photosensing device P2 215 may not be large enough to accommodate a complete transfer of charges from Blue photosensing device P2 215 to Green-2 first level photosensing device P1 210 during the Green-1 Sample and Hold Time TSH_G1. As shown in FIG. 10c, the first level transfer gating signal TG1_3 510x and the second level transfer gating signal TG2_1 515x are activated simultaneously for the period time from time τ17 time τ18 to the time τ18. The remainder of the timing for this implementation of the row control circuitry 420 is as described in FIG. 10b.

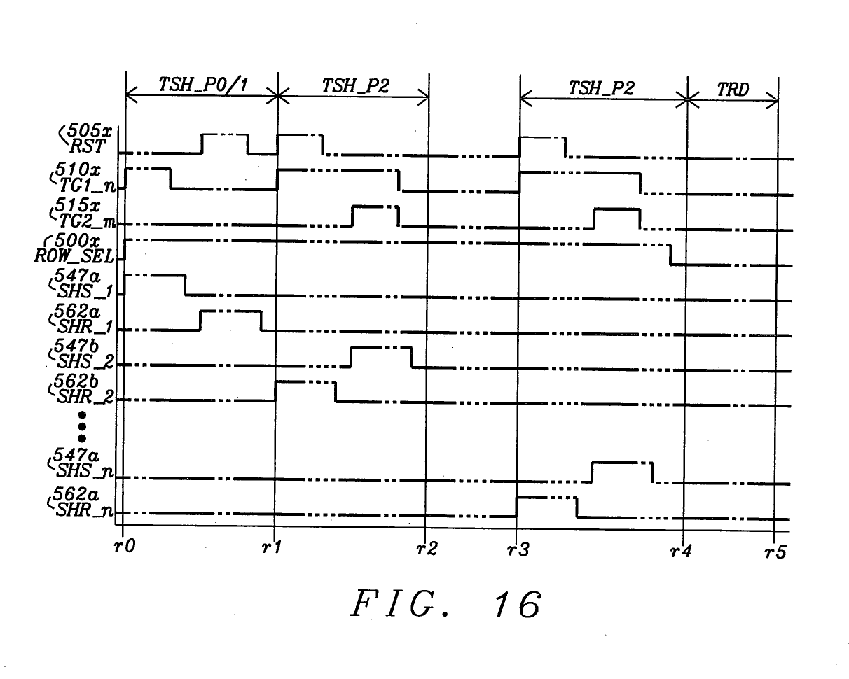

Referring now to FIG. 14 for an explanation of sample, hold and readout process employing the multiple column sample and hold circuit of FIG. 10b, where each column has multiple column sample and hold circuits 525a1, . . . , 525an, . . . , 525ma, . . . , 525nm. Each row of the multiple column sample and hold circuits 525a1, . . . , 525an, . . . , 525ma, . . . , 525nm are connected to one of the Image Readout circuits 535a, . . . , 535m. The Image Readout circuits 535a, . . . , 535m provide separate digital data word 580a, . . . , 580m.

The Sampling and Holding period TSH_P0 between the time τ0 and the time τ1 is the time for the capturing the voltage level representing the number of photoelectrons integrated at the combined photosensing and charge storage device P0. This timing is identical to that described above for FIG. 13a. The Sampling and Holding period TSH_P1 between the time τ1 and the time τ2 is the time for the capturing the voltage level representing the number of photoelectrons integrated at the first level photosensing device P1. This timing is identical to that described above for FIG. 13a with the exception that the Sample and Hold Sense signal SHS_1 547a and the Sample and Hold Reset signal SHSR_1 562a are now for a second row of multiple column sample and hold circuits 525a1, 525an, . . . , 525ma, 525nm of FIG. 10b (not shown) are controlled by the Sample and Hold Sense signal SHS_1 547b and the Sample and Hold Reset signal SHSR_1 562b. The Sample and Hold Sense signal SHS_1 547b and the Sample and Hold Reset signal SHSR_1 562b have the same timing as that shown in FIG. 13a for Sample and Hold Sense signal SHS_1 547a and the Sample and Hold Reset signal SHSR_1 562a for the Sampling and Holding period TSH_P1. The Sampling and Holding period TSH_P2 between the time τ3 and the time τ4 is the time for the capturing the voltage level representing the number of photoelectrons integrated at the combined photosensing and charge storage device P2. This timing is identical to that described above for FIG. 13a with the exception that the Sample and Hold Sense signal SHS_1 547a and the Sample and Hold Reset signal SHSR_1 562a are now for an nth row of multiple column sample and hold circuits 525a1, 525an, . . . , 525ma, . . . , 525nm of FIG. 10b are controlled by the Sample and Hold Sense signal SHS_1 547n and the Sample and Hold Reset signal SHSR_1 562n. The Sample and Hold Sense signal SHS_1 547n and the Sample and Hold Reset signal SHSR_1 562n have the same timing as that shown in FIG. 13a for Sample and Hold Sense signal SHS_1 547a and the Sample and Hold Reset signal SHSR_1 562a for the Sampling and Holding period TSH_P2.

In the time period from the between the time τ2 and the time τ3, the operations described for the Sampling and Holding period TSH_P1 are performed sequentially for all the first level photosensing devices P1 incorporated in a multiple photosensor pixel image sensor. Similarly, in the time period from the between the time τ4 and the time τ5, the operations described for the Sampling and Holding period TSH_P2 are performed sequentially for all the second level photosensing devices P2 incorporated in a multiple photosensor pixel image sensor. At the time τ5, the Row select signal is deactivated. The time τ6 to the time τ7 is the time period TRD that the voltage level of each pixel of each column of the array is read out through each of the Image Readout circuits 535a, . . . , 535m of FIG. 10b to the digital data word 580a, . . . , 580m of FIG. 10b. In FIG. 10a, there is a single Image Readout circuit 535 connected to a row of sample and hold circuits 525a, . . . , 525n. This forces the readout of the Image Readout circuit 535 to be interleaved each of the Sample and Hold period TSH_P0, Sample and Hold period TSH_P1, and Sample and Hold period TSH_P2. The additional multiple column sample and hold circuits 525a1, . . . , 525an, . . . , 525ma, 525nm connected to the Image Readout circuits 535a, . . . , 535m permits parallel readout of the digital data words 580a, . . . , 580m.

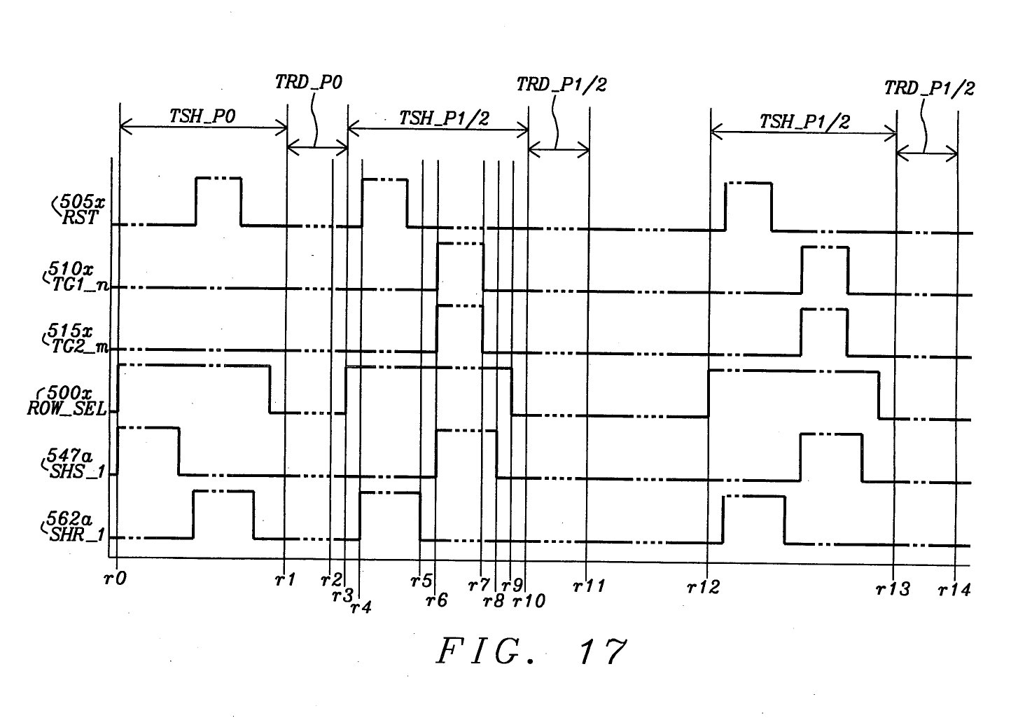

The timing diagram of FIG. 15 illustrates an array of multiple photosensor pixel image sensors where the combined photosensing and charge storage device P0 have at least one of the first level photosensing devices P1 associated with them for combining of the charge or binning. In operation the combined photosensing and charge storage device P0 and the first level photosensing devices P1 are operated such that the charge from each set of devices flow together and are added together or binned. The readout of the combined photosensing and charge storage device P0 and the first level photosensing devices P1 are a non-correlated double sampling that begins at the time τ0 with the first level transfer gating signal TG1_{—}n 510x is activated to provide the binning of the first level photosensing devices P1 with the combined photosensing and charge storage device P0.

At the time τ1, the first level transfer gating signal TG1_{—}n 510x is deactivated and at the time τ2, the Sample and Hold Sense signal SHS_1 547a is deactivated. At the time τ3 (equivalent to the time τ6 of FIG. 12) the Reset signal 505x is activated to reset the combined photosensing and charge storage device P0. The Sample and Hold Reset signal SHR_1 562a is activated to capture the Reset voltage level at the output of the source follower of the combined photosensing and charge storage device P0. The Reset signal 505x is deactivated at the time τ4 and the Sample and Hold Reset signal 562a is deactivated at the time τ5. The Row Select signal 500x is deactivated at the time τ6. The time from the time τ0 to the time τ6 is considered the Sample and Hold period TSH_P0/1 for the combined photosensing and charge storage device P0 binned with selected first level photosensing devices P1. From the time τ7 to the time τ8 is the time period TRD_P0/1 that the voltage level of each pixel of each column of the array is read out through the Image Readout circuit 535 of FIG. 10a to the data output 580 of FIG. 10a.

From the time τ8 to the time τ9, is the Sample and Hold period TSH_P2 for the readout of the second level photosensing devices P2. The timing for this is equivalent to the timing of the Sampling and Holding period TSH_P2 for the second level photosensing device P2 of FIG. 13a. Further the timing of the readout period TRD_P2 from the time τ9 to the time τ10 is equivalent to the readout timing TRD_P2 of FIG. 13a. The Sampling and Holding period TSH_P2 for the second level photosensing device P2 and the readout period TRD_P2 is sequentially repeat until the final second level photosensing devices P2 are sampled and held from the time τ11 until the time τ12 and then readout from the time τ12 until the time τ13. It will be noted that the column sample, hold, and readout circuit 425 of FIG. 10a is employed in the structure illustrated in FIG. 15.

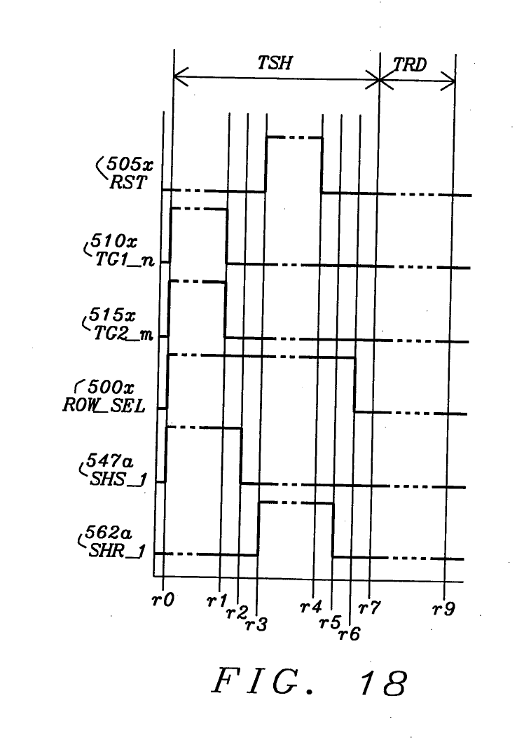

FIG. 16 illustrates the timing of a column sample, hold, and readout circuit 425 of FIG. 10b with multiple column sample and hold circuits 525a1, . . . , 525an, . . . , 525ma, 525nm, multiple Image Readout circuits 535a, . . . , 535m, and multiple digital data word 580a, . . . , 580m. The Sampling and Holding period TSH_P0/1 between the time τ0 and the time τ1 is the time for the capturing the voltage level representing the number of photoelectrons integrated at the combined photosensing and charge storage device P0 binned with selected first level photosensing device P1. This timing is identical to that described above for FIG. 15. The Sampling and Holding period TSH_P2 between the time τ1 and the time τ2 is the time for the capturing the voltage level representing the number of photoelectrons integrated at the second level photosensing devices P2. This timing is identical to that described above for FIG. 13a with the exception that the Sample and Hold Sense signal SHS_1 547a and the Sample and Hold Reset signal SHSR_1 562a are now for a second row of multiple column sample and hold circuits 525a 1., 525an, . . . , 525ma, . . . , 525nm of FIG. 10b (not shown) are controlled by the Sample and Hold Sense signal SHS_1 547b and the Sample and Hold Reset signal SHSR_1 562b. The Sample and Hold Sense signal SHS_1 547b and the Sample and Hold Reset signal SHSR_1 562b have the same timing as that shown in FIG. 15 for Sample and Hold Sense signal SHS_1 547a and the Sample and Hold Reset signal SHSR_1 562a for the Sampling and Holding period TSH_P2. The execution of the Sampling and Holding signals of the period TSH_P2 are repeated until the final second level photosensing devices P2 is sampled and held between the time τ3 and the time τ4 This timing is identical to that described above for FIG. 15 with the exception that the Sample and Hold Sense signal SHS_1 547a and the Sample and Hold Reset signal SHSR_1 562a are now for an nth row of multiple column sample and hold circuits 525a1, . . . , 525an, . . . , 525ma, . . . , 525nm of FIG. 10b are controlled by the Sample and Hold Sense signal SHS_1 547n and the Sample and Hold Reset signal SHSR_1 562n. The Sample and Hold Sense signal SHS_1 547n and the Sample and Hold Reset signal SHSR_1 562n have the same timing as that shown in FIG. 15 for Sample and Hold Sense signal SHS_1 547a and the Sample and Hold Reset signal SHSR_1 562a for the Sampling and Holding period TSH_P2.

Just prior to the time τ4, the Row select signal is deactivated. From the time τ4 to the time τ5 is the time period TRD that the voltage level of each pixel of each column of the array is read out through each of the Image Readout circuits 535a, . . . , 535m of FIG. 10b to the digital data word 580a, . . . , 580m of FIG. 10b. In FIG. 10a, there is a single Image Readout circuit 535 connected to a row of sample and hold circuits 525a, . . . 525n. This forces the readout of the Image Readout circuit 535 to be interleaved each of the Sample and Hold period TSH_P0, Sample and Hold period TSH_P1, and Sample and Hold period TSH_P2. The additional multiple column sample and hold circuits 525a1, . . . , 525an, . . . , 525ma, . . . , 525nm connected to the Image Readout circuits 535a, . . . , 535m permits parallel readout of the digital data words 580a, . . . , 580m.

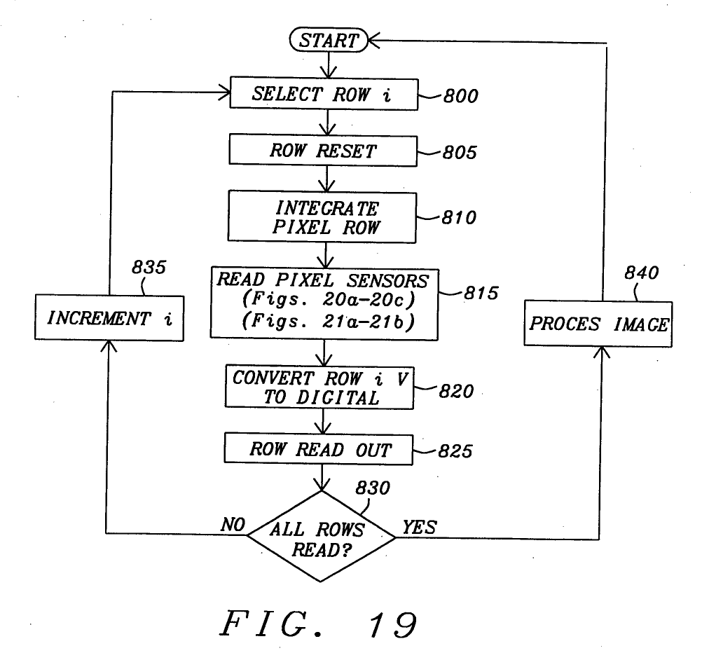

The timing diagram of FIG. 17 illustrates an array of multiple photosensor pixel image sensors where the first level photosensing devices P1 have at least one of the second level photosensing devices P2 associated with them for combining of the charge or binning. In operation the first level photosensing devices P1 and the second level photosensing devices P2 are operated such that the charge from each set of devices flow together and are added together or binned. From the time τ0 to the time τ1, the Sample and Hold period TSH_P0 for the combined photosensing and charge storage device P0 is performed as described in FIG. 13a. From the time τ1 to the time τ2 is the time period TRD_P0 that the voltage level of each pixel of each column of the array is read out through the Image Readout circuit 535 of FIG. 10a to the data output 580 of FIG. 10a.

At the time τ3, the Row Select signal 500x is activated to start the Sampling and Holding period TSH_P1/2 for the first level photosensing device P1 as combined or binned with selected second level photosensing devices P2. At the time τ3, the Reset signal 505x is activated and the Sample and Hold Reset signal SHR_562a is activated to capture the Reset voltage level at the output of the source follower of the combined photosensing and charge storage device P0. At the time τ4, the Reset signal 505x is deactivated and at the time τ5, the Sample and Hold Reset signal SHR_1 562a is deactivated. At the time τ6, the first level transfer gating signal TG1_{—}n 510x and the second level transfer gating signal TG2_{—}m 515x is activated simultaneously to transfer the charge from the first level photosensing device P1 binned with the selected second level photosensing devices P2 to the combined photosensing and charge storage device P0. The Sample and Hold Sense signal SHS_1 547a is also activated at the time τ6 to capture the voltage level of the output of the source follower of the combined photosensing and charge storage device P0 representing the number of photoelectrons integrated during the period T3 and T4 as described in FIG. 12. At the time τ7, the first level transfer gating signal TG1_{—}n 510x and the second level transfer gating signal TG2_{—}m 515x are deactivated; at the time τ8, the Sample and Hold Sense signal SHS_1 547a is deactivated; and at the time τ9 the Row Select signal 500x is deactivated to complete the readout of the charge of the first level photosensing device P1 binned with the selected second level photosensing devices P2 in the time period TSH_P1/2.

During the time period TRD_P1/2 between the time τ10 and time τ11, the voltage level of each first level photosensing device P1 binned with the selected second level photosensing devices P2 of each column of the array is read out through the Image Readout circuit 535 of FIG. 10a to the data output 580 of FIG. 10a. If there are multiple first level photosensing devices P1 binned with selected second level photosensing devices P2, the signal levels as shown for the time period TSH_P1/2 and the time period TRD_P1/2 for each of these devices are repeated to complete the readout of each of the first level photosensing device P1. The repetition occurs from the time τ11 to the time τ12, with the final grouping of the first level photosensing devices P1 binned with the selected second level photosensing devices P2 occurring from the time τ12 to the time τ13 for the sampling and holding and from the time τ13 to the time τ14 for the readout.

It would be obvious from the above description that a similar timing would be employed with a column sample, hold, and readout circuit 425 of FIG. 10b. The signals of the Sample and Hold period TSH_P0 for the combined photosensing and charge storage device P0 and the signals of the Sampling and Holding period TSH_P1/2 for the first level photosensing device P1 as combined or binned with selected second level photosensing devices P2 to be serially executed similar to those of FIG. 14 with the actions of Readout time periods TRD_P0 and TRD_P1/2 would be performed simultaneously.

FIG. 18 illustrates the timing diagram for binning and readout of all the sensors (combined photosensing and charge storage device P0 with the first level photosensing devices P1 and the second level photosensing devices P2) of the multiple photosensor pixel image sensor for which the operation control circuitry of this invention manipulates the control signals for controlling functioning of each pixel image sensor. If the signals in all the three type photosensors (combined photosensing and charge storage device P0 with the first level photosensing devices P1 and the second level photosensing devices P2) are binned, in general, the Column Sample and Hold and Readout circuit 425 of FIG. 10a has only one column sample and hold circuit 525a, . . . , 525n for each of the Row Buses 520a, . . . , 520n. The Sampling and Hold Period TSH begins at the time τ0 with the activation of the Row Select signal 500x. Simultaneously, all. the first level transfer gate signals TG1_{—}n 510x and second level transfer gating signals TG2_{—}m 515x are activated such that all the charge from the first level photosensing devices P1 and the second level photosensing devices P2 are binned with the charge from the combined photosensing and charge storage device P0 for readout. Also, simultaneously, the Sample and Hold Sense signal 547a is activated to sample the binned charge of the combined photosensing and charge storage device P0 with the first level photosensing devices P1 and the second level photosensing devices P2. At the time τ1, the first level transfer gate signals TG1_{—}n 510x and the second level transfer gate signals TG2_{—}m 515x are deactivated and at the time τ2, the Sample and Hold Sense signal 547a are deactivated. At the time τ3, the Reset Signal 505x is set to the reset voltage level to reset the combined photosensing and charge storage device P0. The Sample and Hold Reset signal 562a is activated to capture the Reset voltage level at the output of the source follower of the combined photosensing and charge storage device P0. At the time τ4, the Reset Signal 505x is deactivated; at the time τ5, the Sample and Hold Reset signal 562a is deactivated; and at the time τ6, the Row Select signal 500x is deactivated. From the time τ7 to the time τ8 is the time period TRD where the voltage level of each pixel of each column of the array is read out through the Image Readout circuit 535 of FIG. 10a to the data output 580 of FIG. 10a employing a non-correlated double sampling process.

Refer now to FIG. 19 for a discussion of a process that is executed by the operation control circuitry of this invention for controlling operation of the array of multiple photosensor pixel image sensors for capturing an image. The row select control signal is activated to select (Box 810) one row (i) for reading out of the multiple photosensor pixel image sensors of the selected row (i). The row reset signal for the selected row (i) of the array of multiple photosensor pixel image sensors is activated to reset (Box 805) all the photosensors of each multiple photosensor pixel image sensor on the selected row (i). The array of multiple photosensor pixel image sensors are then exposed to (Box 810) a light reflected from a scene that is be captured as the image. The selected row (i) of multiple photosensor pixel image sensors is then read out (Box 815).

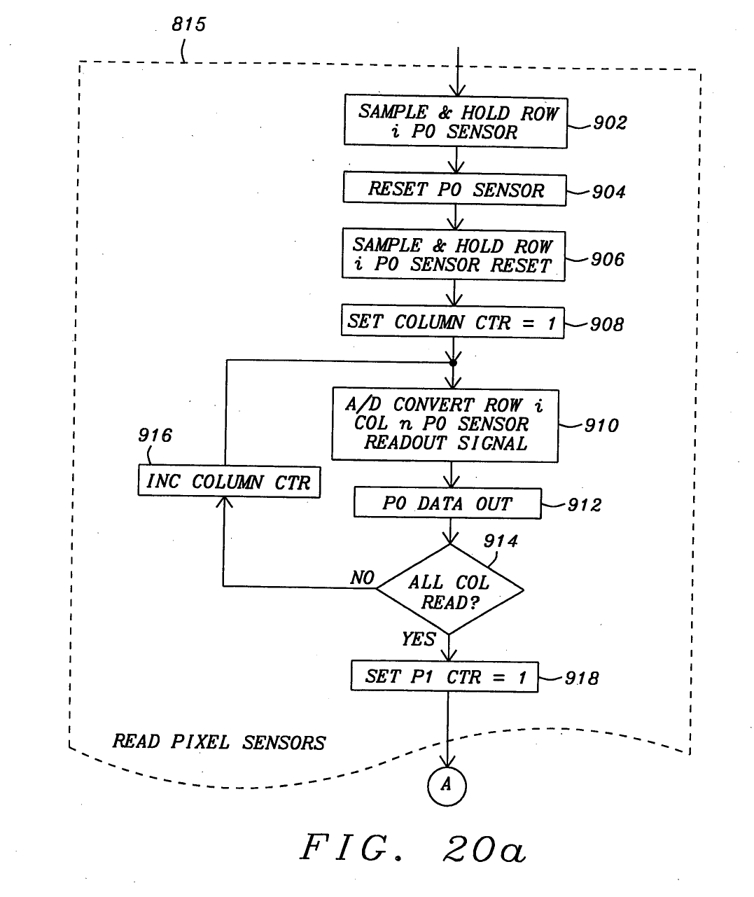

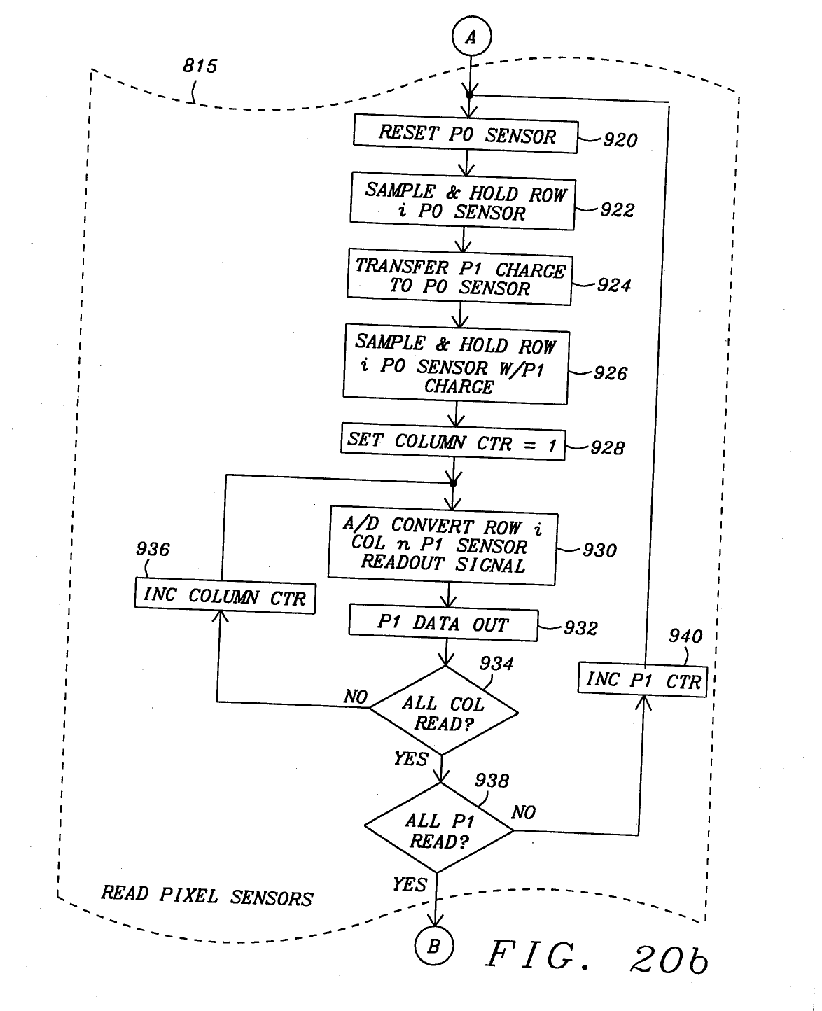

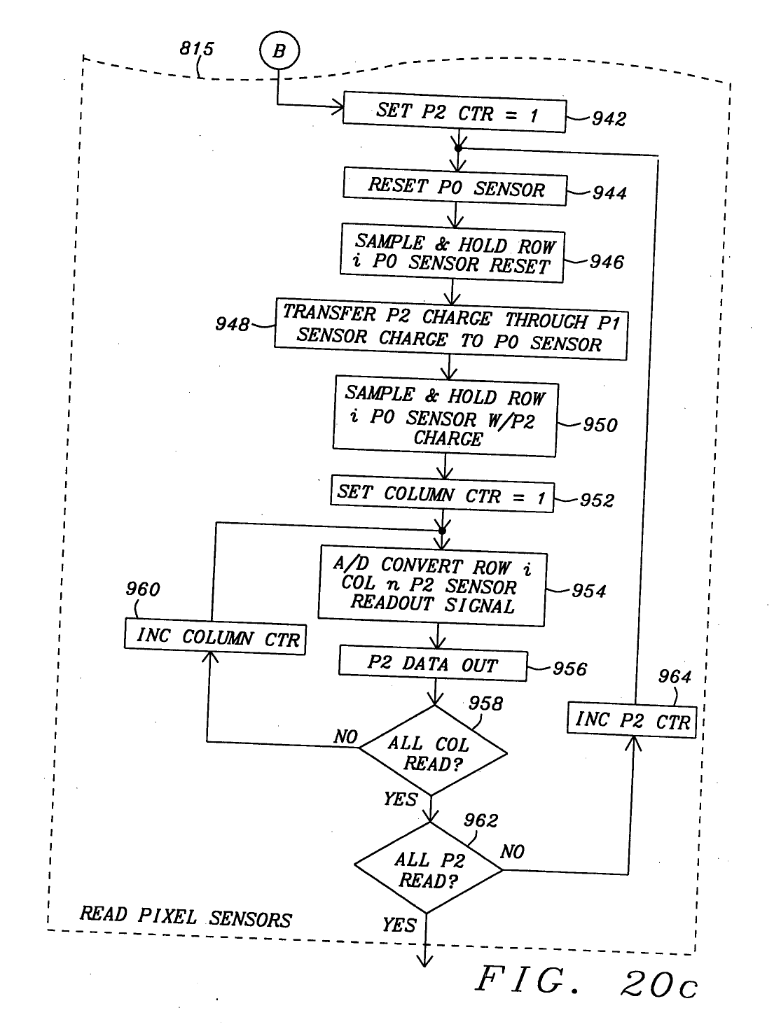

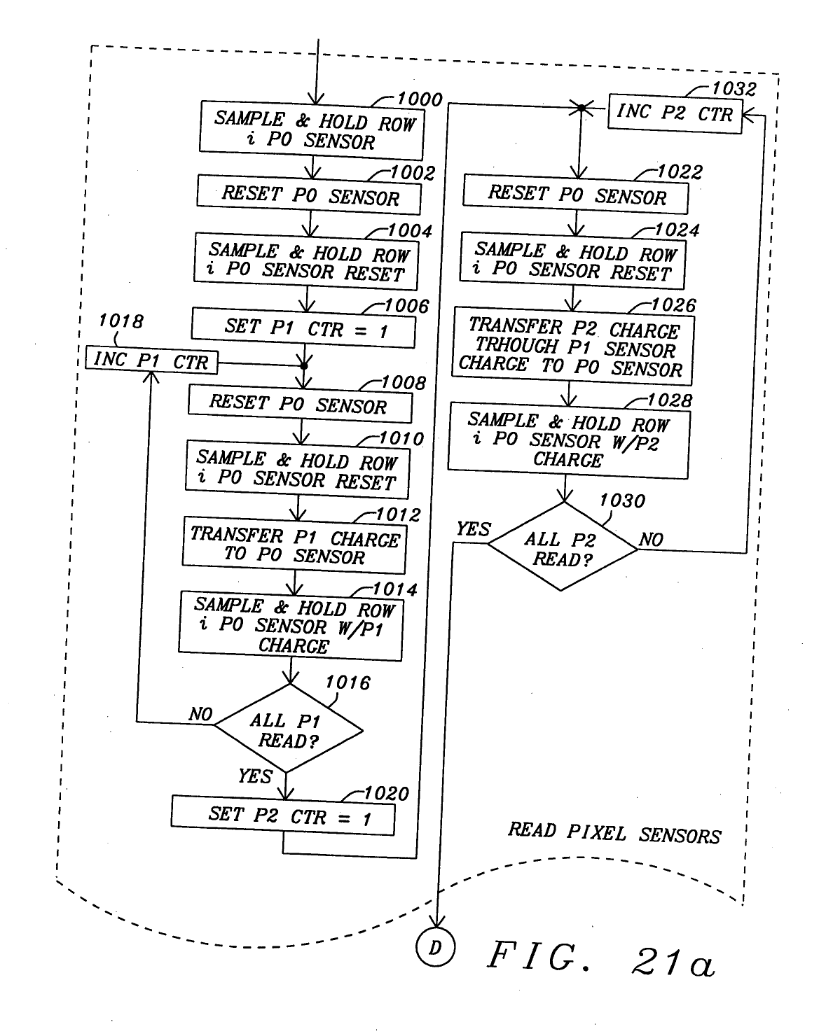

Refer now to FIGS. 20a-20c for a description of the method for reading out (Box 815) of the selected row of multiple photosensor pixel image sensors for an array of the multiple photosensor pixel image sensors having an Image Readout circuit 535 of FIG. 10a. The Sample and Hold signal for the selected row (i) is activated (Box 902) to capture the conversion signal for the combined photosensing and charge storage device P0. The row reset signal is then activated (Box 904) to reset the combined photosensing and charge storage device P0 to capture the reference voltage level (Box 906) of the combined photosensing and charge storage device P0. The difference between the sampled conversion signal and the sampled and held reset reference voltage level is the output voltage level of the conversion signal representing the number of photons that have impinged upon the combined photosensing and charge storage device P0 during the exposure and integration (Box 810) of the combined photosensing and charge storage device P0. A Column Counter is set (Box 908) to an initial value (1). The column counter activates the Column Select Signal of the n^{th} Column Sample and Hold Circuit to connect the Column Sample and Hold Circuit to the Image Readout circuit for analog to digital conversion (Box 910). The digital data for the column of the combined photosensing and charge storage device P0 as indicated by the Column Counter is transferred (Box 912) from the readout circuit. The Column Counter is queried (Box 914) if all the columns of the array are converted and the digital data readout. If not, the Column Counter is incremented (Box 916) and the analog-to-digital conversion (Box 910) and the digital readout (Box 912) of the combined photosensing and charge storage device P0 of each column of the array is performed.

When all the columns are readout, a first level photosensing device counter (P1 CTR) is set (Box 918) to an initial value (1). The row reset signal is then activated (Box 920) to reset the combined photosensing and charge storage device P0 to sample and hold the reference voltage level (Box 922) of the combined photosensing and charge storage device P0. A transfer gate is activated to transfer (Box 924) the charge of the selected first level photosensing devices P1 to the combined photosensing and charge storage device P0. The conversion voltage of the charge of the combined photosensing and charge storage device P0 is sampled and held (Box 926). A Column Counter is set (Box 928) to an initial value (1). The column counter activates the Column Select Signal of the n^{th} Column Sample and Hold Circuit to connect the Column Sample and Hold Circuit to the Image Readout circuit for analog to digital conversion (Box 930). The digital data for the column of the first level photosensing devices P1 as indicated by the Column Counter is transferred (Box 932) from the readout circuit. The Column Counter is queried (Box 934) if all the columns of the array are converted and the digital data readout. If not, the Column Counter is incremented (Box 936) and the analog-to-digital conversion (Box 930) and the digital readout (Box 932) of the first level photosensing devices P1 present on combined photosensing and charge storage device P0 of each column of the array is performed. The first level photosensing device counter (P1 CTR) is queried (Box 938) whether all the first level photosensing devices P1 are converted and read out. If not, the first level photosensing device counter (P1 CTR) is incremented (Box 940) and the combined photosensing and charge storage device P0 is reset (Box 920), sampled and held, and the charge of the selected first level photosensing devices P1 is transferred (Box 924), sampled and held (Box 926), converted (Box 930) and readout (Box 932).

When all the first level photosensing devices P1 of the selected row have been transferred, sampled and held, and readout, a second level photosensing device counter (P2 CTR) is set (Box 942) to an initial value (1). The row reset signal is then activated (Box 944) to reset the combined photosensing and charge storage device P0 to sample and hold the reference voltage level (Box 946) of the combined photosensing and charge storage device P0. The transfer gate between the second level photosensing device P2 and the first level photosensing device P1 and the transfer gate between the first level photosensing devices P1 and the second level photosensing devices P2 are activated to transfer (Box 948) the charge of the selected second level photosensing devices P2 through the first level photosensing devices P1 to the combined photosensing and charge storage device P0. The conversion voltage of the charge of the combined photosensing and charge storage device P0 is sampled and held (Box 950). A Column Counter is set (Box 952) to an initial value (1). The column counter activates the Column Select Signal of the n^{th} Column Sample and Hold Circuit to connect the Column Sample and Hold Circuit to the Image Readout circuit for analog to digital conversion (Box 954). The digital data for the column of the second level photosensing devices P2 as indicated by the Column Counter is transferred (Box 956) from the readout circuit. The Column Counter is queried (Box 958) if all the columns of the array are converted and the digital data readout. If not, the Column Counter is incremented (Box 960) and the analog-to-digital conversion (Box 954) and the digital readout (Box 958) of the second level photosensing devices P2 present on the combined photosensing and charge storage device P0 of each column of the array is performed. The second level photosensing device counter (P2 CTR) is queried (Box 962) whether all the second level photosensing devices P2 are converted and read out. If not, the second level photosensing device counter (P2 CTR) is incremented (Box 964) and the combined photosensing and charge storage device P0 is reset (Box 944), sampled and held, and the charge of the selected second level photosensing devices P2 is transferred (Box 948), sampled and held (Box 950), converted (Box 954) and readout (Box 956).

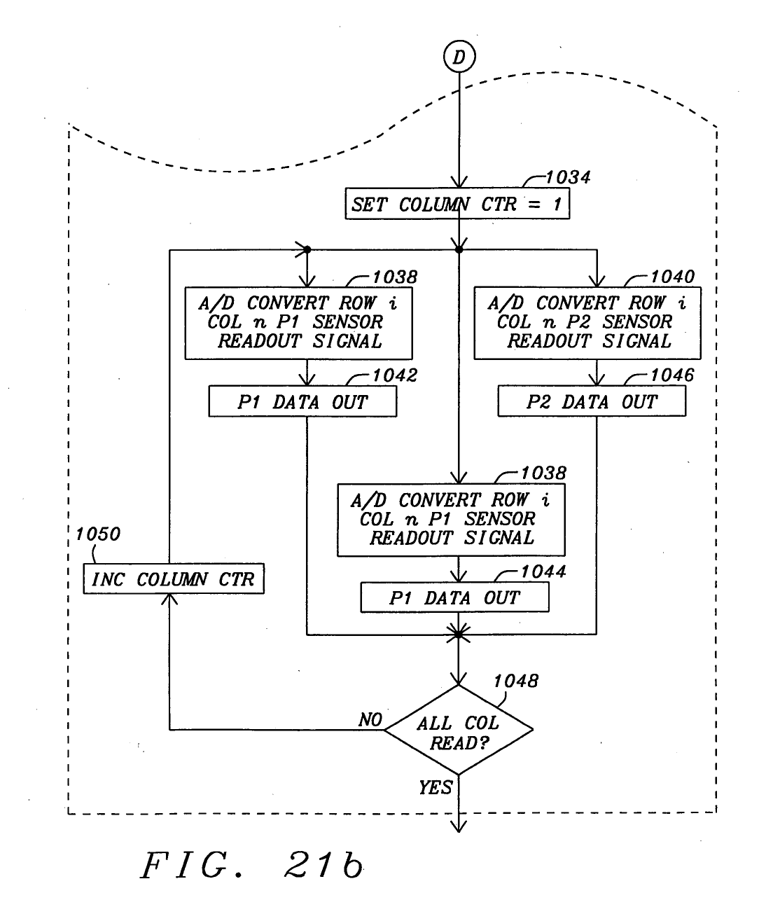

An alternate to the method for reading out (Box 815) of the selected row of multiple photosensor pixel image sensors for an array of the multiple photosensor pixel image sensors having an Image Readout circuit 535 of FIG. 10a, as described in FIGS. 20a-20c is a method for reading out (Box 815) of the selected row of multiple photosensor pixel image sensors for an array of the multiple photosensor pixel image sensors having an Image Readout circuit 535 of FIG. 10b as shown in the flow chart of FIGS. 21 a and 21 b. In FIG. 10b, each Row Bus 520a, . . . , 520n of each column of the array 410 of multiple photosensor pixel image sensors 415 is connected to multiple column sample and hold circuits 525a1, . . . , 525an, . . . , 525am, . . . , 525nm.

The Sample and Hold signal for the selected row (i) is activated (Box 1000) to capture the conversion signal for the combined photosensing and charge storage device P0. The row reset signal is then activated (Box 1002) to reset the combined photosensing and charge storage device P0 to capture the reference voltage level (Box 1004) of the combined photosensing and charge storage device P0. The difference between the sampled conversion signal and the sampled and held reset reference voltage level is the output voltage level of the conversion signal representing the number of photons that have impinged upon the combined photosensing and charge storage device P0 during the exposure and integration (Box 810) of the combined photosensing and charge storage device P0.

A first level photosensing device counter (P1 CTR) is set (Box 1006) to an initial value (1). The row reset signal is then activated (Box 1008) to reset the combined photosensing and charge storage device P0 to sample and hold the reference voltage level (Box 1010) of the combined photosensing and charge storage device P0. A transfer gate is activated to transfer (Box 1012) the charge of the selected first level photosensing devices P1 to the combined photosensing and charge storage device P0. The conversion voltage of the charge of the combined photosensing and charge storage device P0 is sampled and held (Box 1014). The first level photosensing device counter (P1 CTR) is queried (Box 1016) whether all the first level photosensing devices P1 are converted. If not, the first level photosensing device counter (P1 CTR) is incremented (Box 1018) and the combined photosensing and charge storage device P0 is reset (Box 1008), sampled and held (Box 1010), and the charge of the selected first level photosensing devices P1 is transferred (Box 1012), sampled and held (Box 1014).

When all the first level photosensing devices P1 of the selected row have been transferred, sampled and held, and readout, a second level photosensing device counter (P2 CTR) is set (Box 1020) to an initial value (1). The row reset signal is then activated (Box 1022) to reset the combined photosensing and charge storage device P0 to sample and hold the reference voltage level (Box 1024) of the combined photosensing and charge storage device P0. The transfer gate between the second level photosensing device P2 and the first level photosensing device P1 and the transfer gate between the first level photosensing devices P1 and the second level photosensing devices P2 are activated to transfer (Box 1026) the charge of the selected second level photosensing devices P2 through the first level photosensing devices P1 to the combined photosensing and charge storage device P0. The conversion voltage of the charge of the combined photosensing and charge storage device P0 is sampled and held (Box 1028). The first level photosensing device counter (P1 CTR) is queried (Box 1030) whether all the second level photosensing devices P2 are converted. If not, the second level photosensing device counter (P2 CTR) is incremented (Box 1032) and the combined photosensing and charge storage device P0 is reset (Box 1022), sampled and held (Box 1024), and the charge of the selected second level photosensing devices P2 is transferred (Box 1026), sampled and held (Box 1028).

When all selected second level photosensing devices P2 are converted, a Column Counter is set (Box 1034) to an initial value (1). The column counter activates the Column Select Signal of the n^{th} Column Sample and Hold Circuit to connect the Column Sample and Hold Circuits to the Image Readout circuits for analog to digital conversion of the combined photosensing and charge storage device P0 (Box 1036), the first level photosensing devices P1 (Box 1038), and the second level photosensing devices P2 (Box 1040). The digital data for the column of the combined photosensing and charge storage device P0, first level photosensing devices P1, and the second level photosensing devices P2 as indicated by the Column Counter is transferred (Boxes 1042, 1044, and 1046) from the readout circuit. The Column Counter is queried (Box 1048) if all the columns of the array are converted and the digital data readout. If not, the Column Counter is incremented (Box 1050) and the analog-to-digital conversion (Boxes 1036, 1038, and 1040) and the digital readout (Boxes 1042, 1044, and 1046) of the combined photosensing and charge storage device P0, first level photosensing devices P1, and the second level photosensing devices P2 present on the at the sample and hold circuits of each column of the array is performed.

Returning now to FIG. 12, the processed output signals from the readout of the selected row (i) of the array of multiple photosensor pixel image sensors are the converted (Box 820) to digital data word and readout (Box 825) for further image processing. The count of the rows is tested (Box 830) that all rows are all read. If all rows have not been processed, the next row is selected (Box 835) by incrementing the counter (i). When all the rows for the image are readout (Box 825), the image is then processed (Box 840) and the process is repeated for subsequent images.

The Pentile Matrix-Multiple Photosensor Pixel as described in Dosluoglu—840 may be implemented in as a group of 2×2 photo sensor elements. The structure of the Pentile Matrix of Dosluoglu—840 may have photo sensors that are tuned to receive other wavelengths of light such as Red/Green and Green/Blue. The multiple photosensor pixel image sensor of this invention may use colors other than red as the pixel of the storage node. The use of red pixel as the storage node is not fundamental to this invention. Any of the photodiodes that are part of the 2×2 element can be used as the storage node regardless of the type of photodiode used and regardless of the type of color filter used above these diodes. A pixel array that is optimized for Pentile Matrix display where the 2×2 structures can be formed using the Green/Blue photodiode that is sensitive to Green and Blue wavelengths only and not Red wavelengths; and the Red/Green photodiode that is sensitive to Red and Green wavelengths and not to Blue wavelengths. It should be noted that in this case the Blue/Green type photodiode has a shallow junction.

It is in keeping with this invention to have a 2×2 multiple photosensor pixel image sensor consisting of one Blue/Green photodiode and three Red/Green photodiodes. The Blue/Green photodiode is used as the storage node. The Red/Green photodiodes may be pinned photodiode structures with deeper than typical pinning implant to reduce its blue response. These Red/Green photodiodes would be connected through the transfer gates to transfer charges the Blue/Green diode in a manner analogous to the Red photodiode of the multiple photosensor pixel image sensor for which the operation control circuitry of this invention manipulates control signals of this invention. The control circuitry is modified such that the control signals appropriately reset, integrate the photoelectrons, transfer the photoelectrons to the combined photosensing and charge storage device. From the combined photosensing and charge storage device, the photoelectrons are converted to the conversion signal, which is then clamped, sampled and held.

While this invention has been particularly shown and described with reference to the preferred embodiments thereof, it will be understood by those skilled in the art that various changes in form and details, such as the above described Pentile Matrix, may be made without departing from the spirit and scope of the invention.

The invention claimed is:

1. An image sensor fabricated on a surface of a substrate for sensing differentiated color components of light impinging upon said pixel image sensor, said image sensor comprising:
an array of a plurality of color multiple sensor pixel image sensors arranged in rows and columns upon said substrate for sensing said differentiated color components of light impinging upon said image sensor, each of said multiple photosensor pixel image sensor comprising:
a plurality of first level photosensing devices formed within said surface of said substrate, each first level photosensing device is structured for conversion of photons of one of said differentiated color components to photoelectrons,
a plurality of second level photosensing devices formed within said surface of said substrate, each second level photosensing device is structured for conversion of photons of one of said differentiated color components to photoelectrons,
a combined photosensing and charge storage device formed within said surface of said surface and structured for conversion of photons of a principal color of said differentiated color components to photoelectrons and connected to sequentially receive photoelectrons from each of said plurality of first level photosensing devices and said second level photosensing, and
a plurality of first level transfer switches, each first level transfer switch connected such that photoelectrons are selectively and sequentially transferred from each of the plurality of first level photosensing devices to said combined photosensing and charge storage device; and
a plurality of second level transfer switches, each second level transfer switch connected such that photoelectrons are selectively and sequentially transferred from each of the plurality of second level photosensing devices through at least one of said plurality of first level transfer switches;

2. The image sensor of claim 1 further comprising:
a row control circuit in communication with rows of said array of plurality of color multiple sensor pixel image sensors for generating reset control signals, transfer gating signals, and row selecting signals for controlling resetting, integration of photoelectrons generated from said light impinging upon said array of color multiple sensor pixel image sensors, charge transfer of said photoelectrons by said plurality of first level transfer switches and said plurality of second level transfer switches between said first level and second level photosensing devices and from said first level and second level photosensing devices to said combined photosensing and charge storage device, and selecting of rows of said plurality of color multiple sensor pixel image sensors such that output signals from each of said color multiple sensor pixel image sensors on a selected row are transferred for detection.

3. The image sensor of claim 1 wherein each of said color multiple sensor pixel image sensors further comprises:
at least one reset triggering switch in communication with said combined photosensing and charge storage device and those of said triggering switches connected to said combined photosensing and charge storage device to place said plurality of first level and second level photosensing devices and said combined photosensing and charge storage device to a reset voltage level, wherein said reset triggering switch is further in communication with said row control circuit to receive one of said reset control signals for activation of said one reset triggering switch for resetting said plurality of color multiple sensor pixel image sensors on a selected row of plurality of color multiple sensor pixel image sensors.

4. The image sensor of claim 1 wherein said differentiated color components are selected from the group of color components consisting of green and blue.

5. The image sensor of claim 1 wherein said combined photosensing and charge storage device said principal color is red.

6. The image sensor of claim 1 wherein said combined photosensing and charge storage device is sensed with a double sampling readout.

7. The image sensor of claim 1 wherein said plurality of first level photosensing devices and said second level photosensing devices are sensed with a correlated double sampling readout.

8. The image sensor of claim 1 wherein at least one of plurality of second level triggering switches are connected between one of said plurality of second level photosensing devices and one of said first level photosensing devices such that said first level photosensing devices is an intermediary repository of said charge prior to transfer to said combined photosensing and charge storage device.

9. The image sensor of claim 7 wherein said two of said plurality of first level photosensing devices are connected together through at least one of said first level triggering switches to provide binning of said charge from said two first level photosensing devices.

10. The image sensor of claim 1 wherein each of said plurality of photosensing devices are pinned photodiodes.

11. The image sensor of claim 10 wherein said pinned photodiodes comprise a diffusion of the first conductivity type and a shallow pinning diffusion of the second conductivity type within said diffusion of the first conductivity type and connected to a ground reference level.

12. The image sensor of claim 11 wherein each of said plurality of photosensing devices further comprises a deep diffusion of said second conductivity type connected to a substrate reference voltage source to deflect stray photoelectrons generated in said substrate beneath a photon sensing area of said multiple photosensor pixel image sensor.

13. The image sensor of claim 1 wherein said combined photosensing and charge storage device comprises a diffusion of said first conductivity type with a sufficient depth to collect photoelectrons converted from photons of said primary color.

14. The image sensor of claim 13 wherein each of said plurality of color multiple sensor pixel image sensors further comprises a deep diffusion of said first conductivity type into which said combined photosensing and charge storage device is formed and connected to a power supply voltage source to collect stray photoelectrons generated in said substrate beneath a photon sensing area of said multiple photosensor pixel image sensor.

15. The image sensor of claim 1 wherein each of said plurality of color multiple sensor pixel image sensors further comprises at least one readout circuit connected to receive and convert photoelectrons retained by said combined photosensing and charge storage device for conversion to an electronic signal indicative of a magnitude of said color component of said light received by one selected photosensing device of said plurality of photosensing devices.

16. The image sensor of claim 15 wherein said readout circuit further comprises:
a source follower connected to said combined photosensing and charge storage device to receive and buffer a conversion electrical signal indicative of a number of photoelectrons retained by said combined photosensing and charge storage device; and
a pixel select switch selectively connected to said source follower to transfer said buffered conversion electrical signals indicative of the number of photoelectrons by said combined photosensing and charge storage device to external circuitry for further processing.

17. The image sensor of claim 2 further comprising a column sample and hold circuit in communication with each column of the plurality of color multiple sensor pixel image sensors to sample and hold said conversion electrical signals from selected rows of the plurality of color multiple sensor pixel image sensors and from said sampled and held conversion electrical signals generating an output signal representative of a number of photon impinging upon each color multiple sensor pixel image sensor of said row of selected color multiple sensor pixel image sensors.

18. The image sensor of claim 17 wherein:
a) during a row reset period, said row control circuit transmits reset control signals to activate each reset triggering switch, each of said first level triggering switches, and each of said second level triggering switches of each color multiple sensor pixel image sensor of a selected row of said array of said plurality of color multiple sensor pixel image sensors to reset each of the color multiple photosensor pixel image sensor of selected row of said array of color multiple sensor pixel image sensors to a reset level;
b) during a light integration period, each of said color multiple sensor pixel image sensors of selected row of said array of color multiple sensor pixel image sensors are exposed to light impinging upon said array of color multiple sensor pixel image sensors;
c) at completion of said light integration period, said row control circuit transmits row selecting signals to activate each pixel select switch of each of said color multiple sensor pixel image sensors of said selected row of said array of color multiple sensor pixel image sensors;
d) during a combined photosensing and charge storage device readout period,
said column sample and hold circuit samples and holds said conversion electrical signal representing a number of photoelectrons converted during said exposure from each combined photosensing and charge storage device of each color multiple sensor pixel image sensor of said selected row,
said column sample and hold circuit samples and holds said conversion electrical signal representing a reference voltage level of each of said color multiple sensor pixel image sensors of said selected row,
said column sample and hold circuit generates a color intensity signal representative of the intensity of light converted by each of said combined photosensing and charge storage device of the color multiple photosensor pixel image sensors of said selected row;
e) at a beginning of a first level photosensing device readout period, said row control circuit selects at least one of said first level photosensing devices for readout;
f) simultaneously, at said beginning of said first level photosensing device readout period, said row control circuit transmits said reset control signals to activate each reset triggering switch to reset each combined photosensing and charge storage device of the color multiple photosensor pixel image sensors of said selected row of color multiple sensor pixel image sensors to said reset level;
g) during said first level photosensing device readout period,
said column sample and hold circuit samples and hold said conversion electrical signal representing a reset level of each of said color multiple sensor pixel image sensors of said selected row,
said row control circuit transmits at least one of said first level triggering signals to activate each first level triggering switch to transfer charge from the selected first level photosensing device to said combined photosensing and charge storage device of the color multiple photosensor pixel image sensors of said selected row, and
said column sample and hold circuit samples and holds said conversion electrical signal representing a number of photoelectrons converted during said exposure from each selected first level photosensing device connected to said combined photosensing and charge storage device of each color multiple sensor pixel image sensor of said selected row;
h) during said first level photosensing device readout period said row control circuit sequentially selects one of said first level photosensing devices for readout and performs procedures f) and g) until all first level photosensing devices are readout;
i) at a beginning of a second level photosensing device readout period, said row control circuit selects at least one of said second level photosensing devices for readout;
j) simultaneously, at said beginning of said second level photosensing device readout period, said row control circuit transmits said reset control signals to activate each reset triggering switch to reset each combined photosensing and charge storage device of the color multiple photosensor pixel image sensors of said selected row of color multiple sensor pixel image sensors to said reset level;
k) during said second level photosensing device readout period,
said column sample and hold circuit samples and hold said conversion electrical signal representing a reset level of each of said color multiple sensor pixel image sensors of said selected row,
said row control circuit transmits at least one of said first level transfer gating signals to activate each first level triggering switch to transfer charge from said second level photosensing devices to said combined photosensing and charge storage device of the color multiple photosensor pixel image sensors of said selected row, and
said column sample and hold circuit samples and holds said conversion electrical signal representing a number of photoelectrons converted during said exposure from each selected second level photosensing device connected to said combined photosensing and charge storage device of each color multiple sensor pixel image sensor of said selected row;
l) during said second level photosensing device readout period said row control circuit sequentially selects one of said second level photosensing devices for readout and performs procedures f) and g) until all second level photosensing devices are readout; and
m) said row control circuit repeatedly transmits row selecting signals to activate each pixel select switch of each of said color multiple sensor pixel image sensors of another selected row of said array of color multiple sensor pixel image sensors and said row control circuit and said column sample and hold circuit clamps perform operations of procedures d) through l) until all rows of said array of said color multiple sensor pixel image sensors are transferred.

19. The image sensor of claim 18 wherein during said first level photosensing device readout period, said row control circuit transmits one of said second level triggering signals to activate each second level triggering switch to transfer charge from the selected second level photosensing device to an associated first level photosensing device that has previously sampled, held and readout.

20. The image sensor of claim 18 wherein during said second level photosensing device readout period, said row control circuit transmits one of said second transfer gating signals to activate each second level triggering switch to transfer charge from said second level photosensing device through said selected first level photosensing device to said combined photosensing and charge storage device.

21. The image sensor of claim 18 wherein:
at the completion of said combined photosensing and charge storage device readout period, said row control circuit sequentially activates a column select signal to serially transfer each color intensity signal developed from each combined photosensing and charge storage device of each column of said selected row;
at the completion of said first level photosensing device readout period, said row control circuit sequentially activates a column select signal to serially transfer each color intensity signal developed from each readout circuit of first level photosensing device of said selected row; and
at the completion of second level photosensing device period, said row control circuit sequentially activates a column select signal to serially transfer each color intensity signal developed from each readout circuit of said second level photosensing devices of said selected row.

22. The image sensor of claim 17 wherein:
at the completion of second level photosensing device period, said row control circuit sequentially activates a column select signal to serially transfer each color intensity signal developed from each readout circuit of said combined photosensing and charge storage device, said first level photosensing device, and said second level photosensing devices of said selected row in parallel for each column.

23. The image sensor of claim 17 wherein one of said first level triggering signals are connected to more than one first level triggering switches and/or second level triggering switches and said row control circuit transmits said one first level triggering signal to activate each said first level triggering switches and/or second level triggering switches to bin charge present on those first level photosensing devices and/or second level photosensing devices connected to said first level triggering switches and/or second level triggering switches and then transfer said charge to said combined photosensing and charge storage device of the color multiple photosensor pixel image sensors for readout.

24. A control apparatus that controls operation of an array of color multiple sensor pixel image sensors that sense differentiated color components of light impinging upon said pixel image sensor, each of said color multiple sensor pixel image sensors comprising a plurality of first level photosensing devices, plurality of second level photosensing devices connected through a plurality of second level transfer switches to said first level photosensing devices, and a combined photosensing and charge storage device connected through a plurality of first level transfer switches such that photoelectrons are selectively and sequentially transferred from each of the plurality of said first level photosensing devices to said combined photosensing and charge storage device, and at least one reset triggering switch in communication with said combined photosensing and charge storage device and said plurality of first level and second level photosensing devices said combined photosensing and charge storage device to establish a reset voltage level, said control apparatus comprising:
a row control circuit in communication with rows of said array of plurality of color multiple sensor pixel image sensors for generating reset control signals, transfer gating signals, and row selecting signals for controlling resetting, integration of photoelectrons generated from said light impinging upon said array of color multiple sensor pixel image sensors, charge transfer of said photoelectrons by said plurality of first level transfer switches and said plurality of second level transfer switches between said first level and second level photosensing devices and from said first level and second level photosensing devices to said combined photosensing and charge storage device, and selecting of rows of said plurality of color multiple sensor pixel image sensors such that output signals from each of said color multiple sensor pixel image sensors on a selected row are transferred for detection.

25. The control apparatus of claim 24 wherein each of said plurality of color multiple sensor pixel image sensors further comprises at least one readout circuit connected to receive and convert photoelectrons retained by said combined photosensing and charge storage device for conversion to an electronic signal indicative of a magnitude of said color component of said light received by one selected photosensing device of said plurality of photosensing devices and in communication with said row control circuit to receive said row selecting signals.

26. The control apparatus of claim 25 wherein said readout circuit further comprises:
a source follower connected to said combined photosensing and charge storage device to receive and buffer a conversion electrical signal indicative of a number of photoelectrons retained by said combined photosensing and charge storage device; and
a pixel select switch selectively connected to said source follower to transfer said buffered conversion electrical signals indicative of the number of photoelectrons by said combined photosensing and charge storage device to external circuitry for further processing and in communication with said row control circuit to receive said row selecting signals.

27. The control apparatus of claim 24 further comprising a column sample and hold circuit in communication with each column of the plurality of color multiple sensor pixel image sensors to sample and hold said conversion electrical signals from selected rows of the plurality of color multiple sensor pixel image sensors and from said sampled and held conversion electrical signals generating an output signal representative of a number of photon impinging upon each color multiple sensor pixel image sensor of said row of selected color multiple sensor pixel image sensors.

28. The control apparatus of claim 25 wherein:
a) during a row reset period, said row control circuit transmits reset control signals to activate each reset triggering switch, each of said first level triggering switches, and each of said second level triggering switches of each color multiple sensor pixel image sensor of a selected row of said array of said plurality of color multiple sensor pixel image sensors to reset each of the color multiple photosensor pixel image sensor of selected row of said array of color multiple sensor pixel image sensors to a reset level;
b) during a light integration period, each of said color multiple sensor pixel image sensors of selected row of said array of color multiple sensor pixel image sensors are exposed to light impinging upon said array of color multiple sensor pixel image sensors;
c) at completion of said light integration period, said row control circuit transmits row selecting signals to activate each pixel select switch of each of said color multiple sensor pixel image sensors of said selected row of said array of color multiple sensor pixel image sensors;
d) during a combined photosensing and charge storage device readout period,
said column sample and hold circuit samples and holds said conversion electrical signal representing a number of photoelectrons converted during said exposure from each combined photosensing and charge storage device of each color multiple sensor pixel image sensor of said selected row,
said column sample and hold circuit samples and holds said conversion electrical signal representing a reference voltage level of each of said color multiple sensor pixel image sensors of said selected row,
said column sample and hold circuit generates a color intensity signal representative of the intensity of light converted by each of said combined photosensing and charge storage device of the color multiple photosensor pixel image sensors of said selected row;
e) at a beginning of a first level photosensing device readout period, said row control circuit selects at least one of said first level photosensing devices for readout;
f) simultaneously, at said beginning of said first level photosensing device readout period, said row control circuit transmits said reset control signals to activate each reset triggering switch to reset each combined photosensing and charge storage device of the color multiple photosensor pixel image sensors of said selected row of color multiple sensor pixel image sensors to said reset level;
g) during said first level photosensing device readout period,
said column sample and hold circuit samples and hold said conversion electrical signal representing a reset level of each of said color multiple sensor pixel image sensors of said selected row,
said row control circuit transmits at least one of said first level triggering signals to activate each first level triggering switch to transfer charge from the selected first level photosensing device to said combined photosensing and charge storage device of the color multiple photosensor pixel image sensors of said selected row, and
said column sample and hold circuit samples and holds said conversion electrical signal representing a number of photoelectrons converted during said exposure from each selected first level photosensing device connected to said combined photosensing and charge storage device of each color multiple sensor pixel image sensor of said selected row;
h) during said first level photosensing device readout period said row control circuit sequentially selects one of said first level photosensing devices for readout and performs procedures f) and g) until all first level photosensing devices are readout;
i) at a beginning of a second level photosensing device readout period, said row control circuit selects at least one of said second level photosensing devices for readout;
j) simultaneously, at said beginning of said second level photosensing device readout period, said row control circuit transmits said reset control signals to activate each reset triggering switch to reset each combined photosensing and charge storage device of the color multiple photosensor pixel image sensors of said selected row of color multiple sensor pixel image sensors to said reset level;
k) during said second level photosensing device readout period,
said column sample and hold circuit samples and hold said conversion electrical signal representing a reset level of each of said color multiple sensor pixel image sensors of said selected row,
said row control circuit transmits at least one of said first level transfer gating signals to activate each first level triggering switch to transfer charge from said second level photosensing device to said combined photosensing and charge storage device of the color multiple photosensor pixel image sensors of said selected row, and said column sample and hold circuit samples and holds said conversion electrical signal representing a number of photoelectrons converted during said exposure from each selected second level photosensing device connected to said combined photosensing and charge storage device of each color multiple sensor pixel image sensor of said selected row;
l) during said second level photosensing device readout period said row control circuit sequentially selects one of said first level photosensing devices for readout and performs procedures f) and g) until all first level photosensing devices are readout; and
m) said row control circuit repeatedly transmits row selecting signals to activate each pixel select switch of each of said color multiple sensor pixel image sensors of another selected row of said array of color multiple sensor pixel image sensors and said row control circuit and said column sample and hold circuit clamps perform operations of procedures d) through l) until all rows of said array of said color multiple sensor pixel image sensors are transferred.

29. The control apparatus of claim 28 wherein during said first level photosensing device readout period, said row control circuit transmits one of said second level triggering signals to activate each second level triggering switch to transfer charge from the selected second level photosensing device to an associated first level photosensing device that has previously sampled, held and readout.

30. The control apparatus of claim 28 wherein during said second level photosensing device readout period, said row control circuit transmits one of said second transfer gating signals to activate each second level triggering switch to transfer charge from said second level photosensing device through said selected first level photosensing device to said combined photosensing and charge storage device.

31. The control apparatus of claim 28 wherein:
at the completion of said combined photosensing and charge storage device readout period, said row control circuit sequentially activates a column select signal to serially transfer each color intensity signal developed from each combined photosensing and charge storage device of each column of said selected row;
at the completion of said first level photosensing device readout period, said row control circuit sequentially activates a column select signal to serially transfer each color intensity signal developed from each readout circuit of first level photosensing device of said selected row; and
at the completion of second level photosensing device period, said row control circuit sequentially activates a column select signal to serially transfer each color intensity signal developed from each readout circuit of said second level photosensing devices of said selected row.

32. The control apparatus of claim 28 wherein:
at the completion of second level photosensing device period, said row control circuit sequentially activates a column select signal to serially transfer each color intensity signal developed from each readout circuit of said combined photosensing and charge storage device, said first level photosensing device, and said second level photosensing devices of said selected row in parallel for each column.

33. The control apparatus of claim 28 wherein one of said first level triggering signals are connected to more than one first level triggering switches and/or second level triggering switches and said row control circuit transmits said one first level triggering signal to activate each said first level triggering switches and/or second level triggering switches to bin charge present on those first level photosensing devices and/or second level photosensing devices connected to said first level triggering switches and/or second level triggering switches and then transfer said charge to said combined photosensing and charge storage device of the color multiple photosensor pixel image sensors for readout.

34. A method for control of operation of an array of color multiple sensor pixel image sensors that sense differentiated color components of light impinging upon said pixel image sensor, each of said color multiple sensor pixel image sensors comprising a plurality of first level photosensing devices, plurality of second level photosensing devices connected through a plurality of second level transfer switches to said first level photosensing devices, and a combined photosensing and charge storage device connected through a plurality of first level transfer switches such that photoelectrons are selectively and sequentially transferred from each of the plurality of said first level photosensing devices to said combined photosensing and charge storage device, and at least one reset triggering switch in communication with said combined photosensing and charge storage device and said plurality of first level and second level photosensing devices said combined photosensing and charge storage device to establish a reset voltage level, said method for control comprising the steps of:
generating reset control signals, transfer gating signals, and row selecting signals for controlling resetting, integration of photoelectrons generated from said light impinging upon said array of color multiple sensor pixel image sensors, charge transfer of said photoelectrons by said plurality of first level and second level transfer switches between said first level and second level photosensing devices and from said first level photosensing devices to said combined photosensing and charge storage device, and selecting of rows of said plurality of color multiple sensor pixel image sensors such that output signals from each of said color multiple sensor pixel image sensors on a selected row are transferred for detection; and
activating said reset triggering switch to reset said plurality of color multiple sensor pixel image sensors on a selected row of plurality of color multiple sensor pixel image sensors.

35. The method for control of claim 34 wherein each of said plurality of color multiple sensor pixel image sensors further comprises at least one readout circuit connected to receive and convert photoelectrons retained by said combined photosensing and charge storage device for conversion to an electronic signal indicative of a magnitude of said color component of said light received by one selected first level and second level photosensing device of said plurality of first level and second level photosensing devices.

36. The method for control of claim 35 wherein said readout circuit further comprises:
a source follower connected to said combined photosensing and charge storage device to receive and buffer a conversion electrical signal indicative of a number of photoelectrons retained by said combined photosensing and charge storage device; and
a pixel select switch selectively connected to said source follower to transfer said buffered conversion electrical signals indicative of the number of photoelectrons by said combined photosensing and charge storage device to external circuitry for further processing when selected by said row selecting signals.

37. The method for control of claim 34 further comprising the steps of:
sampling and holding said conversion electrical signals from selected rows of the plurality of color multiple sensor pixel image sensors; and
from said sampled and held conversion electrical signals, generating an output signal representative of a number of photon impinging upon each color multiple sensor pixel image sensor of said row of selected color multiple sensor pixel image sensors.

38. The method for control of claim 37 further comprising the steps of
a) during a row reset period, transmitting reset control signals to activate each reset triggering switch, each of said first level triggering switches, and each of said second level triggering switches of each color multiple sensor pixel image sensor of a selected row of said array of said plurality of color multiple sensor pixel image sensors to reset each of the color multiple photosensor pixel image sensor of selected row of said array of color multiple sensor pixel image sensors to a reset level;
b) during a light integration period, exposing each of said color multiple sensor pixel image sensors of selected row of said array of color multiple sensor pixel image sensors to light impinging upon said array of color multiple sensor pixel image sensors;
c) at completion of said light integration period, transmitting row selecting signals to activate each pixel select switch of each of said color multiple sensor pixel image sensors of said selected row of said array of color multiple sensor pixel image sensors;
d) during a combined photosensing and charge storage device readout period,
sampling and holding said conversion electrical signal representing a number of photoelectrons converted during said exposure from each combined photosensing and charge storage device of each color multiple sensor pixel image sensor of said selected row,
sampling and holding said conversion electrical signal representing a reference voltage level of each of said color multiple sensor pixel image sensors of said selected row,
generating a color intensity signal representative of the intensity of light converted by each of said combined photosensing and charge storage device of the color multiple photosensor pixel image sensors of said selected row;
e) at a beginning of a first level photosensing device readout period, selecting at least one of said first level photosensing devices for readout;
f) simultaneously, at said beginning of said first level photosensing device readout period, transmitting said reset control signals to activate each reset triggering switch to reset each combined photosensing and charge storage device of the color multiple photosensor pixel image sensors of said selected row of color multiple sensor pixel image sensors to said reset level;
g) during said first level photosensing device readout period,
sampling and holding said conversion electrical signal representing a reset level of each of said color multiple sensor pixel image sensors of said selected row,
transmitting at least one of said first level triggering signals to activate each first level triggering switch to transfer charge from the selected first level photosensing device to said combined photosensing and charge storage device of the color multiple photosensor pixel image sensors of said selected row, and
sampling and holding said conversion electrical signal representing a number of photoelectrons converted during said exposure from each selected first level photosensing device connected to said combined photosensing and charge storage device of each color multiple sensor pixel image sensor of said selected row;
h) during said first level photosensing device readout period, sequentially selecting one of said first level photosensing devices for readout and performs procedures f) and g) until all first level photosensing devices are readout;
i) at a beginning of a second level photosensing device readout period, selecting at least one of said second level photosensing devices for readout;
j) simultaneously, at said beginning of said second level photosensing device readout period, transmitting said reset control signals to activate each reset triggering switch to reset each combined photosensing and charge storage device of the color multiple photosensor pixel image sensors of said selected row of color multiple sensor pixel image sensors to said reset level;
k) during said second level photosensing device readout period,
sampling and holding said conversion electrical signal representing a reset level of each of said color multiple sensor pixel image sensors of said selected row,
transmitting at least one of said first level transfer gating signals to activate each first level triggering switch to transfer charge from said second level photosensing devices to said combined photosensing and charge storage device of the color multiple photosensor pixel image sensors of said selected row, and
sampling and holding said conversion electrical signal representing a number of photoelectrons converted during said exposure from each selected second level photosensing device connected to said combined photosensing and charge storage device of each color multiple sensor pixel image sensor of said selected row;
) during said second level photosensing device readout period, sequentially selecting one of said first level photosensing devices for readout and performing steps f) and g) until all first level photosensing devices are readout; and
m) repeatedly transmitting row selecting signals to activate each pixel select switch of each of said color multiple sensor pixel image sensors of another selected row of said array of color multiple sensor pixel image sensors and performing procedures d) through l) until all rows of said array of said color multiple sensor pixel image sensors are transferred.

39. The method of control of claim 38 further comprising the steps of:
during said first level photosensing device readout period, transmiting one of said second level triggering signals to activate each second level triggering switch to transfer charge from the selected second level photosensing device to an associated first level photosensing device that has previously sampled, held and readout.

40. The method of control of claim 38 further comprising the steps of:
during said second level photosensing device readout period, transmiting one of said second transfer gating signals to activate each second level triggering switch to transfer charge from said second level photosensing device through said selected first level photosensing device to said combined photosensing and charge storage device.

41. The method of control of claim 38 further comprising the steps of:
at the completion of said combined photosensing and charge storage device readout period, sequentially activating a column select signal to serially transfer each color intensity signal developed from each combined photosensing and charge storage device of each column of said selected row;
at the completion of said first level photosensing device readout period, sequentially activating a column select signal to serially transfer each color intensity signal developed from each readout circuit of first level photosensing device of said selected row; and
at the completion of second level photosensing device period, sequentially activating a column select signal to serially transfer each color intensity signal developed from each readout circuit of said second level photosensing devices of said selected row.

42. The method of control of claim 38 further comprising the steps of:
at the completion of second level photosensing device period, sequentially activating a column select signal to serially transfer each color intensity signal developed from each readout circuit of said combined photosensing and charge storage device, said first level photosensing device, and said second level photosensing devices of said selected row in parallel for each column.

43. The method of control of claim 38 further comprising the steps of:
connecting one of said first level triggering signals to more than one first level triggering switches and/or second level triggering switches;
transmitting said one first level triggering signal to activate each said first level triggering switches and/or second level triggering switches to bin charge present on those first level photosensing devices and/or second level photosensing devices connected to said first level triggering switches and/or second level triggering switches; and
transferring said charge to said combined photosensing and charge storage device of the color multiple photosensor pixel method of controls for readout.
